(19) United States
(12) Patent Application Publication
(10) Pub. No.: US 2026/0015487 A1
(43) Pub. Date: Jan. 15, 2026

(54) TRANSPARENT THERMOPLASTIC RESIN COMPOSITION, INJECTION-MOLDED ARTICLE, LIGHT GUIDE FOR VEHICLES, LIGHT GUIDE MEMBER, DAYTIME RUNNING LIGHT FOR VEHICLES, AND ASPHERICAL LENS

(71) Applicant: PS JAPAN CORPORATION, Bunkyo-ku, Tokyo (JP)

(72) Inventors: Hirokazu IWAMOTO, Tokyo (JP); Tatsuya MATSUMOTO, Tokyo (JP)

(73) Assignee: PS JAPAN CORPORATION, Bunkyo-ku, Tokyo (JP)

(21) Appl. No.: 19/252,315

(22) Filed: Jun. 27, 2025

(30) Foreign Application Priority Data
Jun. 28, 2024 (JP) 2024-105764

(51) Int. Cl. C08K 5/5313; B29C 45/00; B29K 25/00; B29K 33/00; B29K 69/00; B29L 11/00; C08K 5/00; C08K 5/05; C08K 5/09; C08K 5/103; C08K 5/15; C08K 5/527

(52) U.S. Cl. CPC C08K 5/5313; B29C 45/0001; C08K 5/005; C08K 5/05; C08K 5/09; C08K 5/103; C08K 5/15; C08K 5/527; B29C 2945/76531; B29C 2945/76561; B29K 2025/08; B29K 2033/12; B29K 2069/00; B29K 2995/0026; B29L 2011/0016; B29L 2011/0075

(57) ABSTRACT

The problem to be solved by the present disclosure is to provide a transparent thermoplastic resin composition that is used in molded articles having excellent transparency, heat resistance, long-term thermal stability, light resistance, and moldability, and low yellowness. The present disclosure is a transparent thermoplastic resin composition including 95 to 99.999 mass % of a transparent thermoplastic resin (A) and 0.001 to 0.3 mass % of a phosphorus-based compound (B) represented by the general formula (1), and having a Vicat softening temperature of 105° C. or higher.

### TECHNICAL FIELD

The present disclosure relates to a transparent thermoplastic resin composition, and to an injection-molded article, a light guide for vehicles, a light guide member, a daytime running light for vehicles, and an aspherical lens molded using the transparent thermoplastic resin composition.

### BACKGROUND

Styrene-unsaturated carboxylic acid-based resins typified by styrene-methacrylic acid copolymer resins, aromatic polycarbonate resins, and (meth)acrylic resins exhibit excellent transparency. Utilizing such characteristics, they are suitably used for optical applications. Furthermore, by utilizing the excellent heat resistance of the above resins, they can be suitably used for light guides for vehicles such as daytime running lights for vehicles, where heat resistance is required.

However, when these resins are used alone, their transmittance, low yellowness, long-term thermal stability, moisture and heat resistance, light resistance, and moldability are insufficient for use in optical applications, and it may be necessary to add additives that improve thermal stability, light resistance, and moldability. For example, PTL 1 discloses an aromatic polycarbonate used in light guide parts of daytime running lights for vehicles, in which a certain additive is added to enhance durability.
PTL 2 discloses a transparent thermoplastic resin composition to which phenolic antioxidants, dihydrooxaphosphaphenanthrene-type phosphorus-based compounds, and ultraviolet absorbers are added, and which excels in transparency, initial hue, weather resistance, and heat retention characteristics.
PTL 3 discloses a styrene-based resin composition that is excellent in in heat resistance, transparency, and light resistance, by containing a styrene-unsaturated carboxylic acid-based resin, (meth)acrylic resin, light stabilizer, and ultraviolet absorber in predetermined amounts.
PTL 4 discloses a methodology relating to optical methacrylic resin, which excels in heat resistance, weather resistance, optical properties, hue, and moldability, by including structural units having a cyclic structure in the main chain and predetermined additives.

### CITATION LIST

PTL 1: JP 2022-89906 A
PTL 2: JP 2021-169570 A
PTL 3: WO 2024/24977 A1
PTL 4: JP 2023-145388 A

### SUMMARY

In the methodology of PTL 1, a polycarbonate resin composition with little color change over a long optical path and excellent thermal stability is studied, but its light resistance and moldability are not examined. In particular, the moldability was poor due to low fluidity, making it difficult to injection mold complex-shaped molded articles. When the molding temperature is increased to improve the fluidity of the resin, there is also a problem in that the initial hue of the resin decreases. Furthermore, the moisture and heat resistance is insufficient, and under high-temperature and high-humidity environments, there has been concern that the resin may degrade, resulting in reduced transparency and heat resistance.

In the methodology described in PTL 2, a transparent thermoplastic resin composition with good transparency, initial hue, light resistance, and heat retention characteristics is studied, but heat resistance, moldability, long-term thermal stability, and light resistance were found to be insufficient. In addition, although transparency was not an issue with short optical path lengths, transparency was insufficient with long optical path lengths. In PTL 2, transparency is improved by making the refractive indices of the rubbery polymer and the matrix polymer closer to each other, but in the case of long optical path lengths, a slight difference in refractive index between the rubbery polymer and the matrix polymer led to a decrease in transparency. Furthermore, the inclusion of a rubbery polymer made it more susceptible to degradation by heat and light, resulting in insufficient long-term thermal stability and light resistance.

In the methodology described in PTL 3, although a styrene-based resin composition with good heat resistance, transparency, and weather resistance is studied, the initial hue (transparency and low yellowness) and long-term thermal stability were insufficient.

In the methodology described in PTL 4, a methacrylic resin composition with excellent releasability, heat resistance, weather resistance, optical properties, hue, and moldability is studied. However, a structural unit having a cyclic structure in the main chain is included in order to improve heat resistance, which resulted in increased yellowness, especially in long optical path lengths.

Therefore, the problem to be solved by the present disclosure is to provide a transparent thermoplastic resin composition used in molded articles that are excellent in transparency, heat resistance, long-term thermal stability, light resistance, and moldability, and have low yellowness; as well as to provide an injection-molded article, a light guide for vehicles, a light guide member, a daytime running light for vehicles, and an aspherical lens molded using the transparent thermoplastic resin composition.

In light of the above problems, the present inventors diligently conducted research, and as a result, succeeded in realizing a transparent thermoplastic resin composition and molded articles for in-vehicle use that are excellent in transparency, heat resistance, long-term thermal stability, light resistance, and moldability, by including a transparent thermoplastic resin (A) and a phosphorus-based compound (B) represented by the general formula (1) in predetermined amounts, thereby completing the present disclosure. Specifically, the present disclosure is as follows:
[1] A transparent thermoplastic resin composition comprising:
   95 to 99.999 mass % of a transparent thermoplastic resin (A); and
   0.001 to 0.3 mass % of a phosphorus-based compound (B) represented by the following general formula (1):

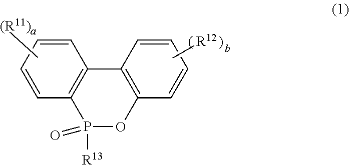

in the above general formula (1), R¹¹ and R¹² each independently are the same or different and represent halogen atoms or lower alkyl groups, and R¹³ represents a hydrogen atom, a halogen atom, a hydroxyl group, an alkyl group having 1 to 10 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; and a and b each independently represent an integer from 0 to 4, and
having a Vicat softening temperature of 105° C. or higher.
[2] The transparent thermoplastic resin composition according to [1], comprising:
   95 to 99.999 mass % of the thermoplastic resin (A);
   0.001 to 0.3 mass % of the phosphorus-based compound (B) represented by the general formula (1);
   0 to 1.0 mass % of an antioxidant (C);
   0 to 1.0 mass % of an ultraviolet absorber (D);
   0 to 1.0 mass % of a hindered amine-based light stabilizer (E);
   0 to 2.5 mass % of a mold release agent (F);
   0 to 2.5 mass % of a monovalent alcohol (G) having 6 or more carbon atoms; and
   0 to 3 mass % of a rubbery polymer (H) having a conjugated diene-based monomer unit (h),
   wherein a total content of the thermoplastic resin (A), the phosphorus-based compound (B) represented by the general formula (1), the antioxidant (C), the ultraviolet absorber (D), the hindered amine-based light stabilizer (E), the mold release agent (F), the monovalent alcohol (G) having 6 or more carbon atoms, and the rubbery polymer (H) having a conjugated diene-based monomer unit (h) is 100 mass % or less.
[3] The transparent thermoplastic resin composition according to [1] or [2], further comprising a rubbery polymer (H) having a conjugated diene-based monomer unit (h), wherein a content of the rubbery polymer (H) is 3.0 mass % or less relative to an entire transparent thermoplastic resin composition.
[4] The transparent thermoplastic resin composition according to any one of [1] to [3], wherein the transparent thermoplastic resin (A) is one or two or more selected from the group consisting of a styrene-unsaturated carboxylic acid-based resin (A1) having a styrene-based monomer unit (a1-1) and an unsaturated carboxylic acid monomer unit (a1-2), an aromatic polycarbonate resin (A2), and a (meth)acrylic resin (A3).
[5] The transparent thermoplastic resin composition according to any one of [1] to [4], wherein the styrene-unsaturated carboxylic acid-based resin (A1) is a styrene-based copolymer resin including a styrene-based monomer unit (a1-1), an unsaturated carboxylic acid monomer unit (a1-2), and an unsaturated carboxylic acid monomer unit ester (a1-3).
[6] The transparent thermoplastic resin composition according to any one of [1] to [5], wherein the transparent thermoplastic resin (A) is a styrene-unsaturated carboxylic acid-based resin (A1) having a styrene-based monomer unit (a1-1) and an unsaturated carboxylic acid monomer unit (a1-2), a content of the styrene-based monomer unit is 60 mass % or more and 97 mass % or less relative to an entire transparent thermoplastic resin (A), and a methyl ethyl ketone insoluble component content is 3 mass % or less.
[7] The transparent thermoplastic resin composition according to any one of [1] to [6], wherein the phosphorus-based compound (B) is 9,10-dihydro-9-oxa-10-phosphaphenanthrene-10-oxide.
[8] The transparent thermoplastic resin composition according to any one of [1] to [7], further comprising one or two or more antioxidants (C) selected from the group consisting of a phenolic antioxidant (C1) and a phosphorus-based antioxidant (C2), and contents of the phenolic antioxidant (C1) and the phosphorus-based antioxidant (C2) are each 0.001 to 0.5 mass % relative to the entire transparent thermoplastic resin composition.
[9] The transparent thermoplastic resin composition according to any one of [1] to [8], further comprising one or two or more antioxidants (C) selected from the group consisting of a phenolic antioxidant (C1) and a phosphorus-based antioxidant (C2),
   wherein a content ratio (mass ratio) of the phenolic antioxidant (C1) to the phosphorus-based compound (B) (phenolic antioxidant (C1)/phosphorus-based compound (B)) is 0.1 to 10.
[10] The transparent thermoplastic resin composition according to according to any one of [1] to [9], further comprising a phosphorus-based antioxidant (C2),
   wherein a content ratio of the phosphorus-based antioxidant (C2) to the phosphorus-based compound (B) (phosphorus-based antioxidant (C2)/phosphorus-based compound (B)) is 0.1 to 15.
[11] The transparent thermoplastic resin composition according to any one of [1] to [10], further comprising 0.001 to 1 mass % of an ultraviolet absorber (D) represented by the general formula (d) and the general formula (d′) relative to the entire transparent thermoplastic resin composition:

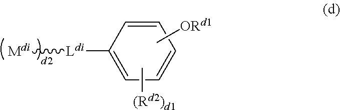

in the above general formula (d), M^{di} each independently represents a monovalent or higher aromatic group, R^{d1} represents a hydrogen atom or an alkyl group having 1 to 10 carbon atoms, L^{di} each independently represents a divalent to pentavalent group, R^{d2} represents an alkyl group having 1 to 15 carbon atoms or an aralkyl group having 7 to 25 carbon atoms, wherein —CH₂—in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; d1 represents an integer of 0 or more and 4 or less; and d2 represents an integer of 0 or more and 4 or less; a wavy line connecting M^{di} and L^{di} in the above general formula (d) indicates the presence of one or more chemical bonds that are greater than or equal to a single bond, and

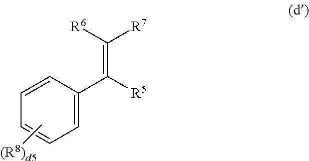

in the above general formula (d′), R⁵ to R⁷ each independently represent a hydrogen atom, a halogen atom, a hydroxyl group, a cyano group, a phenyl group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring,
R⁸ each independently represents a halogen atom, a hydroxyl group, a cyano group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring, and
d5 represents an integer of 0 or more and 4 or less, and when d5 is 2 or more, R⁸ may be the same or different from each other.
[12] The transparent thermoplastic resin composition according to any one of [1] to [11], wherein the hindered amine-based light stabilizer (E) is contained in an amount of 0.001 to 1 mass % relative to the entire transparent thermoplastic resin composition.
[13] The transparent thermoplastic resin composition according to any one of [1] to [12], wherein a proportion of the phosphor-based compound (B) in stabilizing components composed of the phosphorus-based compound (B), the antioxidant (C), the ultraviolet absorber (D), and the hindered amine-based light stabilizer (E) is 5 to 50 mass % when a total amount of the stabilizing components is 100 mass %.
[14] The transparent thermoplastic resin composition according any one of [1] to [13], wherein the mold release agent (F) is contained in an amount of 0.001 to 2.5 mass % relative to the entire transparent thermoplastic resin composition.
[15] The transparent thermoplastic resin composition according to any one of [1] to [14], wherein the monovalent alcohol (G) having 6 or more carbon atoms is contained in an amount of 0.001 to 2.5 mass % relative to the entire transparent thermoplastic resin composition.
[16] The transparent thermoplastic resin composition according to any one of [1] to [15], wherein a long optical path test piece having a light path length of 300 mm obtained by injection molding the transparent thermoplastic resin composition under the following molding conditions (S1) to (S3) has a YI value of 25 or less and an L* value of 80 or more:

### <Molding Conditions>

a molding condition (S1) of the transparent thermoplastic resin composition when the transparent thermoplastic resin (A) in the transparent thermoplastic resin composition is mainly composed of the styrene-unsaturated carboxylic acid-based resin (A1): a cylinder temperature of 220° C., a mold temperature of 70° C., and a cycle time of 35 seconds;
a molding condition (S2) of the transparent thermoplastic resin composition when the transparent thermoplastic resin (A) in the transparent thermoplastic resin composition is mainly composed of the aromatic polycarbonate resin (A2): a cylinder temperature of 260° C., a mold temperature of 80° C., and a cycle time of 35 seconds; or
a molding condition (S3) of the transparent thermoplastic resin composition when the transparent thermoplastic resin (A) in the transparent thermoplastic resin composition is mainly composed of the (meth)acrylic resin (A3): a cylinder temperature of 240° C., a mold temperature of 70° C., and a cycle time of 35 seconds.
[17] The transparent thermoplastic resin composition according to [16], wherein ΔYI, which is determined by subtracting an initial YI value before heating from the YI value after heating the long optical path test piece at 110° C. for 1000 hours, is 25 or less.
[18] An injection molded article produced by injection molding the transparent thermoplastic resin composition according to any one of [1] to [17].
[19] A light guide member comprising the transparent thermoplastic resin composition according to any one of [1] to [17].
[20] The light guide member according to [19], which is a member used in a vehicle lamp and having a bent portion.
[21] A daytime running light for vehicles comprising the transparent thermoplastic resin composition according to any one of [1] to [17].
[22] An elongated light guide member comprising the transparent thermoplastic resin composition according to any one of [1] to and having a bent portion.
[23] An aspherical lens comprising the transparent thermoplastic resin composition according to any one of [1] to [17].

According to the present disclosure, it is possible to provide a transparent thermoplastic resin composition used in molded articles that are excellent in transparency (light transmittance), heat resistance, long-term thermal stability, light resistance, and moldability.

According to the present disclosure, it is possible to provide molded articles for in-vehicle use that are excellent in transparency (light transmittance), heat resistance, long-term thermal stability, light resistance, and moldability.

According to the present disclosure, it is possible to provide an injection-molded article, a light guide for vehicles, a light guide member, a daytime running light for vehicles, and an aspherical lens that are excellent in transparency (light transmittance), heat resistance, long-term thermal stability, light resistance, and moldability.

### BRIEF DESCRIPTION OF THE DRAWINGS

In the accompanying drawings:

FIG. 1 is a schematic diagram illustrating one example of the light guide member of the present embodiment;

FIG. 2 is a schematic diagram illustrating another example of the light guide member of the present embodiment; and

FIG. 3 is a cross-sectional view of the light guide member main body of the light guide member illustrated in FIG. 2.

### DETAILED DESCRIPTION

The following provides a detailed description of an embodiment of the present disclosure (hereinafter referred to as “the present embodiment”). The present disclosure is, however, not limited to the embodiments disclosed herein, and various modifications can be made within the spirit and scope of the disclosure.

### [Transparent Thermoplastic Resin]

The present disclosure relates to a transparent thermoplastic resin composition in which the amount of a transparent thermoplastic resin (A) is 95 to less than 99.999 mass %, and the amount of a phosphorus-based compound (B) represented by the following general formula (1) is 0.001 to 0.3 mass %, and which has a Vicat softening temperature of 105° C. or higher:

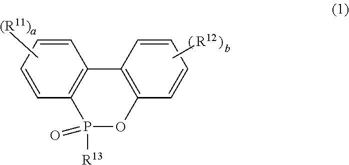

in the above general formula (1), R¹¹ and R¹² each independently represent a halogen atom or a lower alkyl group, a and b each independently represent an integer from 0 to 4, and R¹³ represents a hydrogen atom, a halogen atom, a hydroxyl group, an alkyl group having 1 to 10 carbon atoms, or an aralkyl group having 7 to 25 carbon atoms, wherein —CH₂— in the alkyl group may be substituted with —O— or —C(═O)—, —CH₂—CH₂— in the alkyl group or the aralkyl group may be substituted with —CH═CH—, —C(═O)—O—, —O—C(═O)—, —CH₂O—, or —OCH₂—, and one or more hydrogen atoms in the benzene ring of the aralkyl group may be substituted with a phenolic hydroxyl group, an alkyl group having 1 to 15 carbon atoms, or a monovalent aromatic ring.

As a result, it is possible to provide a transparent thermoplastic resin composition that is excellent in transparency (light transmittance), heat resistance, long-term thermal stability, light resistance, and moldability, ans has low yellowness.

Note that, in the present specification, “transparent” means that, when the total light transmittance (%) is measured according to JIS K 7361-1 using a 2 mm thick plate fabricated under the conditions of the examples described later, the total light transmittance is 85% or more.

Furthermore, the transparent thermoplastic resin composition of the present embodiment may, as necessary, contain one or two or more antioxidants selected from the group consisting of a phenolic antioxidant (C1) and a phosphorus-based antioxidant (C2). In addition, the transparent thermoplastic resin composition of the present embodiment may, as necessary, contain one or more selected from the group consisting of an ultraviolet absorber (D), hindered amine-based light stabilizer (E), release agent (F), and monovalent alcohol (G) having 6 or more carbon atoms.

As a result, it is possible to provide a transparent thermoplastic resin composition that is further excellent in transparency (light transmittance), heat resistance, long-term thermal stability, light resistance, and moldability, and has even lower yellowness.

In the transparent thermoplastic resin composition of the present embodiment, it is preferable that the YI value of a long optical path test piece having an optical path length of 300 mm, obtained by injection molding under predetermined conditions, is 25 or less.

In the transparent thermoplastic resin composition of the present embodiment, it is preferable that, when a long optical path test piece with an optical path length of 300 mm obtained by injection molding under predetermined conditions is heated for 1000 hours at 110° C., the ΔYI, obtained by subtracting the initial YI value before heating from the YI value after heating is 25 or less.

### “Transparent Thermoplastic Resin (A)”

The transparent thermoplastic resin (A) in the present embodiment refers to a thermoplastic resin having a total light transmittance of 85% or more when the resin is molded into a 2 mm thick plate. The transparent thermoplastic resin (A) is preferably one or two resins selected from the group consisting of a styrene-unsaturated carboxylic acid-based resin (A1) having a styrene-based monomer unit (a1-1) and an unsaturated carboxylic acid monomer unit (a1-2); an aromatic polycarbonate resin (A2); and a (meth)acrylic resin (A3).

The following provides a detailed explanation of the styrene-unsaturated carboxylic acid-based resin (A1), aromatic polycarbonate resin (A2), and (meth)acrylic resin (A3), which may be included as the transparent thermoplastic resin (A).

### “Styrene-Unsaturated Carboxylic Acid-Based Resin (A1)”

In the present embodiment, the styrene-unsaturated carboxylic acid-based resin (A1) is preferably a copolymer resin (hereinafter also simply referred to as resin (A1)) that contains styrene-based monomer units (a1-1) and unsaturated carboxylic acid monomer units (a1-2) as essential components. The styrene-unsaturated carboxylic acid-based resin (A1) may be composed of styrene-based monomer units (a1-1) and unsaturated carboxylic acid monomer units (a1-2), or, if necessary, may further contain unsaturated carboxylic acid ester monomer units (a1-3) and/or optional monomer units (a1-4), in addition to the essential components of styrene-based monomer units (a1-1) and unsaturated carboxylic acid monomer units (a1-2).

The styrene-unsaturated carboxylic acid-based resin (A1) is preferably a random copolymer. In addition, the styrene-unsaturated carboxylic acid-based resin (A1) is preferably a binary to quinary copolymer.

When the transparent thermoplastic resin (A) of the present embodiment contains the styrene-unsaturated carboxylic acid-based resin (A1), the content of the styrene-unsaturated carboxylic acid-based resin (A1) is preferably 60 to 99.999 mass % relative to the total amount (100 mass %) of the transparent thermoplastic resin composition. The lower limit of the content of the styrene-unsaturated carboxylic acid-based resin (A1) in the transparent thermoplastic resin composition is 60 mass % or more, 65 mass % or more, 70 mass % or more, 75 mass % or more, 80 mass % or more, 85 mass % or more, 90 mass % or more, 95 mass % or more, 96 mass % or more, 96.7 mass % or more, 97 mass % or more, 97.5 mass % or more, 97.8 mass % or more, 98 mass % or more, 98.5 mass % or more, 98.7 mass % or more, and 99 mass % or more, in the more preferable order. The upper limit of the content of the styrene-unsaturated carboxylic acid-based resin (A1) is 99.999 mass % or less, 99.9 mass % or less, 99.8 mass % or less, 99.7 mass % or less, 99.6 mass % or less, 99.5 mass % or less, and 99.4 mass % or less, in the more preferable order. The content of the styrene-unsaturated carboxylic acid-based resin (A1) may be selected from any combination of the above upper and lower limits.

In particular, by setting the content of the styrene-unsaturated carboxylic acid-based resin (A1) to 60 mass % or more, it is possible to impart fluidity to the transparent thermoplastic resin composition, thereby obtaining a transparent thermoplastic resin composition excellent in moldability as well as in transparency (light transmittance), heat resistance, and moisture and heat resistance. By setting the content to 99.999 mass % or less, the effects of improving long-term thermal stability and light resistance by the phosphorus-based compound (B) and other additives described later can be sufficiently obtained.

The above-mentioned moisture and heat resistance may be necessary depending on the installation location or environment of in-vehicle components. If the moisture and heat resistance is excellent, appearance changes and heat resistance changes due to resin degradation under high temperature and high humidity environments can be reduced, and the material can be suitably used as an in-vehicle component.

<Styrene-Based Monomer Unit (a1-1)>

In the styrene-unsaturated carboxylic acid-based resin (A1) of the present embodiment, the content of the styrene-based monomer unit (a1-1) relative to the total amount (100 mass %) of the styrene-unsaturated carboxylic acid-based resin (A1) is preferably 60 to 97 mass %, more preferably 70 to 97 mass %, still more preferably 75 to 96 mass %, even more preferably 80 to 95 mass %, further more preferably 81 to 94 mass %, even further more preferably 82 to 93 mass %, and particularly preferably 83 to 92 mass %. If the content of the styrene-based monomer unit (a1-1) is less than 60 mass %, fluidity decreases, and if it exceeds 97 mass %, it becomes difficult to incorporate the desired amount of unsaturated carboxylic acid monomer units (a1-2), and the effect of improving heat resistance by the unsaturated carboxylic acid monomer units (a1-2) (particularly, (meth)acrylic acid monomer units) may not be sufficiently exhibited.

In the transparent thermoplastic resin composition of the present embodiment, the styrene-based monomer unit (a1-1) is contained in an amount of preferably 60 to 97 mass %, more preferably 70 to 97 mass %, further preferably 75 to 96 mass %, and even more preferably 80 to 95 mass %, relative to the total amount of the transparent thermoplastic resin composition. When the content of the styrene-based monomer unit (a1-1) in the entire composition is within the above range, the effects of improving moldability, heat resistance, moisture and heat resistance, and transparency (light transmittance) can be sufficiently obtained.

In the present embodiment, the styrene-based monomer (a1-1), which is the precursor of the styrene-based monomer unit (a1-1), is not particularly limited and examples include, for example, styrene, α-methylstyrene, β-methylstyrene, paramethylstyrene, orthomethylstyrene, metamethylstyrene, chlorostyrene, and bromostyrene. In particular, from an industrial perspective, styrene and α-methylstyrene are preferred, with styrene being more preferred. These may be used alone or in combination with two or more as the styrene-based monomer unit (a1-1).

It should be noted that in the present specification, “styrene-based monomer unit (a1-1)” refers to a repeating unit that constitutes a polymer resulting from the polymerization of the styrene-based monomer (a1-1), and is formed by the polymerization or cross-linking reaction where the carbon-carbon double bond in the styrene-based monomer (a1-1) is changed into a single bond (—C—C—). The same definition applies to other monomer units described in this specification. The term “monomer (unit)” includes both the monomer unit and the monomer as its precursor.

<Unsaturated Carboxylic Acid Monomer Unit (a1-2)>

In the styrene-unsaturated carboxylic acid-based resin (A1) of the present embodiment, the unsaturated carboxylic acid monomer unit (a1-2) plays a role in improving heat resistance. By copolymerizing the unsaturated carboxylic acid monomer (a1-2) with the styrene-based monomer (a1-1), a transparent thermoplastic resin having a lower refractive index than polystyrene composed only of styrene-based monomer units (a1-1) can be obtained, and thus superior transparency (light transmittance) is achieved.

The content of the unsaturated carboxylic acid monomer unit (a1-2) relative to the total amount (100 mass %) of the styrene-unsaturated carboxylic acid-based resin is preferably 2 to 40 mass %, more preferably 3 to 40 mass %, further preferably 3 to 35 mass %, still more preferably 5 to 30 mass %, even more preferably 8 to 25 mass %, particularly preferably 8.5 to 20 mass %, further preferably 9.0 to 18 mass %, further preferably 10 to 15 mass %, further preferably 10.3 to 14 mass %, and most preferably 10.5 to 13 mass %. If the content of the unsaturated carboxylic acid monomer units (a1-2) is less than 2 mass %, the effect of improving heat resistance is insufficient. On the other hand, a content of the unsaturated carboxylic acid monomer units (a1-2) exceeds 40 mass % is not preferred because reduced processability due to increased resin viscosity, bubble generation during molding due to increased moisture absorption, and excessively high viscosity during production. In particular, by setting the content of the unsaturated carboxylic acid monomer unit (a1-2) to 8 to 25 mass %, a transparent thermoplastic resin composition with a well-balanced combination of moldability, heat resistance, transparency (light transmittance), and moisture and heat resistance can be obtained.

Examples of the unsaturated carboxylic acid monomer (a1-2), which is the precursor of the unsaturated carboxylic acid monomer unit (a1-2) in the present embodiment, include (meth)acrylic acid monomers, maleic anhydride monomers, maleic acid monomers, fumaric acid monomers, fumaric anhydride monomers, or cinnamic acid monomer units, among which (meth)acrylic acid monomers are preferred.

### -(Meth)acrylic Acid Monomer Unit-

In the present embodiment, when using (meth)acrylic acid monomer (unit) as the unsaturated carboxylic acid monomer (unit) (a1-2), the (meth)acrylic acid monomer (unit) serves to improve heat resistance. Examples of (meth)acrylic acid monomers that may be the precursor of the unsaturated carboxylic acid monomer unit (a1-2) include acrylic acid or methacrylic acid. From an industrial perspective, it is particularly preferable to use these either alone or in combination of two or more as the (meth)acrylic acid monomer units. Methacrylic acid, which has a high effect in improving heat resistance, is particularly preferred as the (meth)acrylic acid monomer units.

In the present embodiment, the content range of the (meth)acrylic acid monomer unit relative to the total amount of the styrene-unsaturated carboxylic acid-based resin (A1) is preferably 2 to 40 mass %, more preferably 3 to 40 mass %, further preferably 3 to 35 mass %, still more preferably 5 to 30 mass %, even more preferably 8 to 25 mass %, further preferably 8.5 to 20 mass %, further preferably 9.0 to 18 mass %, further preferably 10 to 15 mass %, further preferably 10.3 to 14 mass %, and particularly preferably 10.5 to 13 mass %. By setting the content of the (meth)acrylic acid monomer unit to 2 mass % or more, the effect of improving heat resistance can be obtained.

Furthermore, by setting the content of the (meth)acrylic acid monomer unit to 40 mass % or less, excessive viscosity increase can be suppressed. In particular, by setting the content of the (meth)acrylic acid monomer unit to the range of 8 to 25 mass %, it is possible to obtain a styrene-unsaturated carboxylic acid-based resin (A1) that achieves both high heat resistance improvement effect and suppression of gel formation to a level suitable for optical applications.

In the transparent thermoplastic resin composition of the present embodiment, the content of the unsaturated carboxylic acid monomer unit (a1-2) relative to the total amount of the transparent thermoplastic resin composition is preferably 2 to 40 mass %, more preferably 3 to 40 mass %, further preferably 3 to 35 mass %, still more preferably 5 to 30 mass %, even more preferably 8 to 25 mass %, further preferably 8.5 to 20 mass %, further preferably 9.0 to 18 mass %, further preferably 10 to 15 mass %, further preferably 10.3 to 14 mass %, and particularly preferably 10.5 to 13 mass %. When the content of the unsaturated carboxylic acid monomer unit (a1-2) in the entire composition is within the above range, the effects of improving moldability, heat resistance, moisture and heat resistance, and transparency (light transmittance) can be sufficiently obtained.

-Unsaturated Carboxylic Acid Ester Monomer Unit (a1-3)-

In the styrene-unsaturated carboxylic acid-based resin (A1) of the present embodiment, when the unsaturated carboxylic acid ester monomer unit (a1-3) is included, the inclusion of the unsaturated carboxylic acid ester monomer unit (a1-3) in the styrene-unsaturated carboxylic acid-based resin (A1) serves to reduce the refractive index of the styrene-unsaturated carboxylic acid-based resin (A1), thereby further improving transparency (light transmittance).

The unsaturated carboxylic acid ester monomer (a1-3), which is the precursor of the unsaturated carboxylic acid ester monomer unit (a1-3) of the present embodiment is preferably a (meth)acrylic acid ester monomer represented by the following general formula (i):

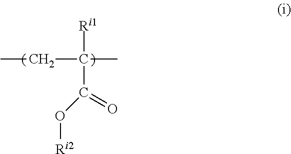

in the above general formula (i), Rⁱ¹ represents a hydrogen atom or an alkyl group having 1 to 3 carbon atoms, and Rⁱ² represents an ester substituent, specifically an alkyl group having 1 to 12 carbon atoms.

In the present embodiment, the number of carbon atoms in the ester substituent group (Rⁱ² in the above general formula (i)) of the unsaturated carboxylic acid ester monomer (a1-3) is preferably 10 or less, more preferably 8 or less, further preferably 6 or less, even more preferably 4 or less, and most preferably 3 or less. If the number of carbon atoms exceeds 10 is undesirable because the negative effect on heat resistance becomes significant.

Examples of the unsaturated carboxylic acid ester monomer (a1-3), which is the precursor of the unsaturated carboxylic acid ester monomer unit (a1-3) in the present embodiment, include, for example, (meth)acrylic acid methyl, (meth)acrylic acid ethyl, (meth)acrylic acid propyl, (meth)acrylic acid (n-butyl), (meth)acrylic acid (t-butyl), (meth)acrylic acid (isobutyl), (meth)acrylic acid cyclohexyl, (meth)acrylic acid sibenzyl, (meth)acrylic acid (n-octyl), (meth)acrylic acid (2-ethylhexyl), (meth)acrylic acid decyl, (meth)acrylic acid stearyl, and (meth)acrylic acid isobornyl. These may be used either alone or in combination. As the unsaturated carboxylic acid ester monomer (a1-3), methyl (meth)acrylate, (n-butyl) (meth)acrylate, (n-octyl) (meth)acrylate, and (3-ethylhexyl) (meth)acrylate are preferred from the viewpoint of industrial availability, and methyl methacrylate is particularly preferred because the decrease in heat resistance is suppressed.

In the present embodiment, the content range of the (meth)acrylic acid ester monomer unit (a1-2) relative to the total amount of the styrene-unsaturated carboxylic acid-based resin (A1) is preferably 0 to 50 mass %, more preferably 1 to 20 mass %, even more preferably 2 to 17 mass %, still even more preferably 3 to 12 mass %, and further even more preferably 4 to 10 mass %.

In the transparent thermoplastic resin composition of the present embodiment, the content of the unsaturated carboxylic acid ester monomer unit (a1-3) is preferably 0 to 50 mass %, more preferably 1 to 20 mass %, further preferably 2 to 17 mass %, even more preferably 3 to 12 mass %, and still more preferably 4 to 10 mass %, relative to the total amount of the transparent thermoplastic resin composition. When the content of the unsaturated carboxylic acid ester monomer unit (a1-3) in the entire composition is within the above range, sufficient effects in improving moldability, heat resistance, moisture and heat resistance, and transparency (light transmittance) can be obtained.

### <Preferred Form of Styrene-Unsaturated Carboxylic Acid-Based Resin (A1)>

The styrene-unsaturated carboxylic acid-based resin (A1) of the present embodiment may be a multi-component copolymer containing the styrene-based monomer unit (a1-1), unsaturated carboxylic acid monomer unit (a1-2), and unsaturated carboxylic acid ester monomer unit (a1-3). In particular, it is preferable that the styrene-unsaturated carboxylic acid-based resin (A1) contains methacrylic acid and methyl methacrylate.

That is, a preferred embodiment of the styrene-unsaturated carboxylic acid-based resin (A1) of the present embodiment may be not only a binary copolymer of the styrene-based monomer unit (a1-1) and the unsaturated carboxylic acid monomer unit (a1-2), but also a multi-component copolymer of three or more components in which the styrene-based monomer (a1-1), the unsaturated carboxylic acid monomer (a1-2), and the unsaturated carboxylic acid ester monomer (a1-3) are copolymerized; among these, a ternary copolymer in which the styrene-based monomer (a1-1), methacrylic acid, and methyl methacrylate are copolymerized is particularly preferred. As a result, further improvement in heat resistance and transparency (light transmittance) can be obtained.

Furthermore, when the unsaturated carboxylic acid ester monomer unit (a1-3) is arranged adjacent to the unsaturated carboxylic acid monomer unit (a1-2) in the polymer chain, effects such as suppression of crosslinking reactions between unsaturated carboxylic acids can be achieved. It is preferable that the styrene-unsaturated carboxylic acid-based resin (A1) of the present embodiment is a ternary copolymer having the styrene-based monomer unit (a1-1), the unsaturated carboxylic acid monomer unit (a1-2), and the unsaturated carboxylic acid ester monomer unit (a1-3). When the styrene-unsaturated carboxylic acid-based resin (A1) is a ternary copolymer having the styrene-based monomer unit (a1-1), the unsaturated carboxylic acid monomer unit (a1-2), and the unsaturated carboxylic acid ester monomer unit (a1-3), the molded article made from the transparent thermoplastic resin composition can achieve effects in heat resistance, transparency (light transmittance), long-term thermal stability, and light resistance.

When the styrene-unsaturated carboxylic acid-based resin (A1) of the present embodiment has the styrene-based monomer unit (a1-1), the unsaturated carboxylic acid monomer unit (a1-2), and the unsaturated carboxylic acid ester monomer unit (a1-3), it is preferable that the content of the unsaturated carboxylic acid monomer unit (a1-2) is 2 to 30 mass % and the content of the unsaturated carboxylic acid ester monomer unit (a1-3) is 0 to 20 mass % relative to the total amount of the styrene-unsaturated carboxylic acid-based resin (A1); it is more preferable that the content of the unsaturated carboxylic acid monomer unit (a1-2) is 3 to 20 mass % and the content of the unsaturated carboxylic acid ester monomer unit (a1-3) is 1 to 17 mass %; it is further preferable that the content of the unsaturated carboxylic acid monomer unit (a1-2) is 3.4 to 25 mass % and the content of the unsaturated carboxylic acid ester monomer unit (a1-3) is 3 to 15 mass %; it is even more preferable that the content of the unsaturated carboxylic acid monomer unit (a1-2) is 6 to 14 mass % and the content of the unsaturated carboxylic acid ester monomer unit (a1-3) is 4 to 10 mass %; it is further even more preferable that the content of the unsaturated carboxylic acid monomer unit (a1-2) is 9 to 12.5 mass % and the content of the unsaturated carboxylic acid ester monomer unit (a1-3) is 4.5 to 7.1 mass %; it is still further preferable that the content of the unsaturated carboxylic acid monomer unit (a1-2) is 10.3 to 12.5 mass % and the content of the unsaturated carboxylic acid ester monomer unit (a1-3) is 4.5 to 7.1 mass %; and it is most preferable that the content of the unsaturated carboxylic acid monomer unit (a1-2) is 10.5 to 12.5 mass % and the content of the unsaturated carboxylic acid ester monomer unit (a1-3) is 4.5 to 7.1 mass %. By keeping the content of the unsaturated carboxylic acid ester monomer unit (a1-3) to 20 mass % or less, it is possible to obtain a resin composition with excellent fluidity during molding. Particularly, by setting the content of the unsaturated carboxylic acid monomer unit (a1-2) to 9 mass % or more, more preferably 10.3 mass % or more, and even more preferably 10.5 mass % or more, a resin composition with excellent heat resistance can be obtained.

When the styrene-unsaturated carboxylic acid-based resin (A1) is a ternary copolymer having the styrene-based monomer unit (a1-1), the unsaturated carboxylic acid monomer unit (a1-2), and the unsaturated carboxylic acid ester monomer unit (a1-3), it is preferable that the content of the unsaturated carboxylic acid monomer unit (a1-2) is 10.5 to 12.5 mass %, the content of the unsaturated carboxylic acid ester monomer unit (a1-3) is 4.5 to 7.1 mass %, the unsaturated carboxylic acid monomer unit (a1-2) is methacrylic acid, and the unsaturated carboxylic acid ester monomer unit (a1-3) is methyl methacrylate. As a result, a transparent thermoplastic resin composition can be obtained that has a more excellent balance of heat resistance, transparency (light transmittance), long-term thermal stability, moisture and heat resistance, light resistance, and moldability.

-Optional Monomer Unit (a1-4)-

The styrene-unsaturated carboxylic acid-based resin (A1) of the present embodiment may further include optional monomer units (a1-4) in addition to the above-described styrene-based monomer unit (a1-1), unsaturated carboxylic acid monomer unit (a1-2), and unsaturated carboxylic acid ester monomer unit (a1-3). That is, in the present embodiment, the optional monomer (a1-4), which is the precursor of the optional monomer unit (a1-4), may be any monomer copolymerizable with the styrene-based monomer (a1-1), the unsaturated carboxylic acid monomer (a1-2), or the unsaturated carboxylic acid ester monomer (a1-3), and it is possible to use a predetermined amount of a monomer other than the two or three monomers mentioned above, without particular limitation, as long as the effects of the present disclosure are not impaired.

Examples of the optional monomer (a1-4) other than the three monomers mentioned above include (meth)acrylonitrile, dimethyl maleate, dimethyl fumarate, diethyl fumarate, ethyl fumarate, maleimide, and nucleus-substituted maleimides.

In the present embodiment, when the styrene-unsaturated carboxylic acid-based resin (A1) contains an optional monomer unit (a1-4), the upper limit of the content of the optional monomer unit (a1-4) relative to the total amount of the styrene-unsaturated carboxylic acid-based resin (A1) is preferably 12 mass % or less, more preferably 5 mass % or less, even more preferably 2 mass % or less, still even more preferably 1 mass % or less, and further even more preferably 0.5 mass % or less. On the other hand, the lower limit of the content of the optional monomer (a1-4) may be 0 mass %.

### <Properties of Styrene-Unsaturated Carboxylic Acid-Based Resin (A1)>

The contents of the styrene-based monomer unit (a1-1), the unsaturated carboxylic acid monomer unit (a1-2), the unsaturated carboxylic acid ester monomer unit (a1-3), and the optional monomer unit (a1-4) in the styrene-unsaturated carboxylic acid-based resin (A1) of the present embodiment can be quantified by thermal decomposition GC/MS using calibration curves created with resins in which each monomer unit is known.

The melt flow rate of the styrene-unsaturated carboxylic acid-based resin (A1) in the present embodiment at 200° C. is in the range of preferably 0.3 to 3.0, more preferably 0.4 to 2.5, even more preferably 0.5 to 2.0, still even more preferably 0.5 to 1.8, still even more preferably 0.5 to 1.1, and still even more preferably 0.5 to 1.0. A melt flow rate is 0.3 or more is preferred in view of the fluidity, and a melt flow rate of 3.0 or less is preferred in view of the mechanical strength of the resin. In this disclosure, melt mass rate is a value measured at a temperature of 200° C. under a load of 5.00 kg (49 N) in accordance with ISO 1133.

The weight average molecular weight (Mw) of the styrene-unsaturated carboxylic acid-based resin (A1) in the present embodiment is in the range of preferably 100,000 to 400,000, more preferably 120,000 to 320,000, even more preferably 140,000 to 280,000, still even more preferably 160,000 to 240,000, and most preferably 170,000 to 210,000. When the weight average molecular weight is in the range of 100,000 to 400,000, the resin that exhibits excellent practicality in terms of a balance between impact strength and fluidity is obtained. The weight average molecular weight and number average molecular weight can be measured in terms of standard polystyrene using gel permeation chromatography (GPC).

The number average molecular weight (Mn) of the styrene-unsaturated carboxylic acid-based resin (A1) in the present embodiment is preferably 40,000 to 150,000, more preferably 50,000 to 120,000, and even more preferably 60,000 to 100,000.

The Z average molecular weight (Mz) of the styrene-unsaturated carboxylic acid-based resin (A1) in the present embodiment is preferably 200,000 to 800,000, more preferably 250,000 to 500,000, and even more preferably 300,000 to 450,000.

The Vicat softening temperature of the styrene-unsaturated carboxylic acid-based resin (A1) of the present embodiment is preferably 105 to 140° C., more preferably 107 to 135° C., still more preferably 108 to 130° C., even more preferably 115 to 127° C., further more preferably 120 to 125° C., and still further more preferably 121 to 125° C. By setting the Vicat softening temperature of the styrene-unsaturated carboxylic acid-based resin (A1) to 105° C. or higher, the effect of improving heat resistance of the resin composition can be obtained, and by setting it to 140° C. or lower, a resin composition with excellent moldability can be obtained. Particularly, by setting the Vicat softening temperature to 120° C. or higher, a resin composition with excellent heat resistance can be obtained. The method for measuring the Vicat softening temperature in this specification is measured under a load of 5 kg at a heating rate of 50° C./hour in accordance with ISO 306.

The preferred transparent thermoplastic resin (A) of the present embodiment contains the styrene-based monomer unit (a1-1) and the unsaturated carboxylic acid monomer unit (a1-2), and preferably has a content of the styrene-based monomer unit of 60 mass % or more and 97 mass % or less relative to the total amount of the transparent thermoplastic resin (A), and a methyl ethyl ketone insoluble component content of 3 mass % or less. When the methyl ethyl ketone insoluble component content is 3 mass % or less, a transparent thermoplastic resin composition with excellent transparency can be obtained.

The transparent thermoplastic resin (A) is preferably one or two or more selected from the group consisting of a styrene-unsaturated carboxylic acid-based resin (A1), aromatic polycarbonate-based resin (A2), and (meth)acrylic resin (A3), and more preferably one or two selected from the group consisting of a styrene-unsaturated carboxylic acid-based resin (A1) and (meth)acrylic resin (A3). In this case, the styrene-unsaturated carboxylic acid-based resin (A1) and the (meth)acrylic resin (A3) are soluble in methyl ethyl ketone, but the aromatic polycarbonate-based resin (A2) is not soluble.

Furthermore, the rubbery polymer (H) containing the conjugated diene monomer unit (h), which is an optional component, is also not soluble in methyl ethyl ketone. Therefore, the methyl ethyl ketone insoluble components that may be contained in the entire transparent thermoplastic resin composition correspond to the aromatic polycarbonate-based resin (A2) and the rubbery polymer (H) containing the conjugated diene monomer unit (h). Accordingly, by setting the methyl ethyl ketone insoluble component content in the transparent thermoplastic resin composition to 3 mass % or less, the total amount of the aromatic polycarbonate-based resin (A2) and the rubbery polymer (H) containing the conjugated diene monomer unit (h) can be controlled.

### <Method for Producing Styrene-Unsaturated Carboxylic Acid-Based Resin (A1)>

The method for producing the styrene-unsaturated carboxylic acid-based resin (A1) in the present embodiment will be described below.

The method for producing the styrene-unsaturated carboxylic acid-based resin (A) of the present embodiment preferably includes a step of preparing a mixed solution by mixing the styrene-based monomer unit (a1-1), the unsaturated carboxylic acid monomer unit (a1-2), and, if necessary, the unsaturated carboxylic acid ester monomer unit (a1-3) and/or the optional monomer (a1-4) with a solvent, a polymerization step of polymerizing the mixed solution to produce a reaction product, and a step of recovering the reaction product.

There are no particular limitations on the polymerization method for the styrene-unsaturated carboxylic acid-based resin (A1), but radical polymerization is preferably adopted, for example. Of these, bulk polymerization or solution polymerization methods can be preferably adopted.

Specifically, the polymerization method including a polymerization step of polymerizing polymerization raw materials (monomer components) and a devolatilization step of removing volatile components such as unreacted monomers and the polymerization solvent from the polymerization product is preferred.

In the present embodiment, when the polymerization raw materials are polymerized to obtain the styrene-unsaturated carboxylic acid-based resin (A1), a polymerization initiator is typically included in the polymerization raw material composition. Examples of the polymerization initiator includes, for example, organic peroxides, including peroxy ketals such as 2,2-bis (t-butylperoxy) butane, 1,1-bis(t-butylperoxy) cyclohexane, and n-butyl-4,4-bis (t-butylperoxy) valerate, dialkyl peroxides such as di-t-butyl peroxide, t-butylcumyl peroxide, and dicumyl peroxide, diacyl peroxides such as acetyl peroxide and isobutyryl peroxide, peroxydicarbonates such as diisopropyl peroxydicarbonate, peroxy esters such as t-butyl peroxyacetate, ketone peroxides such as acetylacetone peroxide, and hydroperoxides such as t-butyl hydroperoxide. Among these, 1,1-bis(t-butylperoxy) cyclohexane is preferred from the viewpoint of the decomposition rate and the polymerization rate.

In the present embodiment, a chain transfer agent may also be used during polymerization of the styrene-unsaturated carboxylic acid-based resin (A1) as necessary. Examples of chain transfer agents include, for example, α-methylstyrene linear dimers, n-dodecyl mercaptan, t-dodecyl mercaptan, and n-octyl mercaptan.

As for the polymerization method for the styrene-unsaturated carboxylic acid-based resin (A1), solution polymerization using a polymerization solvent can be employed. Aromatic solvents such as toluene, ethylbenzene, propylbenzene, and butylbenzene are preferred as the polymerization solvent, and, if needed, polar solvents such as alcohols or ketones can be combined to prepare a solvent system in which the solubility of the styrene-unsaturated carboxylic acid-based resin (A1) is adjusted.

In the present embodiment, the polymerization solvent is used preferably in a range of 3 to 35 parts by mass, more preferably in a range of 5 to 30 parts by mass, relative to 100 parts by mass of all the monomers constituting the styrene-unsaturated carboxylic acid-based resin (A1). If the content of the polymerization solvent exceeds 35 parts by mass relative to 100 parts by mass of all the monomers, the polymerization rate decreases, and the molecular weight of the obtained resin also decreases, leading to a reduction in mechanical strength of the resin. If the content of the polymerization solvent is less than 3 parts by mass, it may become difficult to control the removal of heat during polymerization. Adding the polymerization solvent is at a ratio of 3 to 35 parts by mass relative to 100 parts by mass of all the monomers is preferred for uniformizing the quality and from the viewpoint of control on the polymerization temperature.

When the monovalent alcohol (G) having 6 or more carbon atoms, which is an optional component, is added to the polymerization system in the transparent thermoplastic resin composition of the present embodiment, it is preferable to add the monovalent alcohol (G) having 6 or more carbon atoms in an amount of 0.5 to 10 mass % relative to 100 mass % of the total polymerization solvent.

In the present embodiment, an apparatus used in the polymerization step to obtain the styrene-unsaturated carboxylic acid-based based resin (A) is not limited, and may be appropriately selected according to a typical polymerization method of a styrene-based resin. For example, in the case where bulk polymerization is employed, a polymerization apparatus having one complete mixing-type reactor or a plurality of complete mixing-type reactors connected to one another may be used. The devolatilization step is also not limited; in the case where bulk polymerization is employed, polymerization is allowed to take place until the amount of unreacted monomers finally becomes preferably 50 mass % or less, more preferably 40 mass % or less, and devolatilization is performed by a well-known method to remove volatile components including such unreacted monomers. For example, conventional devolatilizers, such as flash drums, twin axis devolatilizers, thin film evaporators, and extruders, can be used, but devolatilizers in which the materials reside in fewer portions are preferred. Note that the temperature for the devolatilization is typically about 190 to 280° C., and more preferably 190 to 260° C. from the viewpoint of inhibition of decomposition. The pressure for the devolatilization is typically about 0.13 to 4.0 kPa, preferably 0.13 to 3.0 kPa, and more preferably 0.13 to 2.0 kPa. Preferred devolatilization methods include a method of removing volatile components through heating under a reduced pressure, and a method of removing through an extruder or the like designed for the purpose of removing volatile components, for example.

### “Aromatic Polycarbonate-Based Resin (A2)”

When the transparent thermoplastic resin composition of the present embodiment contains an aromatic polycarbonate-based resin (A2) (hereinafter also simply referred to as resin (A2)), a particularly high heat resistance effect can be achieved.

The aromatic polycarbonate-based resin (A2) of the present embodiment may be a resin having an aromatic ring and a carbonate group (—O—(C═O)—O—) and having a weight average molecular weight (Mw) of 11,000 or more and 25,000 or less.

It is preferable that the aromatic polycarbonate-based resin (A2) is a resin obtained by reacting a divalent phenol and a carbonate precursor as raw materials.

Specifically, it is preferable to use, as the aromatic polycarbonate-based resin (A2) of the present embodiment, a resin obtained by reacting a divalent phenol and a carbonate precursor by a solution method (interfacial polycondensation method) or a melt method (ester exchange method), that is, a resin produced by reacting a divalent phenol and phosgene in the presence of a chain terminator by the interfacial polycondensation method, or a resin produced by reacting a divalent phenol and diphenyl carbonate or the like in the presence of a chain terminator by the ester exchange method or the like.

The method for producing the aromatic polycarbonate-based resin (A2) of the present embodiment is not particularly limited, and any method may be employed. The method for producing the aromatic polycarbonate-based resin (A2) is not particularly limited, and any method may be employed. Examples include interfacial polymerization, melt ester-exchange method, pyridine method, ring-opening polymerization of cyclic carbonate compounds, and solid-phase ester-exchange method using a prepolymer.

As the above divalent phenol, any compound can be used without particular limitation, but specific examples include 2,2-bis(4-hydroxyphenyl) propane [bisphenol A], bis(4-hydroxyphenyl) methane, 1,1-bis(4-hydroxyphenyl) ethane, 2,2-bis(4-hydroxy-3,5-dimethylphenyl) propane, 4,4′-dihydroxydiphenyl, bis(4-hydroxyphenyl) oxide, bis(4-hydroxyphenyl) cycloalkane, bis(4-hydroxyphenyl) sulfone, bis(4-hydroxyphenyl) sulfide, bis(4-hydroxyphenyl) sulfoxide, and bis(4-hydroxyphenyl) ketone. Other examples include hydroquinone, resorcinol, and catechol. One of these may be used alone, or two or more of these may be used in combination. Among these, bis(hydroxyphenyl) alkane-type compounds are preferred, and bisphenol A is particularly preferred. By using bisphenol A as the divalent phenol, an aromatic polycarbonate-based resin (A2) having a bisphenol A structure can be obtained.

The carbonate precursor mentioned above may be a carbonyl halide, carbonyl ester, or halofomate, and specific examples include phosgene, dihalofomate of a divalent phenol, diphenyl carbonate, dimethyl carbonate, and diethyl carbonate.

In the present embodiment, the aromatic polycarbonate-based resin (A2) may have a branched structure. Therefore, a branching agent may be included as the reaction raw material.

Examples of the branching agent include 1,1,1-tris (4-hydroxyphenyl) ethane, α,α′, α″-tris (4-hydroxyphenyl)-1,3,5-triisopropylbenzene, phloroglucinol, trimellitic acid, and 1,3-bis (o-cresol).

As the chain terminator, a monocarboxylic acid and derivatives thereof or a monovalent phenol can be used. Examples include p-tert-butylphenol, p-phenylphenol, p-cumylphenol, p-perfluorononylphenol, p-(perfluorononylphenyl) phenol, p-(perfluorohexylphenyl) phenol, p-tert-perfluorobutylphenol, 1-(p-hydroxybenzyl) perfluorodecane, p-[2-(1H, 1H-perfluorotridecyloxy)-1, 1, 1,3,3,3-hexafluoropropyl] phenol, 3,5-bis(perfluorohexyloxycarbonyl) phenol, p-hydroxybenzoic acid perfluorododecyl, p-(1H, 1H-perfluorooctyloxy) phenol, 2H,2H,9H-perfluorononanoic acid, and 1,1,1,3,3,3-hexafluoro-2-propanol.

In a preferred aromatic polycarbonate-based resin (A2) of the present embodiment, the main chain preferably has a repeating unit represented by the following general formula (2):

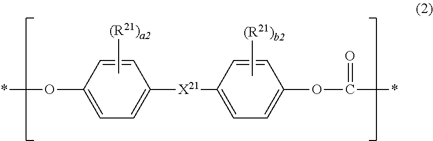

in the above general formula (2), R²¹ and R²² each independently represent an alkyl group having 1 to 6 carbon atoms or an alkoxy group having 1 to 6 carbon atoms, X²¹ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenylidene group, —S—, —SO—, —SO₂—, —O—, or —CO—, and a2 and b2 each independently represent an integer from 0 to 4.

Examples of the alkyl groups represented by R²¹ and R²² in the above general formula (2) include methyl group, ethyl group, n-propyl group, isopropyl group, various butyl groups (the term “various” includes both linear and all branched-chain forms; the same shall apply hereinafter), various pentyl groups, and various hexyl groups. Examples of the alkoxy groups represented by R²¹ and R²² include those in which the alkyl group moiety corresponds to the above-described alkyl groups. R²¹ and R²² are each preferably an alkyl group having 1 to 4 carbon atoms or an alkoxy group having 1 to 4 carbon atoms.

Examples of the alkylene group represented by X²¹ in the above general formula (2) include a methylene group, ethylene group, trimethylene group, tetramethylene group, and hexamethylene group, with alkylene groups having 1 to 5 carbon atoms being preferred. Examples of the alkylidene group represented by X²¹ include an ethylidene group, isopropylidene group, and 2,2-butylidene group. Examples of the cycloalkylene group represented by X²¹ include cyclopentanediyl group, cyclohexanediyl group, and cyclooctanediyl group, with cycloalkylene groups having 5 to 10 carbon atoms being preferred.

Examples of the cycloalkylidene group represented by X²¹ include cyclohexylidene group, 3,5,5-trimethylcyclohexylidene group, and 2-adamantylidene group, with cycloalkylidene groups having 5 to 10 carbon atoms being preferred, and cycloalkylidene groups having 5 to 8 carbon atoms being more preferred.

In the above general formula (2), a2 and b2 each independently represent an integer from 0 to 4, preferably 0 to 2, and more preferably 0 or 1.

In the present embodiment, it is preferable that the aromatic polycarbonate-based resin (A2) contains a polycarbonate resin having a bisphenol A structure from the viewpoint of mechanical properties and thermal properties of the resulting molded article. Specific examples of the polycarbonate resin having a bisphenol A structure include compounds in which X²¹ in the general formula (2) is an isopropylidene group. The content of the polycarbonate resin having a bisphenol A structure in the aromatic polycarbonate resin (A2) is preferably 50 to 100 mass %, more preferably 75 to 100 mass %, further preferably 85 to 100 mass %, and even more preferably 90 to 100 mass %, relative to the entire aromatic polycarbonate resin (A2).

In the present embodiment, the viscosity average molecular weight (Mv) of the aromatic polycarbonate-based resin (A2) is usually 10,000 to 50,000, preferably 12,000 to 35,000, more preferably 13,000 to 20,000, and even more preferably 13,000 to 18,000.

In this specification, the viscosity average molecular weight (Mv) is determined by measuring the viscosity of a methylene chloride solution at 20° C. using an Ubbelohde-type viscometer, calculating the intrinsic viscosity [η], and then using the following formula:

$$[ □ ] = 1.23 \times {10}^{- 5} \times {Mv}^{0.83}$$

In addition, in this specification, the number average molecular weight (Mn), weight average molecular weight (Mw), and Z average molecular weight (Mz) of the aromatic polycarbonate-based resin (A2) can also be measured using gel permeation chromatography (GPC) as described in the section of Examples below, and it is preferred that the number average molecular weight is 10,000 to 30,000 and the weight average molecular weight is 15,000 to 60,000.

### “(Meth) Acrylic Resin (A3)”

When the transparent thermoplastic resin composition of the present embodiment contains a (meth)acrylic resin (A3) (hereinafter also simply referred to as resin (A3)), excellent effects in light resistance and long-term thermal stability can be obtained.

In the present embodiment, the term “(meth)acrylic resin (A3)” refers to a synthetic resin that essentially contains an unsaturated carboxylic acid ester monomer unit (a3-1), and in which the content of the unsaturated carboxylic acid ester monomer unit (a3-1) is 50 mass % or more relative to the entire (meth)acrylic resin (A3). On the other hand, the styrene-unsaturated carboxylic acid-based resin (A1) contains less than 50 mass % of the unsaturated carboxylic acid ester monomer unit (a1-3) relative to the total amount of the styrene-unsaturated carboxylic acid-based resin (A1).

Furthermore, in the present specification, the number average molecular weight (Mn), weight average molecular weight (Mw), and Z average molecular weight (Mz) of the (meth)acrylic resin (A3) are values measured using gel permeation chromatography (GPC) and calibrated based on standard polystyrene, as described in the Examples section based on data detected by a differential refractometer.

<Unsaturated Carboxylic Acid Ester Monomer Unit (a3-1)>

The unsaturated carboxylic acid ester monomer unit (a3-1) constituting the (meth)acrylic resin (A3) in the present embodiment includes methacrylic acid ester monomer units and acrylic acid ester monomer units. Examples of the unsaturated carboxylic acid ester monomer (a3-1), which is the precursor of the unsaturated carboxylic acid ester monomer unit (a3-1), include (meth)acrylic acid ester monomer, such as methyl acrylate, ethyl acrylate, (n-butyl) acrylate, (2-ethylhexyl) acrylate, (n-octyl) acrylate, benzyl acrylate, methyl methacrylate, butyl methacrylate, ethyl methacrylate, propyl methacrylate, isopropyl methacrylate, cyclohexyl methacrylate, phenyl methacrylate, (2-ethylhexyl) methacrylate, (n-octyl) methacrylate, benzyl methacrylate, and stearyl methacrylate. Among these, methyl acrylate, (n-butyl) acrylate, methyl methacrylate, (2-ethylhexyl) methacrylate, and (n-octyl) methacrylate are preferable in view of their industrial availability and low cost. The (meth)acrylic acid ester monomers (b1-2) may be used alone or in combination, with a combination of two (meth)acrylic acid ester monomers being particularly preferred.

From the viewpoint of balancing heat resistance and thermal decomposition resistance, it is preferable that as the combinations of monomer units constituting the (meth)acrylic resin (A3), copolymers where methacrylic acid ester species and acrylic acid ester species are copolymerized. Among these, a methyl methacrylate-methyl acrylate copolymer is more preferred.

<Unsaturated Carboxylic Acid Monomer Unit (a3-2)>

In the present embodiment, the (meth)acrylic resin (A3) may contain an unsaturated carboxylic acid monomer unit (a3-2). Examples of the unsaturated carboxylic acid monomer unit (a3-2) include acrylic acid or methacrylic acid.

<Preferred Form of (meth)acrylic resin (A3)>

The preferred (meth)acrylic resin (A3) of the present embodiment is preferably a binary or ternary copolymer, and more preferably a methacrylic acid ester-acrylic acid ester copolymer obtained by copolymerizing methacrylic acid ester species (methacrylic acid ester monomer units) and acrylic acid ester species (acrylic acid ester monomer units); and a copolymer containing 0.1 to 25 mass % of the acrylic acid ester monomer units relative to the total amount of the methacrylic acid ester-acrylic acid ester is preferred, a copolymer containing 0.5 to 17 mass % of the acrylic acid ester monomer units is more preferred, a copolymer containing 1.0 to 7.0 mass % of the acrylic acid ester monomer units is even more preferred, a copolymer containing 1.2 to 4.5 mass % of the acrylic acid ester monomer units is still even more preferred, and a copolymer containing 1.5 to 3.0 mass % of the acrylic acid ester monomer units is most preferred.

A preferred (meth)acrylic resin (A3) of the present embodiment is a methyl methacrylate-methyl acrylate copolymer that is more preferably a copolymer containing 0.5 to 17 mass % of methyl acrylate monomer units, and is even more preferably a copolymer containing 1.0 to 5.0 mass % of methyl acrylate monomer units, relative to the total amount of the copolymer. This makes it possible to obtain a (meth)acrylic resin with excellent thermal decomposition resistance and heat resistance.

In the (meth)acrylic resin (A3) of the present embodiment, the lower limit of the content of the unsaturated carboxylic acid ester monomer unit (a3-1) is preferably 54 mass % or more, more preferably 64 mass % or more, further preferably 71 mass % or more, even more preferably 86 mass % or more, still more preferably 91 mass % or more, further more preferably 94 mass % or more, and most preferably 96 mass % or more, relative to the total amount of the (meth)acrylic resin (A3). By setting the content of the unsaturated carboxylic acid ester monomer unit (a3-1) in the range of 54.0 to 100 mass %, the resin can be made resistant to kneading, extrusion, and molding processes with other resins at temperatures below 300° C. As for the types of unsaturated carboxylic acid ester monomer unit (a3-1), methyl acrylate or methyl methacrylate is preferable from the viewpoints of heat resistance, industrial availability, and low cost.

In the transparent thermoplastic resin composition of the present embodiment, the lower limit of the content of the unsaturated carboxylic acid ester monomer unit (a3-1) is preferably 54 mass % or more, more preferably 64 mass % or more, further preferably 71 mass % or more, even more preferably 86 mass % or more, still more preferably 91 mass % or more, further more preferably 94 mass % or more, and most preferably 96 mass % or more, relative to the total amount of the transparent thermoplastic resin composition. By setting the content of the unsaturated carboxylic acid ester monomer unit (a3-1) in the range of 54.0 to 100 mass % relative to the total amount of the transparent thermoplastic resin composition, a transparent thermoplastic resin composition excellent in moldability, heat resistance, transparency (light transmittance), and light resistance can be obtained.

In the (meth)acrylic resin (A3) of the present embodiment, the upper limit of the content of the unsaturated carboxylic acid ester monomer unit (a3-1) in the (meth)acrylic resin (A3) is preferably 100 mass % or less, more preferably 99 mass % or less, more preferably 98 mass % or less, more preferably 97 mass % or less, further preferably 96 mass % or less, further preferably 95 mass % or less, even more preferably 94 mass % or less, and most preferably 93 mass % or less, relative to the total amount of the (meth)acrylic resin (A3).

The above upper limit and the above lower limit can be arbitrarily combined.

In the transparent thermoplastic resin composition of the present embodiment, the upper limit of the content of the unsaturated carboxylic acid ester monomer unit (a3-1) is preferably 100 mass % or less, more preferably 99 mass % or less, more preferably 98 mass % or less, more preferably 97 mass % or less, further preferably 96 mass % or less, further preferably 95 mass % or less, even more preferably 94 mass % or less, and most preferably 93 mass % or less, relative to the total amount of the transparent thermoplastic resin composition.

The above upper limit and the above lower limit can be arbitrarily combined.

In the (meth)acrylic resin (A3) of the present embodiment, the upper limit of the content of the unsaturated carboxylic acid monomer unit (a3-2) in the (meth)acrylic resin (A3) is preferably 15 mass % or less, more preferably 12 mass % or less, even more preferably 5 mass % or less, still even more preferably 3 mass % or less, and most preferably 4 mass % or less, relative to the total amount of the (meth)acrylic resin (A3). The lower limit of the content of the unsaturated carboxylic acid monomer unit (a3-2) in the (meth)acrylic resin (A3) is preferably 0 mass % or more, more preferably 0.5 mass % or more, further preferably 1.0 mass % or more, even more preferably 1.5 mass % or more, and most preferably 2.0 mass % or more, relative to the total amount of the (meth)acrylic resin (A3). The above upper limit and the above lower limit can be arbitrarily combined.

<Optional Monomer Unit (a3-3)>

The (meth)acrylic resin (A3) of the present embodiment may further contain an optional monomer unit (a3-3) in addition to the above-mentioned unsaturated carboxylic acid ester monomer unit (a3-1) and/or unsaturated carboxylic acid monomer unit (a3-2). That is, the optional monomer unit (a3-3) may be copolymerized with monomers other than those listed above if the optional monomer unit (a3-3) may be copolymerized with the unsaturated carboxylic acid ester monomer unit (a3-1) and/or the unsaturated carboxylic acid monomer unit (a3-2), as long as the effects of the invention are not impaired and without particular limitation. Examples of the optional monomer (a3-3) other than the monomers described above include styrene, dimethyl maleate, dimethyl fumarate, diethyl fumarate, ethyl fumarate, maleimide, phenylmaleimide, and nuclear-substituted maleimides.

In the present embodiment, the content of the optional monomer unit (a3-3) is preferably 0 to 30 mass %, more preferably 0 to 20 mass %, further preferably 0 to 15 mass %, still more preferably 0 to 12 mass %, even more preferably 0 to 10 mass %, and further preferably 0 to 7 mass %, relative to the total amount of the (meth)acrylic resin (A3).

The upper limit of the weight average molecular weight (Mw) of the (meth)acrylic resin (A3), in terms of standard polystyrene using the GPC method described later, is preferably 8,000,000 or less, 6,000,000 or less, 5,000,000 or less, 3,000,000 or less, 2,000,000 or less, 1,000,000 or less, 900,000 or less, 500,000 or less, 400,000 or less, 300,000 or less, 250,000 or less, 200,000 or less, 150,000 or less, 130,000 or less, 120,000 or less, and 110,000 or less, in the order of preference. The lower limit of the weight average molecular weight (Mw) of the (meth)acrylic resin (A3) is preferably 40,000 or more, 50,000 or more, 60,000 or more, 70,000 or more, 80,000 or more, and 90,000 or more, in that order. The upper and lower limits of the weight average molecular weight (Mw) of the (meth)acrylic resin (A3) may be arbitrarily combined. In particular, setting Mw to 70,000 or more can provide a resin composition excellent in strength, and setting Mw to 250,000 or less can reduce the viscosity of the resin composition, making it possible to obtain a (meth)acrylic resin (A3) excellent in injection moldability.

The value of the number average molecular weight (Mn) of the (meth)acrylic resin (A3) is in the range of preferably 20,000 to 1,500,000, more preferably 25,000 to 300,000, and even more preferably 30,000 to 120,000, in terms of standard polystyrene using the GPC method to be described later.

The value of the number average molecular weight (Mn) of the (meth)acrylic resin (A3) is in the range of preferably 80,000 to 1,000,000, more preferably 90,000 to 300,000, and even more preferably 100,000 to 250,000, in terms of standard polystyrene using the GPC method to be described later.

The value of the dispersity (Mw/Mn) of the (meth)acrylic resin (A3) is in the range of preferably 1.1 to 6.0, more preferably 1.3 to 4.0, and even more preferably 1.5 to 3.7, in terms of standard polystyrene using the GPC method to be described later. Particularly, by setting the value in the range of 1.5 to 3.7, a transparent thermoplastic resin composition with an excellent balance of moldability and strength can be obtained.

It should be noted that the (meth)acrylic resin (A3) of the present embodiment may contain high molecular weight components of 1,000,000 or more. The high molecular weight components have unsaturated carboxylic acid ester monomer units (a3-1), and the proportion of the (meth)acrylic resin

(A3) with high molecular weight components of 1,000,000 or more among the (meth)acrylic resin (A3) contained in the transparent thermoplastic resin composition is preferably 1.0 mass % or less relative to the total amount of the transparent thermoplastic resin composition.

In the present embodiment, when the (meth)acrylic resin (A3) is classified into a high molecular weight component of 1,000,000 or more and other molecular weight components of less than 1,000,000, a method for controlling the high molecular weight component of 1,000,000 or more in the (meth)acrylic resin (A3) to 1.0 mass % or less includes controlling the type and blend amount of the unsaturated carboxylic acid ester monomer unit (a3-1), the type and blend amount of chain transfer agent, the reaction temperature, residence time, the type and blend amount of polymerization initiator, and the type and blend amount of polymerization solvent during the radical polymerization of the unsaturated carboxylic acid ester monomer unit (a3-1).

In this specification, “high molecular weight component of 1,000,000 or more” refers to the weight ratio of molecular weight of 1,000,000 or more calculated from the slice data of the differential molecular weight distribution in standard polystyrene conversion measured by a differential refractive index detector (RI detector), before calculating various average molecular weights obtained from gel permeation chromatography (GPC) as described in the Examples section.

As described above, it is more preferable that the (meth)acrylic resin (A3) of the present embodiment contains 0.0 mass % or more and 1.0 mass % or less of high molecular weight components of 1,000,000 or more relative to the total amount of the transparent thermoplastic resin composition, and the weight average molecular weight (Mw) of the entire (meth)acrylic resin (A3) is in the range of 70,000 to 250,000.

In the present embodiment, it is particularly preferable that the (meth)acrylic resin (A3) is a copolymer comprising an unsaturated carboxylic acid ester monomer unit (a3-1), which includes a methacrylic acid ester monomer unit and an acrylic acid ester monomer unit. This provides the effect of improving mechanical strength, while also achieving thermal decomposition resistance. <Method for Producing (meth)acrylic resin (A3)>

There are no particular limitations on the method for producing the (meth)acrylic resin (A3) in the present embodiment. However, it can be producing using bulk polymerization where the unsaturated carboxylic acid ester monomer unit (a3-1) and other optional monomers, as required, are polymerized, solution polymerization where a solvent is added, suspension polymerization where the organic phase is dispersed in water using a suspending agent, emulsion polymerization, etc.

In the present embodiment, the styrene-unsaturated carboxylic acid-based resin (A1) contains an unsaturated carboxylic acid monomer unit (a1-2), and contains 50 mass % or more of a styrene-based monomer unit (a1-1) relative to the total amount (100 mass %) of the styrene-unsaturated carboxylic acid-based resin (A1).

In the present embodiment, the aromatic polycarbonate-based resin (A2) contains 50 mass % or more of repeating units represented by the general formula (2), relative to the total amount (100 mass %) of the aromatic polycarbonate-based resin (A2).

In the present embodiment, the (meth)acrylic resin (A3) contains 50 mass % or more of the unsaturated carboxylic acid ester monomer unit (a3-1), relative to the total amount (100 mass %) of the (meth)acrylic resin (A3).

In the present embodiment, the transparent thermoplastic resin (A) may be used by mixing one or more selected from the group consisting of a styrene-unsaturated carboxylic acid-based resin (A1), aromatic polycarbonate-based resin (A2), and (meth)acrylic resin (A3). Furthermore, the styrene-unsaturated carboxylic acid-based resin (A1), aromatic polycarbonate-based resin (A2), and (meth)acrylic resin (A3) may be kneaded and used together to the extent that transparency is not significantly impaired. That is, the transparent thermoplastic resin (A) may be a resin obtained by mixing 0 to 100 mass % of the styrene-unsaturated carboxylic acid-based resin (A1), 0 to 100 mass % of the aromatic polycarbonate-based resin (A2), and 0 to 100 mass % of the (meth)acrylic resin (A3).

In the present embodiment, when the styrene-unsaturated carboxylic acid-based resin (A1) is the main component, it is preferable that the content of the styrene-unsaturated carboxylic acid-based resin (A1) is 60 to 99.999 mass %, and the content of the aromatic polycarbonate-based resin (A2) and/or (meth)acrylic resin (A3) is preferably 0 to 40 mass %; it is more preferable that the content of the styrene-unsaturated carboxylic acid-based resin (A1) is 70 to 99.999 mass %, and the content of the aromatic polycarbonate-based resin (A2) and/or (meth)acrylic resin (A3) is preferably 0 to 30 mass % mass %; it is even more preferable that the content of the styrene-unsaturated carboxylic acid-based resin (A1) is 80 to 99.999 mass %, and the content of the aromatic polycarbonate-based resin (A2) and/or (meth)acrylic resin (A3) is preferably 0 to 20 mass % mass %; and it is still even more preferable that the content of the styrene-unsaturated carboxylic acid-based resin (A1) is 90 to 99.999 mass %, and the content of the aromatic polycarbonate-based resin (A2) and/or (meth)acrylic resin (A3) is preferably 0 to 10 mass % mass %, relative to the total content of the transparent thermoplastic resin composition.

In addition, when the aromatic polycarbonate-based resin (A2) is the main component, it is preferable that the content of the aromatic polycarbonate-based resin (A2) is preferably 60 to 99.999 mass %, and the content of the styrene-unsaturated carboxylic acid-based resin (A1) and/or (meth)acrylic resin (A3) is preferably 0 to 40 mass %; it is more preferable that the content of the aromatic polycarbonate-based resin (A2) is preferably 70 to 99.999 mass %, and the content of the styrene-unsaturated carboxylic acid-based resin (A1) and/or (meth)acrylic resin (A3) is preferably 0 to 30 mass %; it is even more preferable that the content of the aromatic polycarbonate-based resin (A2) is preferably 80 to 99.999 mass %, and the content of the styrene-unsaturated carboxylic acid-based resin (A1) and/or (meth)acrylic resin (A3) is preferably 0 to 20 mass %; and it is still even more preferable that the content of the aromatic polycarbonate-based resin (A2) is preferably 90 to 99.999 mass %, and the content of the styrene-unsaturated carboxylic acid-based resin (A1) and/or (meth)acrylic resin (A3) is preferably 0 to 10 mass %, relative to the total content of the transparent thermoplastic resin composition.

In addition, when the (meth)acrylic resin (A3) is the main component, it is preferable that the content of the (meth)acrylic resin (A3) is 60 to 99.999 mass %, and the content of the styrene-unsaturated carboxylic acid-based resin (A1) and/or the aromatic polycarbonate (A2) is 0 to 40 mass %; it is more preferable that the content of the (meth)acrylic resin (A3) is 70 to 99.999 mass %, and the content of the styrene-unsaturated carboxylic acid-based resin (A1) and/or the aromatic polycarbonate (A2) is 0 to 30 mass %; it is even more preferable that the content of the (meth)acrylic resin (A3) is 80 to 99.999 mass %, and the content of the styrene-unsaturated carboxylic acid-based resin

(A1) and/or the aromatic polycarbonate (A2) is 0 to 20 mass %; and it is still ven more preferable that the content of the (meth)acrylic resin (A3) is 90 to 99.999 mass %, and the content of the styrene-unsaturated carboxylic acid-based resin (A1) and/or the aromatic polycarbonate (A2) is 0 to 10 mass %, relative to the total amount of the transparent thermoplastic resin composition. The styrene-unsaturated carboxylic acid-based resin (A1) and the (meth)acrylic resin (A3) have excellent compatibility, and it is possible to maintain transparency even after kneading. In addition, since the styrene-unsaturated carboxylic acid-based resin (A1) and the aromatic polycarbonate (A2) have similar refractive indices, transparency can be maintained even when kneaded.

In this specification, “component A as the main component relative to B” means that the content of A is 50 mass % or more, preferably 60 mass % or more, more preferably 70 mass % or more, still more preferably 80 mass % or more, even more preferably 90 mass % or more, and most preferably 95 mass % or more, relative to the total amount of B being 100 mass %.

### <Unsaturated Carboxylic Acid Ester Monomer Unit and Unsaturated Carboxylic Acid Monomer Unit in Transparent Thermoplastic Resin Composition>

In the present embodiment, the content of all unsaturated carboxylic acid monomer units contained in the transparent thermoplastic resin composition is 2 to 40 mass %, preferably 3 to 40 mass %, preferably 3 to 35 mass %, more preferably 5 to 30 mass %, still more preferably 8 to 25 mass %, even more preferably 8.5 to 20 mass %, even more preferably 9.0 to 18 mass %, even more preferably 10 to 15 mass %, even more preferably 10.3 to 14 mass %, and particularly preferably in the range of 10.5 to 13 mass %, relative to the total amount (100 mass %) of the transparent thermoplastic resin composition. When the content of the unsaturated carboxylic acid monomer units in the entire resin composition is within this range, the effect of improving heat resistance can be sufficiently obtained.

The above content of all unsaturated carboxylic acid monomer units refers to the total amount of unsaturated carboxylic acid ester monomer units present in the transparent thermoplastic resin composition, and includes the content of unsaturated carboxylic acid monomer units in the resin (A1), resin (A3), and any optionally added resin. The content of all unsaturated carboxylic acid monomer units mainly represents the total amount of the unsaturated carboxylic acid monomer unit (a1-2) and the unsaturated carboxylic acid monomer unit (a3-2).

In the present embodiment, the content of all unsaturated carboxylic acid ester monomer units contained in the transparent thermoplastic resin composition is preferably 0 to 98 mass % relative to the total amount (100 mass %) of the transparent thermoplastic resin composition, more preferably 1 to 80 mass %, further preferably 2 to 60 mass %, still more preferably 2.5 to 40 mass %, even more preferably 3 to 30 mass %, still more preferably 3.5 to 20 mass %, and even more preferably in the range of 4 to 10 mass %. When the content of the unsaturated carboxylic acid ester monomer units in the entire composition is within the above range, excellent balance among injection moldability, transparency (light transmittance), long-term heat stability, and light resistance can be achieved.

The content of all unsaturated carboxylic acid ester monomer units refers to the total amount of unsaturated carboxylic acid ester monomer units present in the transparent thermoplastic resin composition, and includes the respective contents of the unsaturated carboxylic acid ester monomer units in the resin (A1), resin (A3), and any optionally added resin.

The content of all unsaturated carboxylic acid ester monomer units mainly represents the total amount of the unsaturated carboxylic acid ester monomer unit (a1-3) and the unsaturated carboxylic acid ester monomer unit (a3-1).

When the styrene-unsaturated carboxylic acid-based resin (A1) is the main component, by controlling the content of all unsaturated carboxylic acid monomer units and all unsaturated carboxylic acid ester monomer units contained in the transparent thermoplastic resin composition within the above ranges, it is possible to simultaneously and efficiently obtain the effect of improving heat resistance by the unsaturated carboxylic acid monomer units and the transparency (light transmittance) by the unsaturated carboxylic acid ester monomer units, and as a result, a transparent thermoplastic resin composition and a molded article obtained by injection molding the same that are excellent in heat resistance and transparency (light transmittance) can be obtained.

### “Phosphorus-Based Compound (B)”

The phosphorus-based compound (B) in the present embodiment is represented by the general formula (1). This provides an effect of improving long-term heat stability.

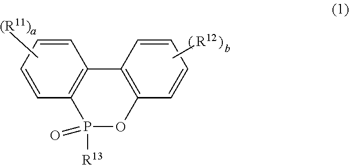

In the above general formula (1), R¹¹ and R¹² each independently represent a halogen atom or a lower alkyl group, and R¹³ represents a hydrogen atom, a halogen atom, a hydroxyl group, an alkyl group having 1 to 10 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; and a and b each independently represent an integer from 0 to 4. a of 0 represents no substitution, and b of 0 represents no substitution.

The phosphorus-based compound (B) is preferably one or more compounds selected from the group consisting of a phosphinic acid-based compound (B1) and a phosphonic acid ester-based compound (B2).

In the above general formula (1), unsubstituted R¹¹ and R¹² are most preferable. R¹³ is most preferably a hydrogen atom. a and b are preferably each independently 0, 1, or 2.

In this specification, the term “aromatic ring” includes monocyclic aromatic rings, fused aromatic rings, or ring-assembled aromatic rings. Examples of the monocyclic aromatic ring include benzene, furan, pyrrole, thiophene, imidazole, pyrazole, oxazole, isoxazole, pyridine, pyrimidine, pyridazine, pyrazine, or triazine. Examples of the fused aromatic ring include naphthalene, anthracene, phenalene, phenanthrene, quinoline, coumarin, indole, benzimidazole, or benzofuran. Examples of the ring-assembled aromatic ring include biphenyl, binaphthyl, bipyridyl, bithiophene, or phenylpyridine.

In addition, one or more hydrogen atoms of the aromatic ring may be substituted with one or more substituents. The substituent R is preferably, for example, an alkyl group having 1 to 12 carbon atoms, an aryl group having 6 to 30 carbon atoms, a hydroxyl group, an alkoxy group having 1 to 12 carbon atoms, an amino group, or an imino group having an alkyl group with 1 to 5 carbon atoms.

It is noted that a monovalent aromatic ring includes a group in which any one hydrogen atom of the above-mentioned aromatic rings is removed.

In this specification, an “alkyl group” may be linear, branched, or cyclic. Specific examples of the alkyl group include methyl, ethyl, propyl, isopropyl, n-butyl, isobutyl, sec-butyl, tert-butyl, n-pentyl, isopentyl, tert-pentyl, neopentyl, 1,2-dimethylpropyl, n-hexyl, isohexyl, (n-) heptyl, (n-) octyl, (n-) nonyl, (n-) decyl, cyclopropyl, cyclobutyl, cyclopentyl, cyclohexyl, cycloheptyl, cyclooctyl, cyclononyl, norbornyl, or adamantyl groups. Low alkyl groups are preferably alkyl groups having 1 to 4 carbon atoms.

Examples of “aryl group” include phenyl, 1-naphthyl, or 2-naphthyl. Examples of “alkoxy group” include methoxy, ethoxy, propoxy, isopropoxy, butoxy, pentyloxy, hexyloxy, 2-ethylhexyloxy, or octyloxy groups.

### “Phosphinic Acid-Based Compound (B1)”

In the present embodiment, examples of the phosphinic acid-based compound (B1) include: 9,10-dihydro-9-oxa-10-phosphaphenanthrene-10-oxide represented by the following chemical formula (1-1) (manufactured by Sanko Co., Ltd under the trade name “HCA”), 10-(2,5-dihydroxyphenyl)-9,10-dihydro-9-oxa-10-phosphaphenanthrene-10-0 xide represented by the following chemical formula (1-2) (manufactured by Sanko Co., Ltd under the trade name “HCA-HQ”), and 9,10-dihydro-10-benzyl-9-oxa-10-phosphaphenanthrene-10-oxide represented by the following chemical formula (1-3) (developed and manufactured by Sanko Co., Ltd., under the name “BCA”).

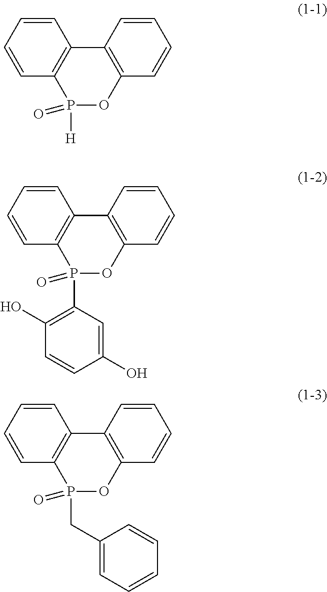

Among these, 9,10-dihydro-9-oxa-10-phosphaphenanthrene-10-oxide is particularly preferable in view of the initial hue and long-term heat stability when added to the transparent thermoplastic resin composition.

### “Phosphonic Acid Ester-Based Compound (B2)”

As the above phosphonic acid ester-based compound (B2), for example, compounds represented by the following general formula (1-4) may be mentioned:

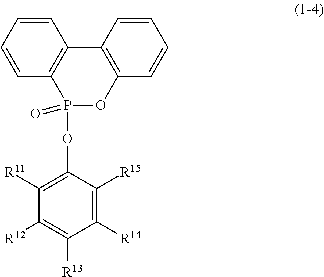

in the general formula (1-4), R¹¹ to R¹⁵ each independently represent a hydrogen atom or a monovalent hydrocarbon group which may have a substituent, and R¹¹ to R¹⁵ may be the same or different.

In this specification, the monovalent hydrocarbon group may be linear (either straight-chain or branched-chain) or cyclic (including monocyclic, fused polycyclic, bridged, or spiro ring systems), for example, a cyclic hydrocarbon group having a side chain can be mentioned, and an alkyl group or a monovalent aromatic ring is preferable. The hydrocarbon group may be saturated or unsaturated.

Examples of such hydrocarbon groups include alkyl groups, cycloalkyl groups, allyl groups, aryl groups, or aralkyl groups.

Specific examples of the phosphonic acid esters represented by the chemical formula (1-4) include compounds represented by formulas (1-4.1) to (1-4.8) below.

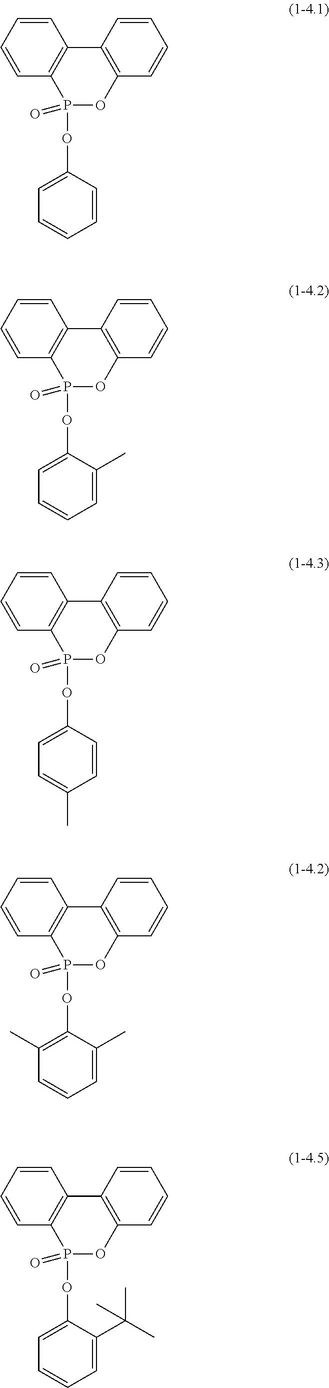 [SMILES: O=P1(Oc2ccccc2)Oc2ccccc2-c2ccccc21 ; Cc1ccccc1OP1(=O)Oc2ccccc2-c2ccccc21 ; Cc1ccc(OP2(=O)Oc3ccccc3-c3ccccc32)cc1 ; Cc1cccc(C)c1OP1(=O)Oc2ccccc2-c2ccccc21 ; CC(C)(C)c1ccccc1OP1(=O)Oc2ccccc2-c2ccccc21]

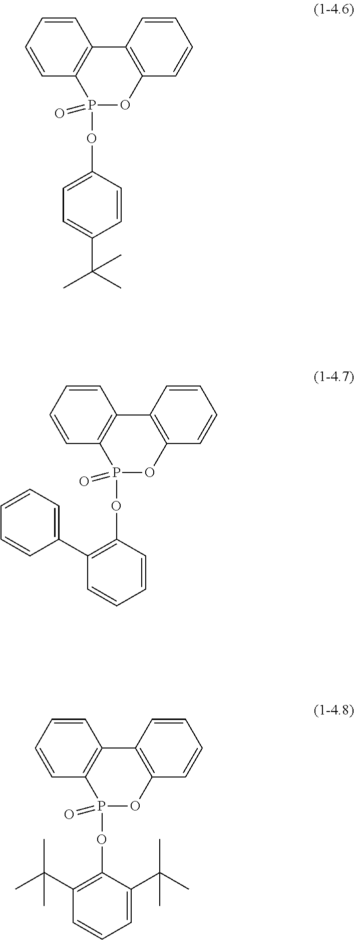 [SMILES: CC(C)(C)c1ccc(OP2(=O)Oc3ccccc3-c3ccccc32)cc1 ; O=P1(Oc2ccccc2-c2ccccc2)Oc2ccccc2-c2ccccc21 ; CC(C)(C)c1cccc(C(C)(C)C)c1OP1(=O)Oc2ccccc2-c2ccccc21]

In the present embodiment, the preferred content of the above-described phosphorus-based compound (B) in the transparent thermoplastic resin composition is preferably 0.001 to 0.3 mass %, more preferably 0.01 to 0.2 mass %, still more preferably 0.02 to 0.15 mass %, even more preferably 0.03 to 0.12 mass %, further preferably 0.03 to 0.1 mass %, and even further preferably 0.03 to 0.08 mass %, relative to the total amount of the transparent thermoplastic resin composition. When the phosphorus-based compound (B) is added in an amount of 0.001 to 0.3 mass % to the transparent thermoplastic resin composition, the initial hue becomes favorable due to the effects of heat degradation of the resin during kneading in an extruder or during molding, and the long-term heat stability tends to br improved. If the content of the phosphorus-based compound (B) exceeds 0.3 mass %, there is concern that the transparency and L* value of the resin may decrease when added to the transparent thermoplastic resin composition, leading to a reduction in the initial hue.

Although the phosphorus-based compound (B) may also be used as a flame retardant, it is insufficient to impart flame retardancy in the above addition range. Although at least 0.5 mass % must be included in the resin composition to impart flame retardancy, such an amount would impair its transparency. Therefore, it is necessary to add the phosphorus-based compound (B) within the above-described range.

In the present embodiment, the phosphorus-based compound (B) is a compound represented by the general formula (1), and it does not include the phosphorus-based antioxidant (C2) described later.

The above is the description regarding the essential components of the transparent thermoplastic resin composition of the present embodiment. The following describes each component that may be optionally added to the transparent thermoplastic resin composition of the present embodiment.

### “Antioxidant (C)”

In the transparent thermoplastic resin composition of the present embodiment, an antioxidant (C) may be added. The use of a phenolic antioxidant (C1) and/or a phosphorus-based antioxidant (C2) can further improve the initial hue and long-term heat stability of the transparent thermoplastic resin composition.

Examples of the phenolic antioxidant (C1) include octadecyl-3-(3,5-di-tert-butyl-4-hydroxyphenyl) propionate, pentaerythritol tetrakis [3-(3′,5′-di-tert-butyl-4′-hydroxyphenyl) propionate], 4,6-bis(octylthiomethyl)-o-cresol, ethylene bis(oxyethylene bis(3-tert-butyl-4-hydroxy-5-methylbenzenepropionate)), 2,2′-dimethyl-2,2′-(2,4,8, 10-tetraoxaspiro[5.5]undecane-3,9-diyl) dipropane-1, l′-diyl bis [3-(3-tert-butyl-4-hydroxy-5-methylphenyl) propanoate], 2-{1-[2-hydroxy-3,5-bis(2-methylbutan-2-yl)phenyl]ethyl}-4,6-bis (2-methylb utan-2-yl) phenyl prop-2-enoate, 2-tert-butyl-6-[(3-tert-butyl-2-hydroxy-5-methylphenyl)methyl]-4-methylphe nyl acrylate, N,N′-(1,6-hexanediyl) bis [3,5-bis(1,1-dimethylethyl)-4-hydroxybenzenepropi onamide], 1,6-hexanediol bis [3-(3,5-di-tert-butyl-4-hydroxyphenyl) propionate], 1,3,5-tris [[3,5-bis (1,1-dimethylethyl)-4-hydroxyphenyl]methyl]-1,3,5-triazine -2,4,6 (1H,3H,5H)-trione (trade names include, for example, Irganox 1076, Irganox 1010, Irganox 245 manufactured by BASF Japan Ltd., Sumilizer GA-80, Sumilizer GS, Sumilizer GM manufactured by Sumitomo Chemical Co., Ltd., Irganox 1098, Irganox 259, Irganox 3114).

Examples of the phosphorus-based antioxidant (C2) include tris (2,4-di-tert-butylphenyl) phosphite, 3,9-bis(2,6-di-tert-butyl-4-methylphenoxy)-2,4,8,10-tetraoxa-3,9-diphosphasp iro [5.5]undecane, triphenyl phosphite, triisodecyl phosphite, 3,9-dioctadecan-1-yl-2,4,8, 10-tetraoxa-3,9-diphosphaspiro[5.5]undecane (trade names include, for example, Irgafos 168 manufactured by BASF Japan Ltd., ADK STAB PEP-36, ADK STAB TPP, ADK STAB 3010, ADK STAB PEP-8 manufactured by ADEKA Corporation).

In the present embodiment, the antioxidant (C) may be a phosphorus-based antioxidant having a hindered phenol group, such as 6-[3-(3-tert-butyl-4-hydroxy-5-methylphenyl) propoxy]-2,4,8,10-tetra-tert-but yldibenzo[d,f] [1,3,2]dioxaphosphepine (e.g., trade name: Sumilizer GP, manufactured by Sumitomo Chemical Co., Ltd.). When 6-[3-(3-t-butyl-4-hydroxy-5-methylphenyl) propoxy]-2,4,8,10-tetra-t-butyl-di benzo[d,f] [1,3,2]dioxaphosphepine is used, the content shall be calculated as the content of the phenolic antioxidant (C1).

These may be used alone or in combination of two or more. There is no particular restriction on the timing of addition; it can be added either during the polymerization step or the devolatilization step. The antioxidant (C) may also be mixed using a mechanical device such as an extruder or a mixer.

The (total) content of antioxidants (C) in the present embodiment is preferably 0.001 to 1.0 mass % relative to the total amount of the transparent thermoplastic resin composition. The preferred lower limit of the addition amount of the antioxidant (C) relative to the total amount of the transparent thermoplastic resin composition is 0.001 mass % or more, more preferably 0.005 mass % or more, still more preferably 0.008 mass % or more, even more preferably 0.01 mass % or more, further preferably 0.03 mass % or more, more preferably 0.04 mass % or more, and more preferably 0.05 mass % or more. The preferred upper limit of the addition amount of the antioxidant (C) relative to the total amount of the transparent thermoplastic resin composition is preferably 1.0 mass % or less, more preferably 0.8 mass % or less, still more preferably 0.6 mass % or less, even more preferably 0.5 mass % or less, further preferably 0.4 mass % or less, more preferably 0.35 mass % or less, and more preferably 0.3 mass % or less. If the content of the antioxidant (C) in the transparent thermoplastic resin composition is too high, the initial hue of the resin may be reduced, or thermal discoloration may be more likely to occur. If the content of the antioxidant (C) is too low, degradation during extrusion or molding and thermal degradation are more likely to occur, raising concerns of reduction in initial hue and thermal stability. The above upper limit and the above lower limit can be arbitrarily combined.

The (total) content of the phenolic antioxidant (C1) in the present embodiment is from 0.001 to 0.5 mass % relative to the total amount (100 mass %) of the transparent thermoplastic resin composition. The preferred lower limit of the addition amount of the phenolic antioxidant (C1) is preferably 0.001 mass % or more, more preferably 0.005 mass % or more, still more preferably 0.008 mass % or more, even more preferably 0.01 mass % or more, further preferably 0.03 mass % or more, more preferably 0.04 mass % or more, and more preferably 0.05 mass % or more. The preferred upper limit of the addition amount of the phenolic antioxidant (C1) is preferably 0.5 mass % or less, more preferably 0.4 mass % or less, still more preferably 0.3 mass % or less, even more preferably 0.2 mass % or less, and further preferably 0.15 mass % or less. If the content of the phenolic antioxidant (C1) in the transparent thermoplastic resin composition is less than the predetermined amount, discoloration due to degradation during resin processing and discoloration during long-term heat exposure are more likely to occur, and the initial hue tends to be reduced.

In addition, if the content of the antioxidant is too high, degradation of the phenolic antioxidant (C1) due to heat tends to produce quinone-based compounds that cause yellowing. As a result, discoloration during long-term heat exposure is more likely to occur. The above upper limit and the above lower limit can be arbitrarily combined.

The (total) content of the phosphorus-based antioxidant (C2) in the present embodiment is preferably 0.001 to 0.5 mass % relative to the total amount (100 mass %) of the transparent thermoplastic resin composition. The preferred lower limit of the addition amount of the phosphorus-based antioxidant (C2) is preferably 0.001 mass % or more, more preferably 0.005 mass % or more, still more preferably 0.008 mass % or more, even more preferably 0.01 mass % or more, further preferably 0.03 mass % or more, more preferably 0.05 mass % or more, more preferably 0.08 mass % or more, and more preferably 0.1 mass % or more. The preferred upper limit of the addition amount of the phosphorus-based antioxidant (C2) is preferably 0.5 mass % or less, more preferably 0.4 mass % or less, still more preferably 0.35 mass % or less, even more preferably 0.3 mass % or less, further preferably 0.25 mass % or less, and more preferably 0.2 mass % or less. If the content of the phosphorus-based antioxidant (C2) in the transparent thermoplastic resin composition is higher than the predetermined amount, degradation during resin processing and thermal degradation are less likely to occur, but discoloration during long-term heat exposure becomes more likely. On the other hand, if the antioxidant content is too low, degradation during processing and discoloration during long-term heat exposure become more likely. The above upper limit and the above lower limit can be arbitrarily combined.

The total content of the phenolic antioxidant (C1) and the phosphorus-based antioxidant (C2) in the present embodiment is 0.001 to 1.0 mass % relative to the total amount (100 mass %) of the transparent thermoplastic resin composition. The preferred lower limit of the total content of the phenolic antioxidant (C1) and the phosphorus-based antioxidant (C2) is preferably 0.001 mass % or more, more preferably 0.005 mass % or more, still more preferably 0.008 mass % or more, even more preferably 0.01 mass % or more, more preferably 0.03 mass % or more, more preferably 0.05 mass % or more, more preferably 0.08 mass % or more, more preferably 0.1 mass % or more, more preferably 0.12 mass % or more, and more preferably 0.15 mass % or more. The preferred upper limit of the total content is preferably 1.0 mass % or less, more preferably 0.8 mass % or less, still more preferably 0.6 mass % or less, even more preferably 0.5 mass % or less, further preferably 0.45 mass % or less, more preferably 0.4 mass % or less, more preferably 0.35 mass % or less, and more preferably 0.3 mass % or less. The above upper limit and the above lower limit can be arbitrarily combined.

In the present embodiment, when both a phenolic antioxidant (C1) and a phosphorus-based antioxidant (C2) are used, the molar ratio of the phenolic antioxidant (C1) to the phosphorus-based antioxidant (C2) is in the range of 5:1 to 1:5, more preferably 4:1 to 1:4, even more preferably 3:1 to 1:3, even more preferably 2:1 to 1:3, even more preferably 1:1 to 1:2.5. These ratios of antioxidants (C) are particularly effective in preventing resin discoloration.

In the present embodiment, the addition amount ratio of the phosphorus-based compound (B) to the phenolic antioxidant (C1) (phenolic antioxidant (C1)/phosphorus-based compound (B)) is preferably 0.1 to 10, more preferably 0.3 to 8, even more preferably 0.5 to 5, still more preferably 0.8 to 5, further preferably 0.8 to 3, more preferably 1 to 3, and more preferably 1 to 2. By setting the addition amount ratio of the phosphorus-based compound (B) to the phenolic antioxidant (C1) as described above, a transparent thermoplastic resin composition excellent in initial hue and long-term thermal stability can be obtained.

In the present embodiment, the addition amount ratio of the phosphorus-based compound (B) to the phosphorus-based antioxidant (C2) (phosphorus-based antioxidant (C2)/phosphorus-based compound (B)) is preferably 0.1 to 15, more preferably 0.1 to 10, more preferably 0.3 to 8, more preferably 0.5 to 6, more preferably 0.5 to 5, more preferably 0.8 to 6, more preferably 1 to 6, more preferably 1 to 5, more preferably 1 to 4, and more preferably 1.5 to 4. By setting the addition amount ratio of the phosphorus-based compound (B) to the phosphorus-based antioxidant (C2) as described above, a transparent thermoplastic resin composition excellent in initial hue and long-term thermal stability can be obtained.

In the present embodiment, among the phenolic antioxidants (C1), when octadecyl-3-(3,5-di-tert-butyl-4-hydroxyphenyl) propionate (trade names: Irganox 1076 manufactured by BASF Japan Ltd., or AO-50 manufactured by ADEKA Corporation) is used in combination with the phosphorus-based antioxidant (C2), the thermal stability is particularly improved, and a resin composition with excellent initial hue and less discoloration during molding or extrusion processing and during long-term heat exposure can be obtained.

In the present embodiment, among phosphorus-based antioxidants (C2), Irgafos 168 (chemical name: tris (2,4-di-tert-butylphenyl) phosphite)) has particularly an effect of being excellent in hydrolysis resistance, making it suitable for use with resins that have moisture absorption properties or under high humidity conditions. Furthermore, the thermal stability is further improved, discoloration during molding or extrusion processing of the resin is suppressed, excellent initial hue is achieved, and a resin composition with little discoloration during long-term heat exposure can be obtained.

In the present embodiment, among phosphorus-based antioxidants (C2), ADK STAB PEP-36 (chemical name: 3,9-bis(2,6-di-tert-butyl-4-methylphenoxy)-2,4,8,10-tetraoxa-3,9-diphosphaspiro[5.5]undecane), ADK STAB TPP (chemical name: triphenyl phosphite), ADK STAB 3010 (chemical name: triisodecyl phosphite), and ADK STAB PEP-8 (chemical name: 3,9-dioctadecyl-1,2,4,8,10-tetraoxa-3,9-diphosphaspiro[5.5]undecane) exhibit high effects in improving thermal stability during processing and are less prone to discoloration.

In the present embodiment, sulfur-based antioxidants can also be used, and examples include dilauryl 3,3′-thiodipropionate, dimyristyl 3,3′-thiodipropionate, distearyl 3,3′-thiodipropionate, pentaerythritol tetrakis (3-laurylthiopropionate), ditridecyl 3,3′-thiodipropionate, and 2-mercaptobenzimidazole.

### “Ultraviolet Absorber (D)”

The ultraviolet absorber (D) of the present embodiment functions to absorb ultraviolet rays that would otherwise be absorbed by the resin composition, converting them into heat or chemical energy to suppress the generation of photoradicals when ultraviolet light is absorbed by the resin composition and thus prevent degradation and discoloration of the resin. Preferred examples of the ultraviolet absorber (D) are compounds containing two or more aromatic rings connected via a linking group that includes atoms with unpaired electrons (such as oxygen, nitrogen, sulfur, or phosphorus atoms), and at least one of the aromatic rings has a phenolic hydroxyl group. These compounds have chemical structures that can convert the absorbed light into chemical energy after reaching an excited state. Examples of the ultraviolet absorbers (D) include, for example, benzotriazole-based compounds, triazine-based compounds, benzophenone-based compounds, benzoate-based compounds, cyanoacrylate-based compounds, oxalic acid anilide-based compounds, malonic acid ester-based compounds, formamidine-based compounds, and salicylate-based compounds. These ultraviolet absorbers (D) may be used alone or in combination with two or more types, and when used in combination with the light stabilizer (E) to be described later, they provide a higher light resistance effect, in other words, they suppress discoloration and reduction in strength of the transparent thermoplastic resin composition after exposure to light. Preferably, ultraviolet absorbers (D) that are capable of absorbing ultraviolet rays in the wavelength range (250 to 350 nm) that are easily absorbed by the resins used as the transparent thermoplastic resin composition, instead.

The ultraviolet absorber (D) of the present embodiment is more preferably one or two or more selected from the group consisting of benzotriazole-based compounds, triazine-based compounds, benzophenone-based compounds, benzoate-based compounds, cyanoacrylate-based compounds, malonic acid ester-based compounds, and oxalic acid anilide-based compounds, for example.

A preferred ultraviolet absorber (D) in the present embodiment is preferably compounds selected from the group consisting of one or two or more of compounds represented by the following general formulas (d) and (d′):

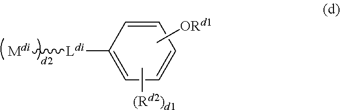

in the above general formula (d), M^{di} each independently represents a monovalent or higher aromatic group, R^{d1} represents a hydrogen atom or an alkyl group having 1 to 10 carbon atoms, L^{di} each independently represents a divalent to pentavalent group, R^{d2} represents an alkyl group having 1 to 15 carbon atoms or an aralkyl group having 7 to 25 carbon atoms, wherein —CH₂—in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; d1 represents an integer from 0 to 4, and d2 represents an integer from 1 to 4. The wavy line connecting M^{di} and L^{di} in the above general formula (d) indicates the presence of one or more chemical bonds that are greater than or equal to a single bond, and d1 of 0 represents no substitution,

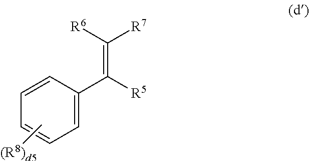

in the above general formula (d′), R⁵ to R⁷ each independently represent a hydrogen atom, a halogen atom, a hydroxyl group, a cyano group, a phenyl group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; R⁸ each independently represents a halogen atom, a hydroxyl group, a cyano group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; d5 represents an integer from 0 to 4, and when d5 is 2 or more, R⁸ may be the same or different from each other. d5 of 0 represents no substitution.

In the above general formula (d), each M^{di} independently represents a monovalent or higher unsubstituted aromatic group or substituted aromatic group where one or more hydrogen atoms are substituted with a substituent R², and preferably is a monovalent to tetravalent aromatic ring where one or more hydrogen atoms may be substituted by the substituent R², and more preferably a group represented by the following formulas (I) or (II):

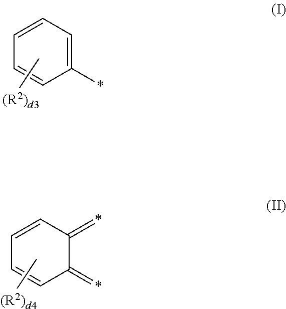

in the above formula (I) or (II), each R² independently represents a halogen atom, hydroxyl group, cyano group, or an alkyl group having 1 to 15 carbon atoms, wherein —CH₂— in the alkyl group may be substituted with —O— or —C(═O)—, d3 represents an integer of 0 to 5, and d4 represents an integer of 0 or more and 4 or less. d3 of 0 represents no substitution, and d4 of 0 represents no substitution.

The substituent R² preferably represents a halogen atom, hydroxyl group, cyano group, or an alkyl group having 1 to 15 carbon atoms, wherein —CH₂—in the alkyl group may be substituted with —O— or —C(═O)—.

In the above general formula (d), each L^{di} independently represents a divalent to pentavalent group, and specifically, is preferably a linking group represented by —C(═O)—, —C(═O)—O—, —O—C(═O)—, —N═, —NH—C(═O)—C(═O)—NH—, or the following formulas (III) or (IV).

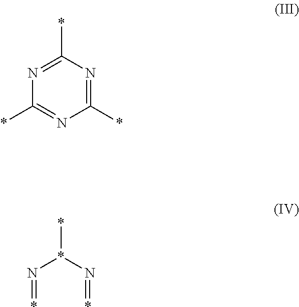

In the above general formula (d), d1 represents an integer of 0 or more and 4 or less, and is preferably 0, 1, 2, or 3.

In the above general formula (d), d2 relates to the number of bonds (valence) of L^{di}. When d2 is 1, L^{di} is a divalent group. Similarly, when d2 is 2, L^{di} is a trivalent group; when d2 is 3, L^{di} is a tetravalent group; and when d2 is 4, L^{di} is a pentavalent group. Therefore, d2 may be (the number of bonds (valence) of L^{di} minus 1).

In the above general formula (d), R^{d2} represents an alkyl group having 1 to 15 carbon atoms, wherein —CH₂— in the alkyl group may be substituted with —O— or —C(═O)—, or —CH₂—CH₂— in the alkyl group may be substituted with —CH═CH—, —C(═O)—O—, —O—C(═O)—, —CH₂O—, or —OCH₂—, and preferably is a straight-chain or branched alkyl group having 1 to 13 carbon atoms, an alkoxy group having 1 to 13 carbon atoms, or an alkoxy group having an ester bond and 1 to 13 carbon atoms. Additionally, when d1 is an integer of 2 or more, the multiple R^{d2} groups may be identical or different.

As one preferred aspect of the ultraviolet absorber (D) of the present embodiment, specifically, compounds represented by the following general formula (d) are preferred.

Among the compounds represented by the above general formula (d), one or more compounds selected from the group consisting of the following general formula (d-1), general formula (d-2), general formula (d-3), and general formula (d-4) are more preferred.

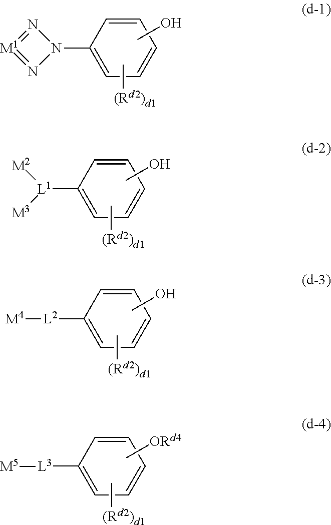

In the above general formula (d-1), M¹ represents a group represented by the above formula (II).

In the above general formula (d-2), M² and M³ represent groups represented by the above formula (I), and L¹ represents —N═ or a group represented by the above formula (III).

In the above general formula (d-3), M⁴ represents a group represented by the above formula (I), and L² represents-C(═O)—, —C(═O)—O—, or —O—C(═O)—. In the above general formula (d-4), M⁵ represents a hydrogen atom, a halogen atom, a hydroxyl group, a cyano group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and preferably is a group represented by the above formula (I); R^{d4} represents an alkyl group having 1 to 10 carbon atoms, and L³ is —NH—C(═O)—C(═O)—NH—.

Note that “R^{d2} and d1” in the above general formulas (d-1) to (d-4) are as defined by “R^{d2} and d1” in the above general formula (d).

Among the compounds represented by the above general formula (d-1), compounds represented by the following general formulas (d-1.1) or (d-1.2) are preferred:

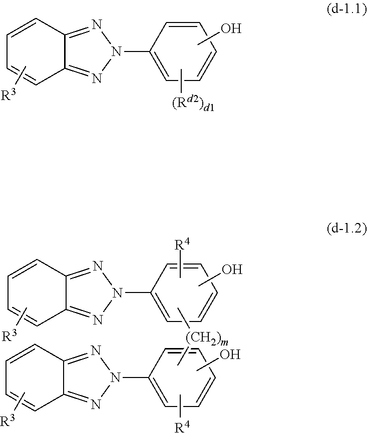

in the above general formula (d-1.1), R³ represents a hydrogen atom, a halogen atom, a hydroxyl group, a cyano group, or an alkyl group having 1 to 15 carbon atoms, wherein —CH₂— in the alkyl group may be substituted with —O— or —C(═O)—, and R^{d2} and d1 are as defined by “R^{d2} and d1” in the above general formula (d), and, in the above general formula (d-1.2), R³ represents a hydrogen atom, a halogen atom, a hydroxyl group, a cyano group, or an alkyl group having 1 to 15 carbon atoms, wherein —CH₂— in the alkyl group may be substituted with —O— or —C(═O)—, R⁴ independently represents a hydrogen atom, an alkyl group having 1 to 15 carbon atoms, or an alkoxy group, and m represents an integer of 1 to 5.

Among the compounds represented by the above general formula (d-2), compounds represented by the following general formula (d-2.1) are preferred:

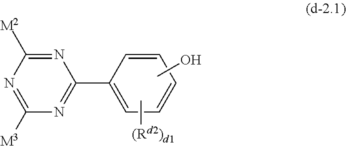

in the above general formula (d-2.1), M² and M³ represent groups represented by the above formula (I), and R^{d2} and d1 are as defined by “R^{d2} and d1” in the above general formula (d).

Among the compounds represented by the above general formula (d-3), compounds represented by the following general formula (d-3.1) are preferred.

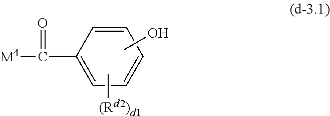

in the above general formula (d-3.1), M⁴ represents a group represented by the above formula (I), and R^{d2} and d1 are as defined by “R^{d2} and d1” in the above general formula (d).

As a preferred ultraviolet absorber (D) of the present embodiment, specifically, compounds represented by the following general formula (d-4.1) are also preferably used.

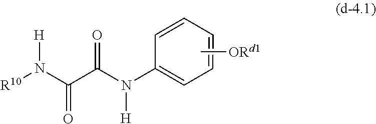

in the above general formula (d-4.1), R¹⁰ each independently represents a hydrogen atom, a halogen atom, a hydroxyl group, a cyano group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—.

In the compounds represented by the general formula (d-4.1), from the viewpoint of compatibility with styrene-based resins and stability, R¹⁰ is preferably an aralkyl group having 7 to 25 carbon atoms, more preferably an aralkyl group having 7 to 20 carbon atoms, even more preferably an aralkyl group having 7 to 18 carbon atoms. However, —CH₂— in the aralkyl group may be substituted with —O— or —C(═O)—, or —CH₂—CH₂— in the aralkyl group may be substituted with —CH═CH—, —C(═O)—O—, —O—C(═O)—, —CH₂O—, or —OCH₂—.

As another preferred ultraviolet absorber (D) in the present embodiment, specifically, compounds represented by the following general formula (d′) are also preferably used:

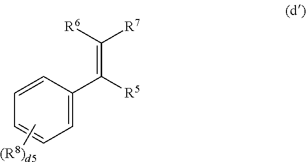

in the above general formula (d′), R⁵ to R⁷ each independently represent a hydrogen atom, a halogen atom, a hydroxyl group, a cyano group, a phenyl group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; R⁸ each independently represents a halogen atom, a hydroxyl group, a cyano group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; d5 represents an integer from 0 to 4, and when d5 is 2 or more, R⁸ may be the same or different from each other.

In the above general formula (d′), R⁵ each independently represents a hydrogen atom, a halogen atom, a hydroxyl group, a cyano group, a phenyl group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring. Particularly, from the viewpoint of stability, R⁵ is preferably a phenyl group or a hydrogen atom.

Among the preferred forms of R⁶ and R⁷ in the above general formula (d′), groups represented by the following general formula (V) or cyano groups (—CN) are preferred:

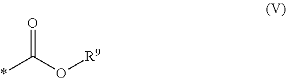

in the above general formula (V), R⁹ represents a hydrogen atom, a halogen atom, a hydroxyl group, a cyano group, an alkyl group having 1 to 15 carbon atoms, an alkenyl group having 2 to 15 carbon atoms, or an aralkyl group having 7 to 25 carbon atoms, wherein —CH₂— in the alkyl group may be substituted with —O— or —C(═O)—, and —CH3 in the alkyl group may be substituted with —CN.

Particularly, from the viewpoint of compatibility with styrene-based resins and stability, in the above general formula (V), R⁹ is preferably an alkyl group having 1 to 15 carbon atoms, more preferably an alkyl group having 1 to 10 carbon atoms, even more preferably an alkyl group having 1 to 5 carbon atoms, still even more preferably an alkyl group having 1 to 3 carbon atoms, and particularly preferably an alkyl group having 1 to 2 carbon atoms.

As the preferred forms of R⁸ in the above general formula (d′), groups represented by the general formula (V) or alkyl groups having 1 to 15 carbon atoms are cited, wherein —CH₂— in the alkyl group may be substituted with —O—or —C(═O)—.

The position of R⁸ in the above general formula (d′) is preferably at the para-position on the benzene ring in the above general formula (d′).

In the above general formula (d′), from the viewpoint of stability, d5 is preferably 0 or 1.

In the present embodiment, when a UV absorber (D) is used, the content of the UV absorber (D) is preferably 0.001 to 1.0 mass % relative to the total amount of the transparent thermoplastic resin composition. The upper limit of the content of the UV absorber (D) is preferably 0.8 mass % or less, 0.6 mass % or less, 0.4 mass % or less, 0.2 mass % or less, 0.15 mass % or less, 0.1 mass % or less, 0.08 mass % or less, 0.06 mass % or less, and 0.05 mass % or less, in the order of preference. The lower limit of the content of the UV absorber (D) is preferably 0.002 mass % or more, 0.004 mass % or more, 0.006 mass % or more, and 0.010 mass % or more, in the order of preference. The above upper limit and the above lower limit of the content of the UV absorber (D) may be combined arbitrarily.

Examples of the benzotriazole-based compound mentioned above include, for example, 2-(2′-hydroxy-5′-methylphenyl)benzotriazole, 2,2′-methylenebis [6-(2H-benzotriazol-2-yl)-4-tert-octylphenol], 2-(2′-hydroxy-3′,5′-di-tert-amylphenyl)benzotriazole, 2-(2′-hydroxy-5′-tert-octylphenyl)benzotriazole, 6-(2-benzotriazolyl)-4-tert-octyl-6′-tert-butyl-4′-methyl-2,2′-methylenebisphe nol, 2-(2′-hydroxy-3′-tert-butyl-5′-methylphenyl)-5-chlorobenzotriazole, and 2-(2H-benzotriazol-2-yl)-4-(1,1,3,3-tetramethylbutyl) phenol. Specific product names include ADK STAB LA-32, ADK STAB LA-36, and ADK STAB

LA-36RG manufactured by ADEKA Corporation, JF-77, JF-79, JF-80, JF-83, JF-832, and AST-500 manufactured by Johoku Chemical Co., Ltd., and Tinuvin P, Tinuvin 234, Tinuvin 234FF, Tinuvin 326, Tinuvin 329, and Tinuvin 360 manufactured by BASF Japan Ltd.

Examples of the triazine-based compound mentioned above include, for example, 2-(4,6-diphenyl-1,3,5-triazine-2-yl)-5-[2-(2-ethylhexanoyloxy) ethoxy] phenol, 2,4,6-tris (2-hydroxy-4-hexyl-3-methylphenyl)-1,3,5-triazine, N,N′,N″-tris (m-tolyl)-1,3,5-triazine-2,4,6-triamine, 2,4,6-tris(4-butoxy-2-hydroxyphenyl)-1,3,5-triazine, 2,4-bis(2,4-dimethylphenyl)-6-(2-hydroxy-4-n-octyloxyphenyl)-1,3,5-triazine, ethylhexyl triazine, 2-(2,4-dihydroxyphenyl)-4,6-bis(2,4-dimethylphenyl)-1,3,5-triazine, 2,4,6-tris (2,4-dihydroxyphenyl)-1,3,5-triazine, bemotrizinol, 2-(2-hydroxy-4-methoxyphenyl)-4,6-diphenyl-1,3,5-triazine, and 2-(2,4-dihydroxyphenyl)-4,6-diphenyl-1,3,5-triazine. Specific product names include ADK STAB LA-46 and ADK STAB LA-F70 manufactured by ADEKA Corporation, and Tinuvin 1577ED and Tinuvin 1600 manufactured by BASF Japan Ltd.

Examples of the benzophenone-based compound mentioned above include, for example, 2-hydroxy-4-(octyloxy)benzophenone, 2-hydroxy-4-methoxybenzophenone, 2,2′-dihydroxy-4,4′-dimethoxybenzophenone, 2,4-dihydroxybenzophenone, and 2,2′,4,4′-tetrahydroxybenzophenone. Specific product names include ADK STAB 1413 manufactured by ADEKA Corporation and Chimassorb 81 and Chimassorb 81FL manufactured by BASF Japan Ltd.

Examples of the cyanoacrylate-based compound mentioned above include, for example, 2,2-bis {[(2-cyano-3,3-diphenylacryloyl)oxy] methyl} propane-1,3-diyl bis(2-cyano-3,3-diphenylacrylate), 2-cyano-3,3-diphenylacrylic acid ethyl, and 2-ethylhexyl (2Z)-3-cyano-2,3-diphenylprop-2-enoate. Specific product names include Uvinul 3030, Uvinul 3035, and Uvinul 3039 manufactured by BASF Japan Ltd.

Examples of the malonic acid ester-based compound mentioned above include, for example, (4-methoxybenzylidene) malonate and tetraethyl 2,2′-(1,4-phenylene dimethanylylidene) dimalonate. Specific products include Hostavin PR-25 GR, Hostavin B-CAP manufactured by Clariant.

Examples of the oxalic acid anilide-based compound mentioned above include, for example, N-(2-ethylphenyl)-N′-(2-ethoxyphenyl) diamide oxalate. Specific products include Hostavin VSU P manufactured by Clariant. In the present embodiment, two or more ultraviolet absorbers (D) may

be used in combination. A preferred form involves the use of an ultraviolet absorber (D) that can efficiently absorb the ultraviolet absorption peak derived from the aromatic groups of the styrene-unsaturated carboxylic acid-based resin (A1) or aromatic polycarbonate resin (A2) in the region (wavelengths of 250 to 300 nm) where ultraviolet absorption enhances during photo-deterioration, and an ultraviolet absorber (D) that can efficiently absorb ultraviolet rays in the ultraviolet region (wavelengths of 300 to 400 nm) that falls most heavily on the surface of the Earth. In the present embodiment, a particularly preferred ultraviolet absorber (D) contains a compound represented by the above-mentioned general formula (d-2.1), and a compound represented by the above-mentioned general formula (d-1.1) or a compound represented by the above-mentioned general formula (d-3.1). Specifically, as an ultraviolet absorber (D) that can efficiently absorb wavelengths of 250 to 300 nm, a combination of a triazine-based ultraviolet absorber with a benzotriazole-based ultraviolet absorber or benzophenone-based ultraviolet absorber is preferred.

When initial color tone is particularly considered important, it is preferable to use a combination of a malonic acid ester-based or oxalic acid anilide-based ultraviolet absorber, which has minimal absorption in the visible light range (wavelengths of 380 nm and above) and absorbs only in the ultraviolet region (near 250 to 350 nm), and a triazine-based ultraviolet absorber that efficiently absorbs wavelengths of 250 to 300 nm, in small quantities. Furthermore, by combining a malonic acid ester-based or oxalic acid anilide-based ultraviolet absorber with a benzophenone-based compound or cyanoacrylate-based compound, which have small absorption in the visible light range and cause little discoloration upon addition, a transparent thermoplastic resin composition with excellent initial color tone can be obtained.

In the present embodiment, when initial color tone is considered important, as the ultraviolet absorber (D), an ultraviolet absorber that has small absorption in the visible light range (wavelengths of 380 nm or more) and has absorption in the ultraviolet range (near 250 to 350 nm) are preferred. As the ultraviolet absorber (D), specifically, malonic acid ester-based compounds and oxalic acid anilide-based compounds that only have absorption near 250 to 350 nm are particularly preferred. Additionally, benzophenone-based compounds and cyanoacrylate-based compounds that have small absorption in the visible light range and cause little discoloration upon addition are also preferably used as alternative preferred ultraviolet absorbers (D).

In the present embodiment, the ultraviolet absorbers (D) that can efficiently absorb the ultraviolet absorption peak derived from the aromatic groups of the styrene-unsaturated carboxylic acid-based resin (A1) or aromatic polycarbonate resin (A2) in the region (wavelengths of 250 to 300 nm) where ultraviolet absorption enhances during photo-deterioration are effective. Specifically, triazine-based compounds are cited as ultraviolet absorbers (D) that can efficiently absorb wavelengths of 250 to 300 nm. When a triazine-based compound is used as the ultraviolet absorber (D), sufficient effects can be achieved even with a small amount of addition and discoloration of the resin when added can be reduced.

In the present embodiment, it is preferable to use a malonic acid ester-based compound, which exhibits particularly good balance between the initial color tone and light resistance of the transparent thermoplastic resin composition when added, as the UV absorber (D), and preferable compounds include (4-methoxybenzylidene) malonic acid and ester tetraethyl 2,2′-(1,4-phenylenedimethylene) dimalonate.

### “Hindered Amine-Based Light Stabilizer (E)”

The hindered amine-based light stabilizer (E) of the present embodiment does not have ultraviolet absorption ability per se but functions to capture and neutralize photoradicals generated when the resin composition absorbs ultraviolet light, thereby preventing the degradation and discoloration of the resin composition caused by radicals. Examples of the hindered amine-based light stabilizer (E) include hindered amine compounds such as secondary amine-based, tertiary amine-based, and N-alkoxy-based stabilizers. The hindered amine-based light stabilizer (E) may be used alone or in combination with two or more types. When used in combination with the ultraviolet absorber (D) described below, it provides a higher light resistance effect, in other words, it can suppress discoloration and reduction in strength of the resin composition or molded articles thereof due to long-term outdoor exposure. Since the hindered amine-based light stabilizer (E) mainly functions at the resin surface where photoradical generation is higher, low-molecular-weight types are preferred for enhanced effectiveness. However, the molecular weight thereof needs to be adjusted to an appropriate molecular weight to prevent mold contamination due to excessive bleed-out, etc.

Among such hindered amine compounds, secondary amine-type hindered amines are preferred as the hindered amine-based light stabilizer (E) for their weather resistance and initial color tone when added.

In the present embodiment, when a hindered amine-based light stabilizer (E) is used, its content is preferably from 0 mass % to 1.0 mass %, and more preferably from 0.001 to 1.0 mass % relative to the total amount of the transparent thermoplastic resin composition. The upper limit of the content of the hindered amine-based light stabilizer (E) is preferably 0.8 mass % or less, 0.6 mass % or less, 0.4 mass % or less, 0.2 mass % or less, 0.15 mass % or less, 0.1 mass % or less, 0.08 mass % or less, 0.06 mass % or less, and 0.05 mass % or less, in the order of preference. The lower limit of the content of the hindered amine-based light stabilizer (E) is preferably 0.005 mass % or more, 0.008 mass % or more, and 0.01 mass % or more, in the order of preference. The above upper limit and the above lower limit of the content of the hindered amine-based light stabilizer (E) may be combined arbitrarily.

Examples of the hindered amine-based light stabilizer (E) of the present embodiment include bis(1,2,2,6-pentamethyl-4-piperidyl) sebacate, bis (1-undecyloxy-2,2,6,6-tetramethylpiperidin-4-yl) carbonate, tetrakis (2,2,6,6-tetramethyl-4-piperidyl) butane-1,2,3,4-tetracarboxylate, bis(1,2,2,6,6-pentamethyl-4-piperidyl) sebacate, N′-bis(2,2,6,6-tetramethylpiperidin-4-yl) hexane-1,6-diamine, butyl (3,5-di-t-butyl-4-hydroxybenzyl) malonate bis(1,2,2,6,6-pentamethyl-4-piperidyl), and N,N′-1,6-hexanediylbis (N-(2,2,6,6-tetramethylpiperidin-4-yl) formamide). Specific product manes include ADK STAB LA-52, ADK STAB LA-57, ADK STAB LA-63P, ADK STAB LA-68, ADK STAB LA-72, ADK STAB LA-77Y, ADK STAB LA-77G, and ADK STAB LA-81 (manufactured by ADEKA Corporation), JF-90G and JF-95 (manufactured by Johoku Chemical Co., Ltd.), and Chimasorb 2020FDL, Chimasorb 944FDL, Tinuvin 622SF, and Uvinul 4050FF (manufactured by BASF Japan Ltd.).

### “Mold Release Agent (F)”

As a preferred mode of the present embodiment, the transparent thermoplastic resin composition may contain a mold release agent (F). The mold release agent (F) can be incorporated as an internal lubricant (F1) by being kneaded into the transparent thermoplastic resin composition when it is prepared, or as an external lubricant (F2) by dry blending after granulation of the transparent thermoplastic resin composition, or both methods may be combined.

The content of the mold release agent (F) in the present embodiment is preferably 0.001 to 2.5 mass % relative to the total amount (100 mass %) of the transparent thermoplastic resin composition. The upper limit of the content of the mold release agent (F) is more preferably 2.0 mass % or less, 1.7 mass % or less, 1.6 mass % or less, 1.5 mass % or less, 1.4 mass % or less, 1.3 mass % or less, 1.2 mass % or less, 1.1 mass % or less, 1.0 mass % or less, 0.9 mass % or less, 0.8 mass % or less, 0.7 mass % or less, and 0.6 mass % or less, in the order of preference. As for the lower limit of the content of the mold release agent (F), it is preferably 0.003 mass % or more, 0.005 mass % or more, 0.007 mass % or more, 0.009 mass % or more, 0.012 mass % or more, 0.031 mass % or more, 0.066 mass % or more, 0.090 mass % or more, 0.11 mass % or more, 0.16 mass % or more, 0.21 mass % or more, 0.26 mass % or more, and 0.31 mass % or more, in the order of preference. By keeping the content of the mold release agent (F) within the range of 0.001 to 2.0 mass %, a transparent thermoplastic resin composition with excellent mold-release properties can be obtained. Particularly, a range of 0.01 to 0.8 mass % results in a transparent thermoplastic resin composition with an excellent balance between mold-release properties and heat resistance. The above upper limit and the above lower limit can be combined arbitrarily.

In the case where the transparent thermoplastic resin composition of the present embodiment contains a mold release agent (F) as an internal lubricant (F1), the content of the internal lubricant (F1) is preferably 0.05 to 2.0 mass %, more preferably 0.10 to 1.5 mass %, even more preferably 0.10 to 1.0 mass %, still even more preferably 0.13 to 1.0 mass %, and further preferably 0.17 to 0.8 mass % relative to the total amount (100 mass %) of the transparent thermoplastic resin composition. Particularly, by setting the content in the range of 0.13 to 1.0 mass %, it is possible to suppress excessive bleed-out and obtain a transparent thermoplastic resin composition with excellent mold release properties.

In cases where the transparent thermoplastic resin composition of the present embodiment contains a mold release agent (F) as an external lubricant (F2), the content of the mold release agent as the external lubricant (F2) is preferably 0.005 to 0.5 mass %, more preferably 0.007 to 0.2 mass %, and even more preferably 0.008 to 0.1 mass % relative to the total amount (100 mass %) of the transparent thermoplastic resin composition. Particularly, by setting it in the range of 0.008 to 0.1 mass %, it is possible to obtain a transparent thermoplastic resin composition that suppresses mold contamination while exhibiting excellent mold release properties.

The content of the mold release agent (F) in the present embodiment refers to the total of the content of the internal lubricant (F1) and the content of the external lubricant (F2). That is, the total content of the internal lubricant (F1) and the external lubricant (F2) is preferably from 0.001 to 2.5 mass %. The upper limit of the total content of the internal lubricant (F1) and the external lubricant (F2) is more preferably 2.0 mass % or less, 1.7 mass % or less, 1.6 mass % or less, 1.5 mass % or less, 1.4 mass % or less, 1.3 mass % or less, 1.2 mass % or less, 1.1 mass % or less, 1.0 mass % or less, 0.9 mass % or less, 0.8 mass % or less, 0.7 mass % or less, and 0.6 mass % or less, in the order of preference. The lower limit of the total content of the internal lubricant

(F1) and the external lubricant (F2) is preferably 0.003 mass % or more, 0.005 mass % or more, 0.007 mass % or more, 0.009 mass % or more, 0.012 mass % or more, 0.031 mass % or more, 0.066 mass % or more, 0.090 mass % or more, 0.11 mass % or more, 0.16 mass % or more, 0.21 mass % or more, 0.26 mass % or more, and 0.31 mass % or more, in the order of preference. The above upper limit and the above lower limit can be combined arbitrarily.

Examples of the mold release agent (F) in the present embodiment include, for example, stearic acid, zinc stearate, calcium stearate, glycerin, monostearate glycerol, distearate glycerol, ethylene bis-stearamide, stearamide, oleamide, erucamide, and hardened castor oil. From the viewpoint of imparting releasability to the transparent thermoplastic resin in the present embodiment, glycerol monostearate, stearic acid, zinc stearate, and calcium stearate are preferable. In particular, glycerol monostearate is preferable from the viewpoint of the initial color tone of the resin composition.

In the mold release agent (F) of the present embodiment, monovalent alcohols having 6 or more carbon atoms having releasability are excluded.

When monostearate glycerol and/or distearate glycerol are used as the mold release agent (F), a resin composition with excellent mold-release properties and initial color tone can be obtained. Specific product names of preferred mold release agents (F) include “EXCEL S-95,” “EXCEL VS-95,” “EXCEL O-95R,” “EXCEL P-40,” “EXCEL P-40P,” “EXCEL 122V,” “EXCEL 200,” “EXCEL O-95N,” “EXCEL O-95F,” and “Step SS” manufactured by Kao Corporation, and “RIKEMAL S-100,” “RIKEMAL S-100P,” and “RIKEMAL H-100” manufactured by Riken Vitamin Co., Ltd. The content of glycerol monostearate and/or glycerol distearate used as the mold release agent (F) is preferably 0.001 to 2.5 mass % relative to the total amount (100 mass %) of the transparent thermoplastic resin composition. The upper limit of the content of glycerol monostearate and/or glycerol distearate, is more preferably 2.5 mass % or less, 2.0 mass % or less, 1.7 mass % or less, 1.6 mass % or less, 1.5 mass % or less, 1.4 mass % or less, 1.3 mass % or less, 1.2 mass % or less, 1.1 mass % or less, 1.0 mass % or less, 0.9 mass % or less, 0.8 mass % or less, 0.7 mass % or less, and 0.6 mass % or less, in the order of preference. The lower limit of the content of glycerol monostearate and/or glycerol distearate is preferably 0.005 mass % or more, 0.01 mass % or more, 0.05 mass % or more, 0.08 mass % or more, 0.09 mass % or more, 0.1 mass % or more, 0.15 mass % or more, 0.18 mass % or more, 0.20 mass % or more, 0.25 mass % or more, and 0.3 mass % or more, in the order of preference.

When monostearate glycerol or distearate glycerol is contained in an amount of 0.1 to 2.0 mass % relative to the total amount (100 mass %) of the transparent thermoplastic resin composition, a resin composition with particularly excellent mold-release properties and initial color tone can be obtained.

The above upper limit and the above lower limit can be combined arbitrarily.

“Monovalent Alcohol (E) having 6 or More Carbon Atoms”

The transparent thermoplastic resin composition of the present embodiment may contain, if necessary, a monovalent alcohol (G) having 6 or more carbon atoms. Therefore, the monovalent alcohol (having 6 or more carbon atoms) (hereinafter simply referred to as “alcohol”) in the present embodiment is an optional component of the transparent thermoplastic resin composition. In particular, when a styrene-unsaturated carboxylic acid-based resin (A1) and/or (meth)acrylic resin (A3) is used as the transparent thermoplastic resin (A), gelation during polymerization of the resin and during molding or extrusion processing can be suppressed, and a transparent thermoplastic resin composition and a molded article made of the transparent thermoplastic resin composition having good appearance can be obtained. Moreover, the monovalent alcohol (G) having 6 or more carbon atoms can also impart a mold release effect during injection molding.

In the present embodiment, the content of the monovalent alcohol (G) having 6 or more carbon atoms is preferably 0.001 to 2.5 mass % relative to the total amount (100 mass %) of the transparent thermoplastic resin composition. The upper limit of the content of the monovalent alcohol (G) having 6 or more carbon atoms is more preferably 2.5 mass % or less, 2.0 mass % or less, 1.7 mass % or less, 1.6 mass % or less, 1.5 mass % or less, 1.4 mass % or less, 1.3 mass % or less, 1.2 mass % or less, 1.1 mass % or less, 1.0 mass % or less, 0.9 mass % or less, 0.8 mass % or less, 0.7 mass % or less, and 0.6 mass % or less, in the order of preference. The lower limit of the content of the monovalent alcohol (G) having 6 or more carbon atoms is preferably 0.005 mass % or more, 0.01 mass % or more, 0.05 mass % or more, 0.08 mass % or more, 0.09 mass % or more, 0.1 mass % or more, 0.15 mass % or more, 0.18 mass % or more, 0.20 mass % or more, 0.25 mass % or more, and 0.3 mass % or more, in the order of preference. The above upper limit and the above lower limit can be combined arbitrarily.

By setting the content of the monovalent alcohol (G) having 6 or more carbon atoms to 0.01 mass % or more, in particular, when a styrene-unsaturated carboxylic acid-based resin (A1) and/or (meth)acrylic resin (A3) is used as the transparent thermoplastic resin (A), gelation during polymerization of the resin and during molding or extrusion processing can be suppressed, and a transparent thermoplastic resin composition and a molded article comprising the same having good appearance can be obtained. Moreover, the monovalent alcohol (G) having 6 or more carbon atoms can also impart a mold release effect during injection molding.

If the content of the monovalent alcohol (G) having 6 or more carbon atoms is too high, there is a concern that the heat resistance of the transparent thermoplastic resin composition may decrease and that mold contamination may become noticeable during injection molding. If the content of the monovalent alcohol (G) having 6 or more carbon atoms is low, it is possible to suppress the decrease in heat resistance and the occurrence of mold contamination of the transparent thermoplastic resin composition. In this specification, even if the monovalent alcohol (G) having 6 or more carbon atoms has releasability, it is not considered as the mold release agent (F).

The total amount of the mold release agent (F) and the monovalent alcohol (G) having 6 or more carbon atoms in the present embodiment is preferably 0.001 to 2.5 mass % relative to the total amount (100 mass %) of the transparent thermoplastic resin composition. The upper limit of the total amount of the mold release agent (F) and the monovalent alcohol (G) having 6 or more carbon atoms is more preferably 2.5 mass % or less, 2.0 mass % or less, 1.7 mass % or less, 1.6 mass % or less, 1.5 mass % or less, 1.4 mass % or less, 1.3 mass % or less, 1.2 mass % or less, 1.1 mass % or less, 1.0 mass % or less, 0.9 mass % or less, 0.8 mass % or less, 0.7 mass % or less, and 0.6 mass % or less, in the order of preference. The lower limit of the total amount of the mold release agent (F) and the monovalent alcohol (G) having 6 or more carbon atoms is preferably 0.005 mass % or more, 0.01 mass % or more, 0.05 mass % or more, 0.08 mass % or more, 0.09 mass % or more, 0.1 mass % or more, 0.15 mass % or more, 0.18 mass % or more, 0.20 mass % or more, 0.25 mass % or more, and 0.3 mass % or more, in the order of preference. The above upper limit and the above lower limit can be combined arbitrarily.

The monovalent alcohol (G) having 6 or more carbon atoms is an alcohol containing one hydroxyl group and having 6 or more carbon atoms. It may include a heteroatom such as oxygen or nitrogen in the carbon chain constituting the alcohol, and may contain a bond other than single bonds, such as a double bond, triple bond, ester bond, or amide bond, within the carbon chain. The number of carbon atoms is preferably 6 or more, more preferably 8 or more, even more preferably 10 or more, still more preferably 12 or more and 50 or less. The above-mentioned monovalent alcohol having 6 or more carbon atoms may be contained in the resin composition or in a molded article made of the resin composition. Therefore, by allowing (or adding) a monovalent alcohol having 6 or more carbon atoms to be present in the polymerization solution used when polymerizing the transparent thermoplastic resin (A), the monovalent alcohol may be allowed to remain in the resulting resin composition, or it may be added during kneading of the transparent thermoplastic resin (A) and mixed in an extruder to be contained therein.

As for the monovalent alcohol (G) having 6 or more carbon atoms, from the viewpoint of the stability of molecular bonds, it is preferable that the carbon chain forming the monovalent alcohol (E) does not contain heteroatoms and is composed only of an alkyl group. Since monovalent alcohols composed solely of an alkyl group exhibit excellent thermal stability and compatibility with styrene-based resins, they exhibit the effect of reducing mold contamination during molding. The number of carbon atoms in the alcohol is preferably 8 or more, more preferably 10 or more, even more preferably 12 or more and 50 or less, and particularly preferably 14 or more and 30 or less.

As the monovalent alcohol (G) having 6 or more carbon atoms, two or more alcohols may be used together, and the number of carbon atoms of the two or more alcohols may be different from each other.

In the present embodiment, the boiling point of the monovalent alcohol (G) having 6 or more carbon atoms is preferably 140° C. or more, more preferably 160° C. or more, still more preferably 180° C. or more, even more preferably 200° C. or more, further preferably 220° C. or more, still more preferably 240° C. or more, and even more preferably 260° C. or more. If the boiling point of the alcohol is lower than 160° C., the volatility increases, and there is a tendency for unpleasant odors to occur during molding.

Although the monovalent alcohol (G) having 6 or more carbon atoms is not particularly limited, examples include, for example, 2-ethylhexanol, 1-hexadecanol, isohexadecanol, 1-octadecanol, 5,7,7-trimethyl-2-(1,3,3-trimethylbutyl)-1-octanol, isooctadecanol, 1-isoeicosanol, stearyl alcohol, 8-methyl-2-(4-methylhexyl)-1-decanol, 2-heptyl-1-undecanol, 2-heptyl-4-methyl-1-decanol, 2-(1,5-dimethylhexyl)-5,9-dimethyl-1-decanol, and polyoxyethylene alkyl ethers.

The polyoxyethylene alkyl ethers mentioned above are preferably compounds represented by the following general formula (2):

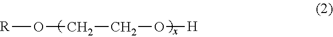

in the above general formula (2), R represents an alkyl group with 6 to 20 carbon atoms, and X represents the average number of ethylene oxide additions, which is an integer from 1 to 15.

Examples of the specific trade names of the preferred alcohol (E) include “FINEOXOCOL 180” manufactured by Nissan Chemical, “KALCOL 8098” manufactured by Kao Corporation, and “EMULGEN 109P” manufactured by Kao Corporation.

“Content of Rubbery Polymer (H) Containing Conjugated Diene Monomer Unit (h)”

The transparent thermoplastic resin composition of the present embodiment may contain a rubbery polymer (H) containing a conjugated diene monomer unit (h), such as high-impact polystyrene, MBS resin, ABS resin, styrene-based elastomers, or core-shell-type butadiene rubber particles, if needed. Then, in the present embodiment, the upper limit of the content of the rubbery polymer (H) containing the conjugated diene monomer unit (h), derived from high-impact polystyrene, MBS resin, ABS resin, styrene-based elastomer, core-shell type butadiene rubber particles, etc., which is optionally added, is preferably 3 mass % or less, more preferably 2.5 mass % or less, more preferably 2 mass % or less, still more preferably 1.5 mass % or less, even more preferably 1.0 mass % or less, further preferably 0.5 mass % or less, and further preferably 0.1 mass % or less relative to the total amount (100 mass %) of the resin composition. By setting the content of the rubbery polymer (H) containing the conjugated diene monomer unit (h) within the above range, a composition with excellent transparency can be obtained.

In addition, the lower limit of the content of the rubbery polymer (H) containing the conjugated diene monomer unit (h), derived from high-impact polystyrene, MBS resin, ABS resin, styrene-based elastomer, core-shell type butadiene rubber particles, etc., can be 0 mass % or more, or more than 0 mass % relative to the total amount (100 mass %) of the resin composition.

The above upper limit and the above lower limit can be combined arbitrarily.

In the transparent thermoplastic resin composition of the present embodiment, when transparency is particularly important, the content of the rubbery polymer (H) is preferably 0 mass % or more and 0.5 mass % or less, more preferably 0 mass % or more and 0.1 mass % or less, even more preferably 0 mass % or more and 0.01 mass % or less, further preferably 0 mass % or more and 0.001 mass % or less, and even further preferably 0 mass %, relative to the total amount (100 mass %) of the resin composition.

In the embodiment of the present application, the conjugated diene monomer unit (h) is a diolefin monomer having a pair of conjugated double bonds, and examples include 1,3-butadiene, 2-methyl-1,3-butadiene (isoprene), 2,3-dimethyl-1,3-butadiene, 1,3-pentadiene, and 1,3-hexadiene. From the viewpoint of industrial availability, 1,3-butadiene and 2-methyl-1,3-butadiene (isoprene) are preferred.

The position of the double bond in the conjugated diene monomer (h) shifts during polymerization. In the case of 1,3-butadiene, for example, the structures of the conjugated diene monomer unit (h) in the rubbery polymer (H) include a mixture of a 1,4-cis structure unit, a 1,4-trans structure unit, and a 1,2-vinyl structure unit; however, all of these are collectively referred to as the conjugated diene monomer unit (h).

### “Other Components (Additives)”

The resin composition of the present embodiment may additionally contain various additives commonly used in styrene-based resins, polycarbonate resins, and (meth)acrylic resins, for achieving known functional effects, thereby forming a transparent thermoplastic resin composition. Examples of such additives include, for example, stabilizers, higher fatty acid-based surfactants, plasticizers, blocking inhibitors, antistatic agents, anti-fogging agents, or mineral oils. In addition, thermoplastic elastomers such as alicyclic epoxy compounds, fatty acid esters, styrene-maleic anhydride copolymers, methyl methacrylate-butyl acrylate block copolymers, methyl methacrylate-(2-ethylhexyl) acrylate block copolymers, and styrene-butadiene block copolymers, and crosslinked materials such as reinforcing agents including core-shell type MBS resin particles may also be added insofar as transparency is not impaired. There is no particular limitation on the method for incorporating the above additives, but examples include a method in which the additives are added during polymerization and polymerized, or a method in which the additives are preliminarily mixed in a blender before melt-kneading after polymerization, and then melt-kneaded using an extruder or a Banbury mixer or the like.

### [Physical Transparent Properties of Thermoplastic Resin Composition]

The physical properties of the transparent thermoplastic resin composition in the present embodiment will be described below.

### <Vicat Softening Temperature>

In the present embodiment, the Vicat softening temperature of the transparent thermoplastic resin composition is preferably 105° C. or more, more preferably 110° C. or more, even more preferably 112° C. or more, further preferably 113° C. or more, further preferably 114° C. or more, still further preferably 115° C. or more, even more preferably 116° C. or more, still more preferably 117° C. or more, and even more preferably 118° C. or more. By setting the Vicat softening temperature to 105° C. or more, a molded article that is resistant to thermal dimensional deformation can be obtained. As will be described later, the Vicat softening temperature can be measured under the conditions of a load of 5 kg and a heating rate of 50° C./h in accordance with ISO 306. For example, the Vicat softening temperature of the transparent thermoplastic resin composition of the present embodiment is preferably in the range of 105° C. or more and 150° C. or less.

### <Heat Deflection Temperature>

In the present embodiment, the heat deflection temperature of the transparent thermoplastic resin composition is preferably 80° C. or more, more preferably 83° C. or more, even more preferably 85° C. or more, further preferably 87° C. or more, further preferably 90° C. or more, still more preferably 92° C. or more, further preferably 94° C. or more, and further preferably 95° C. or more. The heat deflection temperature described below can be measured in accordance with ISO 75 under the conditions of a load of 1.8 MPa, a heating rate of 120° C./h, and under the flatwise specimen condition. For example, the heat deflection temperature of the transparent thermoplastic resin composition of the present embodiment is preferably in the range of 80° C. or more and 125° C. or less.

<Density (g/cm³) of Transparent Thermoplastic Resin Composition>

In the present embodiment, the density of the transparent thermoplastic resin composition is preferably 1.20 g/cm³ or less, more preferably 1.15 g/cm³ or less, even more preferably 1.10 g/cm³ or less, further preferably 1.09 g/cm³ or less, still further preferably 1.08 g/cm³ or less, and even more preferably 1.07 g/cm³ or less, even further preferably 1.06 g/cm³ or less. By setting the density to 1.20 g/cm³ or less, it is possible to contribute to the weight reduction of the molded article. For example, the density of the transparent thermoplastic resin composition of the present embodiment is preferably in the range of 1.04 g/cm³ or more and 1.20 g/cm³ or less.

<YI value/Lightness (L*) at Optical Path Length of 300 mm>

In the present embodiment, the YI value of a long optical path test piece having an optical path length of 300 mm, obtained by injection molding the transparent thermoplastic resin composition under the molding conditions (S1) to (S3) below, is preferably 0 to 25. The upper limit of the YI value is preferably 25 or less, more preferably 24 or less, still more preferably 22 or less, and even more preferably 20 or less, and the lightness (L*) is preferably 80 to 100. The lower limit value of the lightness (L*) is preferably 80 or more, more preferably 82 or more, still more preferably 84 or more, further preferably 85 or more, further preferably 86 or more, further preferably 87 or more, further preferably 88 or more, further preferably 89 or more, and further preferably 90 or more.

The molding conditions for the long optical path test piece with a optical path length of 300 mm using the transparent thermoplastic resin composition vary depending on which of the resins (A1) to (A3) is the main component of the transparent thermoplastic resin (A) in the transparent thermoplastic resin composition.

The YI value and lightness (L*) at an optical path length of 300 mm are measured using a long optical path spectrophotometric colorimeter (ASA-2) (manufactured by Nippon Denshoku Industries Co., Ltd.).

The molding conditions (S1) of the transparent thermoplastic resin composition in the case where the main component of the transparent thermoplastic resin (A) in the transparent thermoplastic resin composition is a styrene-unsaturated carboxylic acid-based resin (A1): a cylinder temperature of 220° C., a mold temperature of 70° C., and a cycle time of 35 seconds;

The molding conditions (S2) of the transparent thermoplastic resin composition in the case where the main component of the transparent thermoplastic resin (A) in the transparent thermoplastic resin composition is an aromatic polycarbonate resin (A2): a cylinder temperature of 260° C., a mold temperature of 80° C., and a cycle time of 35 seconds; or

The molding conditions (S3) of the transparent thermoplastic resin composition in the case where the main component of the transparent thermoplastic resin (A) in the transparent thermoplastic resin composition is a (meth)acrylic resin (A3): a cylinder temperature of 240° C., a mold temperature of 70° C., and a cycle time of 35 seconds.

<ΔYI at Optical Path Length of 300 mm upon Light Irradiation (Light Resistance)>

In the present embodiment, the ΔYI after a light resistance test conducted under the conditions of a black panel temperature of 83° C. and no rain, for 12 hours using a Sunshine Weather Meter S80BBR manufactured by Suga Test Instruments Co., Ltd., on a long optical path test piece with a optical path length of 300 mm of the transparent thermoplastic resin composition is preferably 30 or less, more preferably 25 or less, still more preferably 20 or less, further preferably 18 or less, further preferably 15 or less, and further preferably 13 or less. The YI value at an optical path length of 300 mm is measured using a long optical path spectrophotometric colorimeter (ASA-2) (manufactured by Nippon Denshoku Industries Co., Ltd.).

<ΔYI at Optical Path Length of 300 mm upon Thermal Exposure (Long-Term Heat Stability)>

In the present embodiment, the difference (ΔYI: absolute value) between the YI value after thermal exposure (=heating) at 110° C. for 1000 hours and the YI value before the thermal exposure (=heating) of a long optical path test piece with a optical path length of 300 mm of the transparent thermoplastic resin composition is preferably 25 or less, more preferably 23 or less, still more preferably 21 or less, even more preferably 20 or less, further preferably 19 or less, further preferably 18 or less, further preferably 17 or less, further preferably 16 or less, and further preferably 15 or less.

The YI value at an optical path length of 300 mm is measured using a long optical path spectrophotometric colorimeter (ASA-2) (manufactured by Nippon Denshoku Industries Co., Ltd.).

In the present embodiment, the difference (ΔYI) between the YI value after thermal exposure at 110° C. for 2000 hours and the YI value before the thermal exposure of a long optical path test piece with a optical path length of 300 mm of the transparent thermoplastic resin composition is preferably 40 or less, more preferably 38 or less, still more preferably 35 or less, further preferably 33 or less, further preferably 30 or less, further preferably 28 or less, further preferably 26 or less, and further preferably 25 or less.

### <Moist Heat Resistance (ΔHz)>

In the present embodiment, the long optical path test piece with a optical path length of 300 mm of the transparent thermoplastic resin composition is cut into a 40 mm× 20 mm× 4 mm piece, and a test is conducted for 150 hours under the conditions of temperature of 110° C. and humidity of 85% using a highly accelerated life test apparatus manufactured by Espec Corp. The ΔHz is determined by subtracting the haze (Hz) before the test from the Hz after the test. The smaller the ΔHz, the better the moist heat resistance, and the smaller the appearance change due to resin degradation in high-temperature and high-humidity environments.

### <Moist Heat Resistance (ΔVicat)>

In the present embodiment, a long optical path test piece with a optical path length of 300 mm of the transparent thermoplastic resin composition is cut into a 40 mm× 20 mm× 4 mm piece, and a test is conducted for 150 hours under the conditions of a temperature of 110° C. and a humidity of 85% using a highly accelerated life test apparatus manufactured by Espec Corp. The Vicat softening temperature after the test (VICAT) is measured, and ΔVICAT is determined by subtracting the Vicat softening temperature after the test from the VICAT before the test. The smaller the ΔVICAT, the more resistant the resin is to water absorption, exhibiting excellent moist heat resistance and enabling favorable use even under high temperature and high humidity conditions.

In the present embodiment, when the transparent thermoplastic resin (A) is mainly made of the styrene-unsaturated carboxylic acid-based resin (A1), the composition is characterized in that it is particularly excellent in moist heat resistance and ΔHz and ΔVicat become low even after being left for a long time in a high-temperature and high-humidity environment.

<Measurement of Total Light Transmittance of 2 mm-Thick Plate>

In the present embodiment, the total light transmittance of a 2 mm-thick plate of the transparent thermoplastic resin composition was measured under the following conditions after preparing a test piece.

### (I) Preparation Conditions for Test Piece

Using a flat plate mold, a 2 mm-thick plate was produced by injection molding the transparent thermoplastic resin composition under the following conditions.

Injection molding machine: SE-75 manufactured by Sumitomo Heavy Industries, Ltd.

The molding conditions of the transparent thermoplastic resin composition are as follows, and the appropriate molding conditions vary depending on which of the resins (A1) to (A3) is the main component of the transparent thermoplastic resin (A) in the transparent thermoplastic resin composition.

The molding conditions (S1) of the transparent thermoplastic resin composition in the case where the main component of the transparent thermoplastic resin (A) in the transparent thermoplastic resin composition is a styrene-unsaturated carboxylic acid-based resin (A1): a cylinder temperature of 220° C., a mold temperature of 60° C., and a cooling time of 15 seconds;

The molding conditions (S2) of the transparent thermoplastic resin composition in the case where the main component of the transparent thermoplastic resin (A) in the transparent thermoplastic resin composition is an aromatic polycarbonate resin (A2): a cylinder temperature of 260° C., a mold temperature of 80° C., and a cooling time of 15 seconds; or

The molding conditions (S3) of the transparent thermoplastic resin composition in the case where the main component of the transparent thermoplastic resin (A) in the transparent thermoplastic resin composition is a (meth)acrylic resin (A3): a cylinder temperature of 240° C., a mold temperature of 60° C., and a cooling time of 15 seconds.

### (II) Measurement Conditions for Total Light Transmittance

The 2 mm-thick plate produced under the above conditions is used to measure the total light transmittance (%) in accordance with JIS K 7361-1.

The total light transmittance of the 2 mm thick plate is preferably 85% or more, more preferably 86% or more, still more preferably 87% or more, even more preferably 88% or more, further preferably 89% or more, and still further preferably 90% or more.

### “Preferred Composition of Transparent Thermoplastic Resin Composition”

The transparent thermoplastic resin composition of the present embodiment contains the transparent thermoplastic resin (A) and the phosphorus-based compound (B), and the total content of the transparent thermoplastic resin (A) and the phosphorus-based compound (B) accounts for preferably 95 to 100 mass %, more preferably 96 to 100 mass %, still more preferably 97 to 100 mass %, even more preferably 98 to 100 mass %, and further preferably 99 to 100 mass %, of the entire transparent thermoplastic resin composition.

The transparent thermoplastic resin composition of the present embodiment contains the transparent thermoplastic resin (A), the phosphorus-based compound (B), and the antioxidant (C), and the total content of the transparent thermoplastic resin (A), the phosphorus-based compound (B), and the antioxidant (C) accounts for preferably 95 to 100 mass %, more preferably 96 to 100 mass %, still more preferably 97 to 100 mass %, even more preferably 98 to 100 mass %, and further preferably 99 to 100 mass %, of the entire transparent thermoplastic resin composition.

The transparent thermoplastic resin composition of the present embodiment contains the transparent thermoplastic resin (A), the phosphorus-based compound (B), the antioxidant (C), and the ultraviolet absorber (D), and the total content of the transparent thermoplastic resin (A), the phosphorus-based compound (B), the antioxidant (C), and the ultraviolet absorber (D) accounts for preferably 95 to 100 mass %, more preferably 96 to 100 mass %, still more preferably 97 to 100 mass %, even more preferably 98 to 100 mass %, and further preferably 99 to 100 mass %, of the entire transparent thermoplastic resin composition.

The transparent thermoplastic resin composition of the present embodiment contains the transparent thermoplastic t resin (A), the phosphorus-based compound (B), the antioxidant (C), the ultraviolet absorber (D), and the hindered amine-based light stabilizer (E), and the total content of the transparent thermoplastic resin (A), the phosphorus-based compound (B), the antioxidant (C), the ultraviolet absorber (D), and the hindered amine-based light stabilizer (E) accounts for preferably 95 to 100 mass %, more preferably 96 to 100 mass %, still more preferably 97 to 100 mass %, even more preferably 98 to 100 mass %, and further preferably 99 to 100 mass %, of the entire transparent thermoplastic resin composition.

The transparent thermoplastic resin composition of the present embodiment contains the transparent thermoplastic resin (A), the phosphorus-based compound (B), the antioxidant (C), the ultraviolet absorber (D), the hindered amine-based light stabilizer (E), and the release agent (F), and the total content of the transparent thermoplastic resin (A), the phosphorus-based compound (B), the antioxidant (C), the ultraviolet absorber (D), the hindered amine-based light stabilizer (E), and the release agent (F) accounts for preferably 95 to 100 mass %, more preferably 96 to 100 mass %, still more preferably 97 to 100 mass %, even more preferably 98 to 100 mass %, and further preferably 99 to 100 mass %, of the entire transparent thermoplastic resin composition.

The transparent thermoplastic resin composition of the present embodiment contains the transparent thermoplastic resin (A), the phosphorus-based compound (B), the antioxidant (C), the ultraviolet absorber (D), the hindered amine-based light stabilizer (E), the release agent (F), and the monovalent alcohol (G) having 6 or more carbon atoms, and the total content of the transparent thermoplastic resin (A), the phosphorus-based compound (B), the antioxidant (C), the ultraviolet absorber (D), the hindered amine-based light stabilizer (E), the release agent (F), and the monovalent alcohol (G) having 6 or more carbon atoms accounts for preferably 95 to 100 mass %, more preferably 96 to 100 mass %, still more preferably 97 to 100 mass %, even more preferably 98 to 100 mass %, and further preferably 99 to 100 mass %, of the entire transparent thermoplastic resin composition.

The transparent thermoplastic resin composition of the present embodiment preferably contains a transparent thermoplastic resin (A), a phosphorus-based compound (B), an antioxidant (C), an ultraviolet absorber (D), a release agent (F), and a monovalent alcohol (G) having 6 or more carbon atoms, and the total content of the transparent thermoplastic resin (A), the phosphorus-based compound (B), the antioxidant (C), the ultraviolet absorber (D), the release agent (F), and the monovalent alcohol (G) accounts for preferably 95 to 100 mass %, more preferably 96 to 100 mass %, still more preferably 97 to 100 mass %, even more preferably 98 to 100 mass %, and even further preferably 99 to 100 mass %, of the entire transparent thermoplastic resin composition.

In the present embodiment, the transparent thermoplastic resin composition preferably contains a transparent thermoplastic resin (A), a phosphorus-based compound (B), an antioxidant (C), an ultraviolet absorber (D), and a monovalent alcohol (G) having 6 or more carbon atoms, and the total content of the transparent thermoplastic resin (A), the phosphorus-based compound (B), the antioxidant (C), the ultraviolet absorber (D), and the monovalent alcohol (G) accounts for preferably 95 to 100 mass %, more preferably 96 to 100 mass %, still more preferably 97 to 100 mass %, even more preferably 98 to 100 mass %, and even further preferably 99 to 100 mass %, of the entire transparent thermoplastic resin composition.

The transparent thermoplastic resin composition of the present embodiment preferably contains a transparent thermoplastic resin (A), a phosphorus-based compound (B), an antioxidant (C), a release agent (F), and a monovalent alcohol (G) having 6 or more carbon atoms, and the total content of the transparent thermoplastic resin (A), the phosphorus-based compound (B), the antioxidant (C), the release agent (F), and the monovalent alcohol (G) accounts for preferably 95 to 100 mass %, more preferably 96 to 100 mass %, still more preferably 97 to 100 mass %, even more preferably 98 to 100 mass %, and even further preferably 99 to 100 mass %, relative to the entire transparent thermoplastic resin composition.

The transparent thermoplastic resin composition of the present embodiment preferably contains a transparent thermoplastic resin (A), a phosphorus-based compound (B), and a release agent (F), and the total content of the transparent thermoplastic resin (A), the phosphorus-based compound (B), and the release agent (F) accounts for preferably 95 to 100 mass %, more preferably 96 to 100 mass %, still more preferably 97 to 100 mass %, even more preferably 98 to 100 mass %, and even further preferably 99 to 100 mass %, of the entire transparent thermoplastic resin composition.

The transparent thermoplastic resin composition of the present embodiment preferably contains a transparent thermoplastic resin (A), a phosphorus-based compound (B), an antioxidant (C), an ultraviolet absorber (D), a release agent (F), and a monovalent alcohol (G) having 6 or more carbon atoms, and the total content of the transparent thermoplastic resin (A), the phosphorus-based compound (B), the antioxidant (C), the ultraviolet absorber (D), the release agent (F), and the monovalent alcohol (G) accounts for preferably 95 to 100 mass %, more preferably 96 to 100 mass %, still more preferably 97 to 100 mass %, even more preferably 98 to 100 mass %, and even further preferably 99 to 100 mass %, of the entire transparent thermoplastic resin composition.

The transparent thermoplastic resin composition of the present embodiment preferably contains a transparent thermoplastic resin (A), a phosphorus-based compound (B), an antioxidant (C), an ultraviolet absorber (D), and a release agent (F), and the total content of the transparent thermoplastic resin (A), the phosphorus-based compound (B), the antioxidant (C), the ultraviolet absorber (D), and the release agent (F) accounts for preferably 95 to 100 mass %, more preferably 96 to 100 mass %, still more preferably 97 to 100 mass %, even more preferably 98 to 100 mass %, and even further preferably 99 to 100 mass %, of the entire transparent thermoplastic resin composition.

### “Preferred Components of the Transparent Thermoplastic Resin Composition”

In the present embodiment, the transparent thermoplastic resin composition essentially contains the phosphorus-based compound (B) as described above, and may optionally contain one or more selected from the group consisting of the antioxidant (C), the ultraviolet absorber (D), and the hindered amine-based light stabilizer (E).

In this specification, the phosphorus-based compound (B), antioxidant (C), ultraviolet absorber (D), and hindered amine-based light stabilizer (E) are referred to as stabilizing components that stabilize the composition.

When the transparent thermoplastic resin composition of the present embodiment contains stabilizing components other than the phosphorus-based compound (B), the content of such stabilizing components is preferably 0.001 to 1.5 mass %, more preferably 0.01 to 1 mass %, still more preferably 0.05 to 0.8 mass %, even more preferably 0.08 to 0.6 mass %, and even further preferably 0.1 to 0.5 mass %, relative to the entire transparent thermoplastic resin composition.

Furthermore, the proportion of the phosphorus-based compound (B) in the stabilizing components is preferably 5 to 75 mass %, more preferably 5 to 50 mass %, still more preferably 8 to 45 mass %, even more preferably 10 to 40 mass %, and even further preferably 10 to 35 mass %, relative to the total stabilizing components.

The proportion of the antioxidant (C) in the stabilizing components is preferably 20 to 95 mass %, more preferably 25 to 90 mass %, still more preferably 30 to 85 mass %, even more preferably 40 to 85 mass %, and even further preferably 50 to 85 mass %, relative to the total stabilizing components.

The proportion of the phenolic antioxidant (C1) in the stabilizing components is preferably 10 to 50 mass %, more preferably 13 to 45 mass %, still more preferably 15 to 40 mass %, even more preferably 20 to 40 mass %, and even further preferably 20 to 35 mass %, relative to the total stabilizing components.

The proportion of the phosphorus antioxidant (C2) in the stabilizing components is preferably 10 to 90 mass %, more preferably 20 to 80 mass %, still more preferably 30 to 70 mass %, even more preferably 35 to 65 mass %, and further preferably 40 to 60 mass %, relative to the total stabilizing components.

The proportion of the ultraviolet absorber (D) in the stabilizing components is preferably 1 to 25 mass %, more preferably 2 to 20 mass %, still more preferably 4 to 18 mass %, and even further preferably 5 to 15 mass %, relative to the total stabilizing components.

The proportion of the hindered amine-based light stabilizer (E) in the stabilizing components is preferably 0 to 50 mass %, more preferably 0 to 40 mass %, still more preferably 0 to 30 mass %, and even further preferably 0 to 20 mass %, relative to the total stabilizing components.

In the present embodiment, the preferred combination of stabilizing components includes 9,10-dihydro-9-oxa-10-phosphaphenanthrene-10-oxide, as the phosphorus-based compound (B); one or more components selected from the group consisting of octadecyl-3-(3,5-di-tert-butyl-4-hydroxyphenyl) propionate, pentaerythritol tetrakis [3-(3′,5′-di-tert-butyl-4′-hydroxyphenyl) propionate], 4,6-bis(octylthiomethyl)-o-cresol, bis(3-tert-butyl-4-hydroxy-5-methylbenzenepropanoic acid) ethylene bis(oxyethylene), and 2,2′-dimethyl-2,2′-(2,4,8, 10-tetraoxaspiro[5.5]undecane-3,9-diyl) dipropane-1, l′-diyl bis [3-(3-tert-butyl-4-hydroxy-5-methylphenyl) propanoate], as the phenolic antioxidant (C1); and one or more components selected from the group consisting of tris (2,4-di-tert-butylphenyl) phosphite and 3,9-bis(2,6-di-tert-butyl-4-methylphenoxy)-2,4,8,10-tetraoxa-3,9-diphosphasp iro [5.5]undecane, as the phosphorus-based antioxidant (C2).

“Particularly Preferred Form of Transparent Thermoplastic Resin Composition”

In a particularly preferred embodiment of the present disclosure, the transparent thermoplastic resin (A) is a styrene-unsaturated carboxylic acid-based resin (A1), which is a ternary copolymer composed of a styrene-based monomer unit (a1-1), an unsaturated carboxylic acid monomer unit (a1-2), and an unsaturated carboxylic acid ester monomer unit (a1-3), and the content of the styrene-based monomer unit (a1-1) is 80.4 to 85 mass %, the content of the unsaturated carboxylic acid monomer unit (a1-2) is 10.5 to 12.5 mass %, and the content of the unsaturated carboxylic acid ester monomer unit (a1-3) is 4.5 to 7.1 mass %; and the phosphorus-based compound (B) is 9,10-dihydro-9-oxa-10-phosphaphenanthrene-10-oxide, and the content thereof is 0.03 to 0.08 mass % in the total transparent thermoplastic resin composition (100 mass %).

As a result, a transparent thermoplastic resin composition and a molded body composed thereof can be obtained, which exhibit excellent transparency (light transmittance), long-term thermal stability, humidity and heat resistance, light resistance, heat resistance, and moldability, and have reduced yellowness.

Additionally, adding an antioxidant (C), an ultraviolet absorber (D), or a release agent (F) can further improve long-term thermal stability, light resistance, and moldability, depending on the application.

### [Method for Producing Transparent Thermoplastic Resin Composition]

In the present embodiment, the method for producing the transparent thermoplastic resin composition is not particularly limited to any specific method for blending, melting, kneading, and granulating the raw material components, and methods commonly used for the production of transparent thermoplastic resin compositions can be employed. For example, the components described above may be blended (mixed) by a drum tumbler, a HENSCHEL mixer, or the like, melt-kneaded by using a Banbury mixer, a single screw extruder, a twin screw extruder, a kneader, or the like, and granulated by a rotary cutter, a fan cutter, or the like, to thereby obtain a resin composition. The resin temperature of the melt-kneading is preferably 180 to 300° C. In order to achieve the target resin temperature, the cylinder temperature of the extruder or the like is preferably set to a temperature that is lower than the resin temperature by 10 to 20° C. A resin temperature less than 180° C. is not preferable because sufficient mixing cannot be achieved. On the other hand, when the resin temperature exceeds 300° C., thermal decomposition of the resin occurs, which is undesirable.

### [Molded Article]

The present disclosure is a molded article using the transparent thermoplastic resin composition.

The method for producing a molded article using the transparent thermoplastic resin composition of the present embodiment is as follows. The transparent thermoplastic resin composition can be made into a molded article by the foregoing melt-kneading molding machine, or using obtained pellets of the transparent thermoplastic resin composition as a raw material, by injection molding, injection compression molding, extrusion molding, blow molding, press molding, vacuum molding, foam molding, or the like. Among these, the injection molding method is preferable.

### <Injection Molded Article>

Another aspect of the present disclosure is preferably a molded article produced by injection molding the above-described transparent thermoplastic resin composition. By using the transparent thermoplastic resin composition of the present embodiment as the raw material for injection-molded products, excellent heat resistance, transparency (light transmittance), long-term thermal stability, light resistance, and moldability can be achieved, making it suitable for in-vehicle applications.

Specifically, the present disclosure may be an optical component containing the transparent thermoplastic resin composition. Examples of such optical components include lighting covers, optical lenses, injection-molded products for vehicles, light guide members (e.g., light guides for vehicles), or vehicle lamps.

In particular, since the light guide member of the present embodiment is composed of a transparent thermoplastic resin composition that exhibits excellent transparency, heat resistance, and moldability, and has low yellowness, it is preferable that it is an elongated molded article having a bent portion.

### <Vehicle Lamp>

In the present embodiment, the vehicle lamp preferably includes a light guide member that guides light emitted from the light source from one end in the longitudinal direction to the other end and emits the light to the outside through the circumferential surface. The vehicle lamp of the present embodiment may further include a light source that emits light toward the light guide member, as necessary.

Examples of the vehicle lamp preferably include so-called signal lamps, and daytime running lights (DRLs), position lamps, front turn lamps, stop lamps, or tail lamps, and more preferably daytime running lights (DRLs) are more preferred.

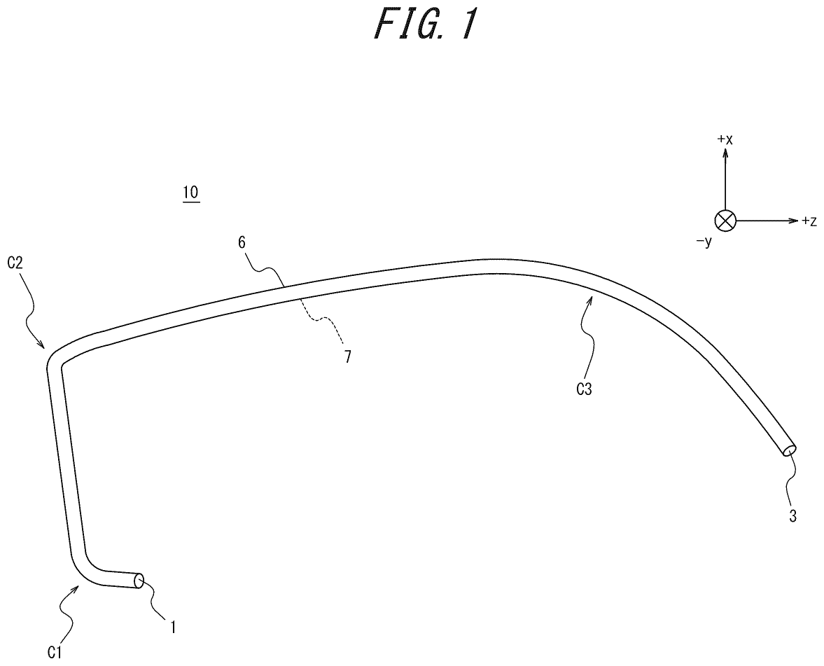

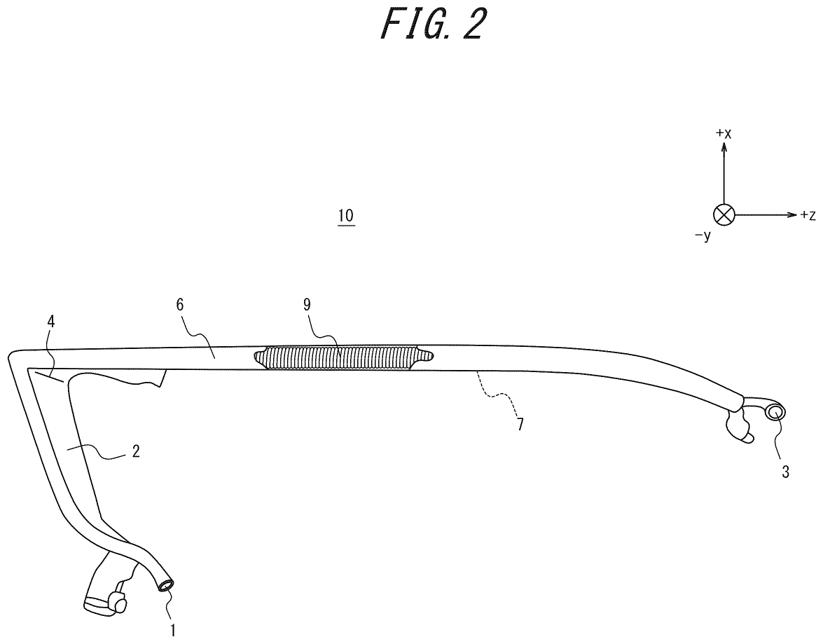

An example of a vehicle lamp will now be described with reference to FIGS. 1 to 3, which illustrate the structure of a light guide member 10. The light guide member 10 has one or more bent portions, and guides light incident from one end in the longitudinal direction (long axis direction: +Z direction in FIGS. 1 to 2) to the other end, while also emitting light from the circumferential surface of the main body of the light guide member. Since the light guide member 10 of the present embodiment, in particular, is composed of a transparent thermoplastic resin composition having excellent transparency, heat resistance, and moldability, and low yellowness, it exhibits little heat generation on the light-emitting surface at the bent portion and enables uniform planar light emission even through a long optical path.

FIG. 1 illustrates a rod-shaped body made of the transparent thermoplastic resin composition of the present embodiment, which is a light guide member 10 having a bent portion C1 with a relatively small radius of curvature, a bent portion C3 with a relatively large radius of curvature, and a bent portion C2 with a radius of curvature between those of the bent portion C1 and the bent portion C3. One end of the light guide member 10 serves as an incident surface 1 that receives light emitted from a light source (not illustrated), and the other end serves as an emission surface 3 that emits the light guided from the one end. The circumferential surface of the light guide member 10 may also serve as a light emission surface.

In the present embodiment, the light guide member 10 can guide light emitted from the light source (not illustrated). The light guide member 10 can receive light emitted from the light source mainly at one end (for example, the proximal end on the incident surface 1 side). The light guide member 10 guides the light emitted from the light source by reflecting it on the side surface (for example, by total internal reflection in the longitudinal direction). In FIGS. 1 to 3, the longitudinal direction of the light guide member 10 is defined as the +Z axis direction. The light guide member 10 emits light rays from the side surface when the incident angle to the side surface is smaller than the critical angle. The light guide member 10 also converts the reflected light ray reflected by the reflective surface into a light ray having an incident angle to the side surface smaller than the critical angle.

Since the light guide member 10 has a function of guiding light from one end to the other end in the longitudinal direction, it includes an incident surface 1 and a reflective surface (or side surfaces 6 and 7). As illustrated in FIG. 1, the light guide member 10 may be an elongated body extending along a curved line in two or three dimensions. Therefore, the central axis of the light guide member 10 may also be a two-dimensional or three-dimensional curve. The light guide member 10 includes bent portions C1, C2, and C3.

In addition, the light source attached to the light guide member 10 in the present embodiment is not particularly limited, and examples include semiconductor light sources such as LEDs and LDs (Laser Diodes). The light guide member 10 is disposed opposite the light source, and if necessary, a reflector (not illustrated) may be disposed to surround the light source and the light guide member 10 (especially around the incident surface 1 of the light guide member 10). The reflector may have a surface provided with metal deposition, such as aluminum deposition, on the inner circumferential surface thereof, so that the light emitted laterally from the light source can be reflected in the axial direction of the light guide member 10.

FIG. 2 is a schematic view illustrating an example of the light guide member 10, which is composed of the transparent thermoplastic resin composition of the present embodiment and includes a rod-shaped body having a bent portion made from the transparent resin composition and a plate portion 2 provided with a linear groove portion 4 attached to the main body of the light guide member 10 (hereinafter, referred to as the light guide member 10 main body). On one side surface 7 of the rod-shaped light guide member 10 main body, prism portions 9 (or protrusions) having a (substantially) triangular prism shape are arranged in a regular pattern. For the convenience of illustration, FIG. 2 illustrates prism portions 9 arranged only in a partial region of one side surface 7 of the light guide member main body, but actually, the prism portions 9 are provided at substantially regular intervals over the entire surface 7 from the proximal end on the incident surface 1 side to the distal end on the emission surface 3 side of the rod-shaped light guide member 10. Accordingly, when the (substantially) triangular prism-shaped prism portions 9 (or protrusions) arranged on the side surface 7 are viewed from the opposite surface 6 side, they appear accordion-like.

In the present embodiment, the light guide member 10 can guide light emitted from the light source (not illustrated). The light guide member 10 can receive light emitted from the light source mainly at one end (for example, the proximal end on the incident surface 1 side). The light guide member 10 guides the light emitted from the light source by reflecting it on the side surface (for example, the reflective surfaces of the prism portions 9), (by means of total internal reflection in the longitudinal direction, for example). The light guide member 10 emits light rays from the side surface 6 when the incident angle to the side surface (for example, the reflective surfaces of the prism portions 9) is smaller than the critical angle. The light guide member 10 also converts the reflected light ray reflected by a reflective surface (e.g., a reflective surface of the prism portion 9) into a light ray having an incident angle to the side surface smaller than the critical angle. . . . Then, the light guide member 10 can emit the guided light toward the plate portion 2 connected to the light guide member 10.

In the present embodiment, the light guide member 10 may have the plate portion 2 attached in an outward direction (for example, the-Y direction in FIG. 2) with respect to the longitudinal direction of the light guide member 10. The plate portion 2 may have a reflective surface.

The plate portion 2 receives light rays emitted from the side surface 7 of the light guide member 10 and emits the incident rays from the surface of the plate portion 2. Accordingly, the plate portion 2 may have a linear groove portion 4. The shape of the plate portion 2 is not particularly limited, but a flat plate shape is preferred. The emission surface from which the light rays are emitted from the plate portion 2 and the reflective surface (or the groove portion 4) that reflects the light rays incident into the plate portion 2 are preferably formed on the side surface of the plate-shaped body and may have a two-dimensionally or three-dimensionally curved shape. The plate portion 2 reflects the light incident from the light guide member 10 on the reflective surface (or groove portion 4) and guides it to the emission surface. The emission surface of the plate portion 2 may be a surface parallel to the +Z-Y plane in FIG. 2, for example.

The light guide member 10 has a function of guiding light from one end to the other end in the longitudinal direction, and therefore includes an incident surface 1 and a reflective surface of the prism portions 9. The shape of the main body of the light guide member 10 is not particularly limited, and may be, for example, an elongated body extending along a curved line in two or three dimensions as illustrated in FIG. 2. Accordingly, the central axis of the light guide member 10 may also be a two-dimensional or three-dimensional curve.

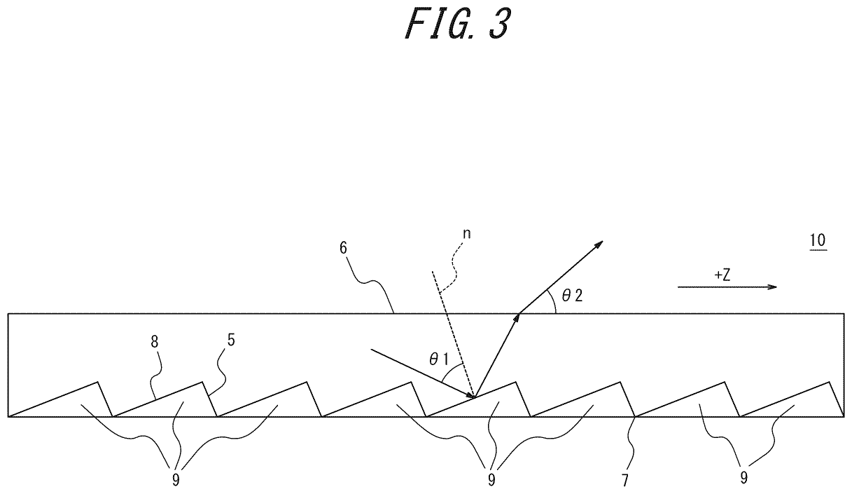

The incident surface 1 for receiving light emitted from the light source (not illustrated) is formed, for example, at an end of the light guide member 10 (e.g., an end surface at one end of the light guide member 10). The incident surface 1 is disposed, for example, facing or intersecting the light-emitting surface of the light source. Meanwhile, the reflective surfaces (e.g., reflective surfaces 5 and 8 in FIG. 3) that reflect the incident light are preferably formed on a part or the entirety of the side surface 7 of the light guide member 10 along the longitudinal direction. The reflective surfaces (e.g., reflective surfaces 5 and 8 in FIG. 3) may be either flat or curved. When the light reflected on the reflective surfaces (e.g., reflective surfaces 5 and 8 in FIG. 3) reaches the side surface 6 of the light guide member 10, and the incident angle of the light with respect to the side surface 6 is smaller than the critical angle, the light reflected on the reflective surfaces is emitted from the side surface 6.

In the present embodiment, the reflective surface is not particularly limited, and examples thereof include a prism, a printed pattern (dot pattern or protrusion) that diffusely reflects incident light, or a notch pattern. Furthermore, a plurality of reflective surfaces may be formed in the direction along the longitudinal axis of the light guide member 10. For example, a plurality of reflective surfaces are continuously formed in the direction along the longitudinal axis of the light guide member 10.

An example of the reflective surface of the light guide member 10 will be described with reference to FIG. 3. FIG. 3 schematically illustrates an example of a cross-sectional view of the light guide member 10 main body 10 in FIG. 2 and is a ray diagram illustrating the optical path of a light beam traveling inside the light guide member 10. In FIG. 3, prism portions 9 (or protrusions) in a (substantially) triangular prism shape are regularly arranged on the side surface 7 of the light guide member 10. Therefore, when the (substantially) triangular prism-shaped prism portions 9 (or protrusions) arranged on the surface 7 are viewed from the side surface 6 facing the surface 7, the surface appears accordion-shaped as illustrated in FIG. 2.

As illustrated in FIG. 3, the light traveling inside the light guide member 10 proceeds in the longitudinal direction (for example, the +z-axis direction in FIG. 3), while being reflected by the side surfaces 6 and 7 of the light guide member 10. The reflective surface 8 reflects the light traveling inside the light guide member 10. For example, as illustrated in the ray diagram of light traveling inside the light guide member 10 in FIG. 3, the light traveling in the +z-axis direction (arrow) is reflected toward the opposing side surface 6 by the reflective surface 8.

In FIG. 3, the angle θ₁ is the incident angle with respect to the reflective surface 8. On the other hand, the angle (90-θ₂) is the incident angle with respect to the light guide member 10. Thus, the refractive index n10 of the light guide member 10 is defined.

Accordingly, light emitted from the light source enters the main body 20 of the light guide member 10 from the incident surface 1, and proceeds inside the light guide member 10 while undergoing repeated total reflection. However, part of the light is incident on the reflective surface 8 and is reflected by the reflective surface 8, thereby changing the optical path thereof. Then, when the light with the changed optical path is emitted from the light guide member 10, it is refracted at the side surface 6 of the light guide member 10. In addition, the light refracted at the side surface 6 of the light guide member 10 main body proceeds in the direction of the plate portion 2 and is then emitted from the emission surface of the plate portion 2 or the like.

### <Optical Lens>

An optical lens using the transparent thermoplastic resin composition of the present embodiment can improve image resolution. In addition, by using the transparent thermoplastic resin composition of the present embodiment in an optical lens, it is possible to provide an optical lens that is excellent in transparency, heat resistance, and long-term thermal stability, and has low yellowness.

The optical lens of the present embodiment is preferably used in the form of an aspherical lens. Aspherical lenses can substantially eliminate spherical aberration with a single lens, eliminating the need to use multiple spherical lenses in combination to remove spherical aberration. Therefore, aspherical lenses made of the transparent thermoplastic resin composition of the present embodiment are particularly useful as camera lenses among optical lenses, especially for cameras of smartphones or tablets. It is preferable that the astigmatism of the aspherical lens is 0 to 18 mλ, more preferably 0 to 12 mλ.

The average thickness of the optical lens of the present embodiment is not particularly limited, and is preferably 0.01 to 30 mm, more preferably 0.1 to 15 mm. The surface of the optical lens of the present embodiment may, if necessary, be provided with a coating layer such as an antireflection layer or a hard coat layer. Examples of materials used for the antireflection layer or the hard coat layer include oxides or fluorides such as silicon oxide, aluminum oxide, zirconium oxide, titanium oxide, cerium oxide, magnesium oxide, or magnesium fluoride.

The optical lens of the present embodiment can be obtained by injection molding the thermoplastic resin composition of the present embodiment into a lens shape using an injection molding machine or an injection compression molding machine. The molding conditions for the injection molding are not particularly limited, but the molding temperature is preferably 180 to 300° C., more preferably 180 to 290° C. In addition, the injection pressure is preferably 50 to 1700 kg/cm².

### Examples

Next, the present disclosure will be described in more detail with reference to examples and comparative examples. However, the present disclosure is not limited to these examples. The methods for analyzing and evaluating the resins and molded articles used in the examples and comparative examples are described below.

### [Evaluation of Properties of Each of Resins and Resin Compositions]

### (1) Measurement of Weight Average Molecular Weight

The number average molecular weight (Mn), weight average molecular weight (Mw), and Z average molecular weight (Mz) of each resin and resin composition prepared in the Examples and Comparative Examples were measured as polystyrene-equivalent molecular weights using gel permeation chromatography (GPC) under the following conditions by a calibration curve method using standard polystyrene.

Measurement apparatus: HLC-8220 manufactured by Tosoh Corp.

Fractionation column: Two TSK gel Super HZM-H (inner diameter: 4.6 mm) manufactured by Tosoh Corp., connected in series

Guard column: TSK guard column Super HZ-H manufactured by Tosoh Corp.

Measuring solvent: Tetrahydrofuran (THF)

Sample concentration: After dissolving 5 mg of the sample to be measured in 10 mL of solvent, filtration was carried out with a 0.45 μm filter. Injection volume: 10 μL

Measuring temperature: 40° C.

Flow rate: 0.35 mL/min

Detector: differential refractometer

Eleven types of TSK standard polystyrene (F-850, F-450, F-128, F-80, F-40, F-20, F-10, F-4, F-2, F-1, and A-5000) by Tosoh Corp. were used to construct a calibration curve. The calibration curve was constructed using a first-order approximation.

### (2) Measurement of Vicat Softening Temperature

The Vicat softening temperature of each of the resins and resin compositions produced in the examples and comparative examples was measured according to ISO 306. The applied load was 50 N, and the heating rate was 50° C./h. If a material has heat resistance with a Vicat softening temperature exceeding 105° C., it can be suitably used as a light guide component for vehicles.

### (3) Measurement of Heat Deflection Temperature

The heat deflection temperature of each resin and resin composition prepared in the Examples and Comparative Examples was measured in accordance with ISO 75 under a load of 1.8 MPa, at a temperature rise rate of 120° C./h, under a flatwise specimen condition. If a material has heat resistance with a heat deflection temperature exceeding 85° C., it can be suitably used as a light guide component for vehicles.

(4) Measurement of Content of Monovalent Alcohol (G) Having 6 or more Carbon Atoms and Other Impurities in Transparent Thermoplastic Resin Composition Mainly Composed of Styrene-unsaturated carboxylic acid-based resin (A1) or (Meth) Acrylic Resin (A3)

The content of the monovalent alcohol (G) having 6 or more carbon atoms in the entire transparent thermoplastic resin composition was measured using gas chromatography under the following conditions. Preparation of sample: 1.0 g of a resin was dissolved in 5 mL of methyl ethyl ketone, then 5 mL of hexane adjusted so that the concentration of p-diethylbenzene (as an internal standard) was to 200 μg/g was added to precipitate the polymer component. The supernatant was taken as the test solution for measurement.

Measurement apparatus: 6850 Series GC System manufactured by Agilent

Detector: FID

Column: DB-WAX
Length: 60 m
Film thickness: 0.50 μm
Diameter: 0.320 mmϕ

Injection volume: 1 μL

Split ratio: 50:1

Column temperature: Held at 100° C. for 5 minutes→heated at 10° C./min to 130° C.→heated at 10° C./min to 180° C.→held at 180° C. for 10 minutes→heated at 20° C./min to 220° C.→held at 220° C. for 10 minutes Inlet temperature: 230° C.

Detector temperature: 300° C.

Carrier gas: Helium

In detecting the peak of the monovalent alcohol (G) having 6 or more carbon atoms, appropriate adjustments of conditions, such as pretreatments, e.g., sample dilution ratios, columns used, and detection conditions, may be made to avoid peak overlaps or saturation of peak intensity.

(5) Measurement of Content of Each Monomer Unit in Transparent Thermoplastic Resin Composition Mainly Composed of Styrene-unsaturated carboxylic acid-based resin (A1) or (Meth) Acrylic Resin (A3)

The content of each monomer unit contained in the resin composition prepared in the examples and comparative examples was measured by pyrolysis GC/MS under the following conditions:

### <Measuring Conditions>

Pyrolysis unit
Apparatus: PY-3030D manufactured by Frontier Lab
Furnace temperature: 600° C.
Boundary temperature: 300° C.
GC/MS
Apparatus: GCMS-QP2020NX manufactured by Shimadzu Corporation
Column: Ultra Alloy-5
(Length: 30 m, film thickness: 0.25 μm, diameter: 0.25 mmϕ) Column temperature: Held at 50° C. for 5 minutes→heated at 10° C./min→heated at 7° C./min from 100° C.→held at 300° C. for 10 minutes
Inlet temperature: 300° C.
Detector temperature: 300° C.
Split ratio: 1/300
Carrier gas: Helium
Detection method: Mass spectrometer (MSD)
Sample amount: 50 ug
Detection mode: Scan mode or SIM mode

In detecting each monomer peak, appropriate adjustments of conditions, such as pretreatments, e.g., sample dilution ratios, columns used, and detection conditions, may be made to avoid peak overlaps or saturation of peak intensity.

### (6) Heat Resistance Evaluation

A long optical path test piece having an optical path length of 300 mm obtained by injection molding the transparent thermoplastic resin composition under the following molding conditions (S1) to (S3) was heated in a dryer at 110° C. for 24 hours, and the molded article was evaluated for deformation based on the following criteria.
A: Dimensional change rate was less than 0.2%
B: Dimensional change rate was 0.2% or more and 0.5% or less
C: Dimensional change rate was 0.5% or more and 1% or less
D: Dimensional change rate was more than 1%<

### Molding Conditions>

The molding conditions (S1) of the transparent thermoplastic resin composition when the transparent thermoplastic resin (A) in the transparent thermoplastic resin composition is mainly composed of a styrene-unsaturated carboxylic acid-based resin (A1): a cylinder temperature of 220° C., a mold temperature of 70° C., and a cycle time of 35 seconds;

The molding conditions (S2) of the transparent thermoplastic resin composition when the transparent thermoplastic resin (A) in the transparent thermoplastic resin composition is mainly composed of an aromatic polycarbonate resin (A2): a cylinder temperature of 260° C., a mold temperature of 80° C., and a cycle time of 35 seconds; or

The molding conditions (S3) of the transparent thermoplastic resin composition when the transparent thermoplastic resin (A) in the transparent thermoplastic resin composition is mainly composed of a (meth)acrylic resin (A3): a cylinder temperature of 240° C., a mold temperature of 70° C., and a cycle time of 35 seconds.

### (7) YI Value at Optical Path Length of 300 mm

A long optical path test piece having an optical path length of 300 mm obtained by injection molding the transparent thermoplastic resin composition under the molding conditions described in the above “(6) Heat Resistance Evaluation” section was conditioned at 23° C. for 24 hours or longer, and the YI value was measured using a long optical path spectrophotometric colorimeter (ASA-2) manufactured by Nippon Denshoku Industries Co., Ltd., and the average (n=3) was determined to be used. In particular, in light guides with long optical paths, the YI value at long optical path lengths may be considered important.

### (8) L* Value at Optical Path Length of 300 mm

A long optical path test piece having an optical path length of 300 mm obtained by injection molding the transparent thermoplastic resin composition under the molding conditions described in the above “(6) Heat Resistance Evaluation” section was conditioned at 23° C. for 24 hours or longer, and the L* value was measured using a long optical path spectrophotometric colorimeter (ASA-2) manufactured by Nippon Denshoku Industries Co., Ltd., and the average (n=3) was used. In particular, in light guides with long optical paths, the L* value at long optical path lengths may be considered important.

(9) ΔYI upon Light Irradiation at Optical Path Length of 300 mm (Light Resistance)

A long optical path test piece having an optical path length of 300 mm obtained by injection molding the transparent thermoplastic resin composition under the molding conditions described in the above “(6) Heat Resistance Evaluation” section was subjected to a light resistance test for 12 hours using a Sunshine Weather Meter S80BBR manufactured by Suga Test Instruments Co., Ltd., under test conditions of a black panel temperature of 83° C. and no rain. The ΔYI value was calculated by subtracting the initial YI value from the YI value after the test. The YI value at 300 mm optical path length was measured using a long optical path spectrophotometric colorimeter (ASA-2) manufactured by Nippon Denshoku Industries Co., Ltd.

(10) ΔYI Value at Optical Path Length of 300 mm upon Thermal Exposure (Long-Term Thermal Stability)

A long optical path test piece having an optical path length of 300 mm obtained by injection molding the transparent thermoplastic resin composition under the molding conditions described in the above “(6) Heat Resistance Evaluation” section was subjected to thermal exposure in a dryer at 110° C. for 1000 hours, and the ΔYI value was calculated by subtracting the initial YI value from the YI value after exposure. The YI value at 300 mm optical path length was measured using a long optical path spectrophotometric colorimeter (ASA-2) manufactured by Nippon Denshoku Industries Co., Ltd.

### (11) Moist Heat Resistance (ΔHz)

A long optical path test piece having an optical path length of 300 mm obtained by injection molding the transparent thermoplastic resin composition under the molding conditions described in the above “(6) Heat Resistance Evaluation” section was cut into a 40 mm×20 mm× 4 mm piece, and a test was conducted for 150 hours under the conditions of temperature of 110° C. and humidity of 85% using a highly accelerated life test apparatus manufactured by Espec Corp. The ΔHz was determined by subtracting the haze (Hz) before the test from the Hz after the test. The smaller the ΔHz, the better the resistance to moist heat and the lower the resin degradation under high temperature and high humidity environments.

### (12) Moist Heat Resistance (ΔVicat)

A long optical path test piece having an optical path length of 300 mm obtained by injection molding the transparent thermoplastic resin composition under the molding conditions described in the above “(6) Heat Resistance Evaluation” section was cut into a 40 mm× 20 mm× 4 mm piece, and a test was conducted for 150 hours under the conditions of a temperature of 110° C. and a humidity of 85% using a highly accelerated life test apparatus manufactured by Espec Corp. The ΔVicat was determined by subtracting the Vicat softening temperature (VICAT) before the test from the VICAT after the test. The smaller the ΔVICAT, the more resistant the resin is to water absorption, exhibiting excellent moist heat resistance and enabling favorable use even under high temperature and high humidity conditions.

### (13) Moldability (Flowability)

The minimum injection pressure at which molding could be conducted without resulting in a short shot was evaluated when a 2 mm thick plate was molded using a transparent thermoplastic resin with an injection molding machine (model SE-75, manufactured by Sumitomo Heavy Industries, Ltd.) under the conditions of a cylinder temperature of 250° C., a mold temperature of 60° C., and a back pressure of 10 MPa. In this evaluation, a lower injection pressure required for molding indicates that even products with complex shapes or thin portions can be molded without causing short shots at relatively low cylinder temperatures. Being moldable at a low cylinder temperature allows suppression of resin degradation during molding and enables the production of molded articles with low initial yellowness.

### (14) Moldability (Mold Releaseability)

The mold releasability was evaluated based on the degree of damage caused by the mold release resistance occurred inside the molded article during removal of the molded article during injection molding. Specifically, a mold in the shape of a box-shaped molded body with external dimensions of 50 mm (length)× 90 mm (width)× 40 mm (depth), a wall thickness of 2 mm, and two ribs with a thickness of 1 mm at 30 mm intervals in the lateral position was used. Injection molding was conducted under the following conditions using an injection molding machine J100E-P manufactured by The Japan Steel Works, Ltd. The releasability was evaluated based on the degree of damage at the time of mold release inside the molded article in accordance with the following criteria:
A: No scar was observed at all.
B: Slight point-like scars were observed at the corner portions inside the molded article.
C: Slight linear scars of 2 mm or less were observed at the corner portions inside the molded article.
D: Linear scars greater than 2 mm were observed at the corner portions inside the molded article.

### <Molding Conditions>

The molding conditions (S1′) of the transparent thermoplastic resin composition when the transparent thermoplastic resin (A) in the transparent thermoplastic resin composition is mainly composed of a styrene-unsaturated carboxylic acid-based resin (A1): a cylinder temperature of 220° C. and a mold temperature is 70° C.;

The molding conditions (S2′) of the transparent thermoplastic resin composition when the transparent thermoplastic resin (A) in the transparent thermoplastic resin composition is mainly composed of an aromatic polycarbonate resin (A2): a cylinder temperature of 260° C. and a mold temperature of 80° C.; or

The molding conditions (S3′) of the transparent thermoplastic resin composition when the transparent thermoplastic resin (A) in the transparent thermoplastic resin composition is mainly composed of a (meth)acrylic resin (A3): a cylinder temperature of 240° C. and a mold temperature of 70° C.

(15) Measurement of Total Light Transmittance of 2 mm-Thick Plate

In the present embodiment, the total light transmittance of a 2 mm-thick plate of the transparent thermoplastic resin composition was measured under the following conditions after preparing a test piece.

### (I) Preparation Conditions for Test Piece

A 2 mm-thick plate was produced by injection molding the transparent thermoplastic resin composition using a flat plate mold under the following conditions.

Injection molding machine: SE-75 manufactured by Sumitomo Heavy Industries, Ltd.

The molding conditions of the transparent thermoplastic resin composition are as follows, and the appropriate molding conditions vary depending on which of the resins (A1) to (A3) is the main component of the transparent thermoplastic resin (A) in the transparent thermoplastic resin composition.

The molding conditions (S1) of the transparent thermoplastic resin composition in the case where the main component of the transparent thermoplastic resin (A) in the transparent thermoplastic resin composition is a styrene-unsaturated carboxylic acid-based resin (A1): a cylinder temperature of 220° C., a mold temperature of 60° C., and a cooling time of 15 seconds;

The molding conditions (S2) of the transparent thermoplastic resin composition in the case where the main component of the transparent thermoplastic resin (A) in the transparent thermoplastic resin composition is an aromatic polycarbonate resin (A2): a cylinder temperature of 260° C., a mold temperature of 80° C., and a cooling time of 15 seconds; or

The molding conditions (S3) of the transparent thermoplastic resin composition in the case where the main component of the transparent thermoplastic resin (A) in the transparent thermoplastic resin composition is a (meth)acrylic resin (A3): a cylinder temperature of 240° C., a mold temperature of 60° C., and a cooling time of 15 seconds.

### (II) Measurement Conditions for Total Light Transmittance

The 2 mm-thick plate produced under the above conditions was used to measure total light transmittance (%) in accordance with JIS K 7361-1.

### Preparation of Each Resin and Production Examples of Transparent

### Thermoplastic Resin Composition

The preparation of each resin and the specific method for producing the transparent thermoplastic resin compositions will be described below.

### Production Example of Styrene-Unsaturated Carboxylic Acid-Based Resin (A1)

-Preparation of Resin ps1-

A polymerization feed composition consisting of 65.5 parts by mass of styrene (containing 20 μg/g of t-butyl catechol as a polymerization inhibitor), 3.8 parts by mass of methyl methacrylate, 6.9 parts by mass of methacrylic acid (containing 50 μg/g of 4-methoxyphenol as a polymerization inhibitor), 21.3 parts by mass of ethylbenzene, 2.5 parts by mass of 2-ethyl-1-hexanol, and 0.027 parts by mass of 1,1-bis(t-butylperoxy) cyclohexane was continuously supplied at a rate of 0.8 liters/hour to a 3.6-liter complete mixing-type reactor. This mixture was then continuously fed to a devolatilizer, which was connected to a single-screw extruder designed to remove unreacted monomers and volatile components such as polymerization solvents. The polymerization temperature in the complete mixing-type reactor was set to 130° C. The temperature of the single-screw extruder was set to 210 to 230° C., and the pressure to 10 torr to devolatilize the unreacted monomers and polymerization solvents. The volatilized components were condensed using a condenser cooled to −5° C. and collected as unreacted liquid, while the styrene-based resin was recovered as resin pellets. The physical properties of the Resin ps1 obtained through the above-mentioned analysis methods are summarized in Table 1.

-Preparation of Resins ps2 to ps3 and ps5 to ps6-

By adjusting the feed amounts of each monomer and polymerization conditions, Resins ps2 to ps3 and ps5 to ps6 were prepared following a procedure similar to that of Resin ps1. The compositions and physical properties of the obtained resins ps1 to ps6 are summarized in Table 1.

-Preparation of Resin ps4-

Using only styrene as the monomer, Resin ps4 was obtained as a styrene homopolymer with the composition and physical properties summarized in Table 1, following similar procedures as described above.

TABLE 1

| | | | Resin | Resin | Resin | Resin | Resin | Resin |
|---|---|---|---|---|---|---|---|---|
| Table 1 | | | (ps1) | (ps2) | (ps3) | (ps4) | (ps5) | (ps6) |
| Composition | Styrene monomer unit (St) | mass % | 84.0 | 92.0 | 90.0 | 100.0 | 80.0 | 75.0 |
| | Methacrylic acid monomer unit (MAA) | mass % | 11.0 | 8.0 | 10.0 | 0.0 | 15.0 | 10.0 |
| | Methyl methacrylate monomer unit (MMA) | mass % | 5.0 | 0.0 | 0.0 | 0.0 | 5.0 | 15.0 |
| | n-acrylic acid (n-butyl) monomer unit (n-BA) | mass % | 0.0 | 0.0 | 0.0 | 0.0 | 0.0 | 0.0 |
| | Rubbery polymer containing conjugated diene | mass % | 0.0 | 0.0 | 0.0 | 0.0 | 0.0 | 0.0 |
| | monomer unit | | | | | | | |
| Properties | Number average Molecular Wt. Mn | ×10,000 | 7.0 | 8.5 | 9.1 | 9.0 | 6.0 | 6.0 |
| and physical | Weight average Molecular Wt. Mw | ×10,000 | 19.0 | 19.0 | 18.0 | 22.0 | 17.0 | 17.0 |
| properties | Z average Molecular Wt. Mz | ×10,000 | 39.0 | 38.0 | 36.0 | 38.0 | 34.0 | 33.0 |
| | Mw/Mn | | 2.7 | 2.2 | 2.0 | 2.4 | 2.8 | 2.8 |
| | Mz/Mw | | 2.0 | 2.0 | 2.0 | 1.7 | 2.0 | 1.9 |
| | Total light transmittance of 2 mm-thick plate | % | 91.0 | 91.0 | 91.0 | 91.0 | 91.0 | 91.0 |
| | Melt mass flow rate | g/10 min | 0.7 | 1.6 | 2.0 | 3.1 | 0.4 | 0.4 |
| | Vicat softening temperature | ° C. | 124.0 | 118.0 | 121.0 | 102.0 | 129.0 | 122.0 |

The obtained resins ps1 to ps8 contained impurities, such as residual styrene monomer in the range of approximately 100 to 500 μg/g, ethylbenzene in the range of approximately 10 to 200 μg/g, 2-ethyl-1-hexanol in the range of approximately 30 to 120 μg/g, and styrene dimers and trimers in the range of approximately 1000 to 6000 μg/g. These impurities, derived from the residuals of the above polymerization feedstock composition, were quantified using the same gas chromatography method as used for the quantification of monovalent alcohols (G) with carbon atoms of 6 or more, as previously described.

### <Aromatic Polycarbonate Resin (A2)>

In the examples and comparative examples of this specification, the following products were used as the aromatic polycarbonate resin (A2).
pc1: LC1500 (manufactured by Idemitsu Kosan Co., Ltd.)
pc2: A1900 (manufactured by Idemitsu Kosan Co., Ltd.)
pc3: Iupilon HL-3003 (manufactured by Mitsubishi Engineering-Plastics Corporation)

All exhibited a total light transmittance of 91% with a 2 mm-thick plate. <Production Example of (Meth) Acrylic Resin (A3)>

-Preparation of Resin pm1-

A suspension agent was prepared by adding 2 kg of water, 65 g of calcium phosphate tribasic, 39 g of calcium carbonate, and 0.39 g of sodium lauryl sulfate into a 5 L vessel equipped with a stirrer and then mixing and stirring. Subsequently, 26 kg of water was added to a 60-L reactor, which was heated to 80° C. to prepare for suspension polymerization. After confirming that the temperature had stabilized at 80° C., 1.56 kg of methyl methacrylate, 0.03 kg of methyl acrylate, 0.99 g of lauroyl peroxide, 4.33 g of n-octyl mercaptan, and the above-described suspension agent were added as polymerization feedstock. Next, suspension polymerization was performed while the temperature was kept at about 80° C. After the exothermic peak was observed, the temperature was raised to 92° C. at a rate of 1° C./min, and the temperature was maintained at 92° C. for 60 minutes. Subsequently, the mixture was cooled to 50° C., and then 20 mass % sulfuric acid was added to dissolve the suspension agent. The polymerized reaction solution was removed from the 60-L reactor, passed through a sieve with a mesh size of 1.7 mm to remove large aggregates, and the solid components were separated using a Buchner funnel to obtain bead-shaped polymer. This bead-shaped polymer was washed on the Buchner funnel using approximately 20 L of distilled water and dehydrated with this washing and dehydrating cycle repeated five times, dried, and pelletized using a single-screw extruder to obtain pelletized Resin pm1.

-Preparation of Resins pm2 to pm5-

By adjusting the feed amounts of each monomer and polymerization conditions, Resins pm2 to pm5 were prepared following a procedure similar to that of Resin pm1. The compositions and physical properties of the obtained resins pm1 to pm5 are summarized in Table 2.

TABLE 2

| | | | Resin | Resin | Resin | Resin | Resin |
|---|---|---|---|---|---|---|---|
| Table 2 | | | (pm1) | (pm2) | (pm3) | (pm4) | (pm5) |
| Composition | Methyl methacrylate monomer unit (MMA) | mass % | 98 | 94 | 93 | 92 | 50 |
| | Methyl acrylate monomer unit (MA) | mass % | 2 | 6 | 0 | 0 | 0 |
| | n-acrylic acid (n-butyl) monomer unit (n-BA) | mass % | 0 | 0 | 0 | 0 | 0 |
| | Methacrylic acid monomer unit (MAA) | mass % | 0 | 0 | 7 | 0 | 0 |
| | N-cyclohexylmaleimide (CMI) | mass % | 0 | 0 | 0 | 8 | 0 |
| | Styrene monomer unit (St) | mass % | 0 | 0 | 0 | 0 | 50 |
| Properties | Number average Molecular Wt. Mn | ×10,000 | 5 | 10 | 10 | 5 | 5 |
| and physical | Weight average Molecular Wt. Mw | ×10,000 | 10 | 19 | 19 | 10 | 10 |
| properties | Z average Molecular Wt. Mz | ×10,000 | 150 | 28.5 | 28.5 | | 15 |
| | Mw/Mn | — | 1.9 | 1.9 | 1.9 | 2 | 2 |
| | Mz/Mw | — | 1.5 | 1.5 | 1.5 | | 1.5 |
| | Total light transmittance of 2 mm-thick plate | % | 92 | 92 | 92 | 92 | 91 |
| | Vicat softening temperature (5 kg load) | ° C. | 106 | 105 | 115 | 120 | 101 |

### <Phosphorus-Based Compound (B)>

The following compounds or products listed in Table 3 and having the chemical structures were used as the phosphorus-based compound (B).

TABLE 3

| Table 3 | Chemical name | Trade Name |
|---|---|---|
| b-1 | 9,10-Dihydro-9-oxa-10-phosphaphenanthrene-10-oxide | HCA manufactured by Sanko Co., Ltd. |
| b-2 | 10-(2,5-Dhydroxyphenyl)-9,10-dihydro9-oxa-10- | HCA-HQ manufactured by Sanko Co., Ltd. |
| | phosphaphenanthrene-10-oxide | |
| b-3 | Phosphonic acid ester compound | Nonnen 73 |
| b-4 | 9,10-Dihydro-10-benzyl-9-oxa-10-phosphananthren-10-oxide | BCA manufactured by Sanko Co., Ltd. |

Phosphorus-based compound (b-1):

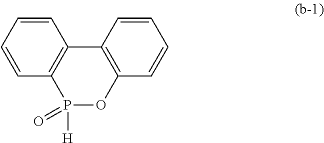 [SMILES: O=[PH]1Oc2ccccc2-c2ccccc21]

### CAS No.: 35948-25-5

Phosphorus-based compound (b-2):

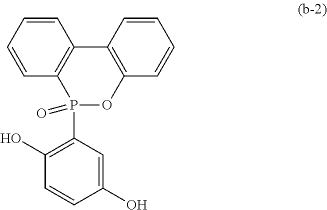 [SMILES: O=P1(c2cc(O)ccc2O)Oc2ccccc2-c2ccccc21]

### CAS No.: 99208-50-1

Phosphorus-based compound (b-4):

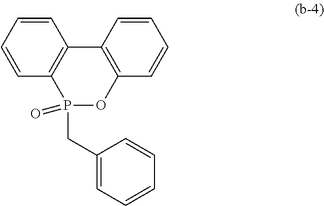 [SMILES: O=P1(Cc2ccccc2)Oc2ccccc2-c2ccccc21]

### CAS No.: 113504-81-7

### <Phenolic Antioxidant (C1)>

In the examples of this specification, the following phenolic antioxidants were used as the phenolic antioxidant (C1).

-Phenolic antioxidant (c1-1): Irganox 1076 manufactured by BASF Japan Chemical name: Octadecyl 3-(3,5-di-tert-butyl-4-hydroxyphenyl) propionate CAS No.: 2082-79-3
-Phenolic antioxidant (c1-2): Irganox 1010 manufactured by BASF Japan

Chemical name: 2,2-bis [[[3-(3,5-di-tert-butyl-4-hydroxyphenyl) propionyl] oxy] methyl]propane -1,3-diol 1,3-bis[3-(3,5-di-tert-butyl-4-hydroxyphenyl) propionate] CAS No.: 6683-19-8

-Phenolic antioxidant (c1-3): Irganox 1330 manufactured by BASF Japan name:

4,4′,4″-[(2,4,6-trimethylbenzene-1,3,5-triyl) tris (methylene)] tris (2,6-di-tert-bu tylphenol)

### Chemical

CAS No.: 1709-70-2
Phenolic antioxidant (c1-4): Irganox 245 manufactured by BASF Japan

Chemical name:

bis(3-tert-butyl-4-hydroxy-5-methylbenzenepropanoic acid) ethylenebis (oxyethylene)

CAS No.: 36443-68-2

Phenolic antioxidant (c1-5): Sumilizer GP manufactured by

Sumitomo Chemical Co., Ltd.

Chemical name:

6-tert-butyl-4-[3-[(2,4,8, 10-tetra-tert-butyldibenzo[d,f] [1,3,2]dioxaphosphep ine-6-yl)oxy] propyl]-2-methylphenol CAS No.: 203255-81-6

Phenolic antioxidant (c1-6): Sumilizer GA-80 manufactured by Sumitomo Chemical Co., Ltd.

Chemical name: 2,2′-dimethyl-2,2′-(2,4,8, 10-tetraoxaspiro[5.5]undecan-3,9-diyl) dipropane-1,1 ′-diyl bis [3-(3-tert-butyl-4-hydroxy-5-methylphenyl) propionate] CAS No.: 90498-90-1

Phenolic antioxidant (c1-7): Irganox 1098 manufactured by BASF

### Japan

Chemical name: N,N’-(1,6-hexanediyl)bis[3,5-bis(1,1-dimethylethyl)-4-hydroxybenzenepropio namide]

CAS No.: 23128-74-7

Phenolic antioxidant (c1-8): Irganox 3114 manufactured by BASF Japan

Chemical name: 1,3,5-tris [[3,5-bis (1,1-dimethylethyl)-4-hydroxyphenyl]methyl]-1,3,5-triazine -2,4,6 (1H,3H,5H)-trione CAS No.: 27676-62-6

Phenolic antioxidant (c1-9): Irganox 259 manufactured by BASF Japan

Chemical name: 1,6-hexanediol bis [3-(3,5-di-tert-butyl-4-hydroxyphenyl) propionate] CAS No.: 35074-77-2

TABLE 4

| Table 4 | Chemical name | Trade Name | Molecular wt. |
|---|---|---|---|
| c1-1 | Octadecyl 3-(3,5-di-tert-butyl-4-hydroxyphenyl)propanoate | Irganox 1076 | 531 |
| c1-2 | 2,2-Bis[[[3-(3,5-di-tert-butyl-4-hydroxyphenyl)propionyl]oxy]methyl]propane-1,3-diol 1,3-bis[3- | Irganox 1010 | 1178 |
| | (3,5-di-tert-butyl-4-hydroxyphenyl)propionate] 1,3-diol 1,3-bis[3-(3,5-di-tert-butyl-4- | | |
| | hydroxyphenyl)propionate] | | |
| c1-3 | 4,4′,4″-[(2,4,6-Trimethylbenzene-1,3,5-triyl)tris(methylene)]tris(2,6-di-tert-butylphenol) | Irganox 1330 | 775 |
| c1-4 | Bis(3-tert-butyl-4-hydroxy-5-methylbenzylpropanoate) ethylenebis(oxyethylene) | Irganox 245 | 587 |
| c1-5 | 6-tert-Butyl-4-[3-[(2,4,8,10-tetra-tert-butyl-dibenzo[d,f][1,3,2]dioxaphosphepin-6-yl)oxy]propyl]-2- | Misriser GP | 661 |
| | methylphenol | | |
| c1-6 | 2,2′-Dimethyl-2,2′-(2,4,8,10-tetraoxaspiro[5.5]undecane-3,9-diyl)dipropane-1,1′-diyl bis[3-(3-tert- | Misriser GA-80 | 741 |
| | butyl-4-hydroxy-5-methylphenyl)propanoate] | | |
| c1-7 | Hexanediyl N,N′-(1,6-) bis[3,5-bis(1,1-dimethylethyl)-4-hydroxybenzenepropanamide] | Irganox 1098 | 637 |
| c1-8 | 1,3,5-Tris[[3,5-bis(1,1-dimethylethyl)-4-hydroxyphenyl]methyl]-1,3,5-triazinane-2,4,6-trione | Irganox 3114 | 784 |
| c1-9 | 1,6-Hexanediol bis[3-(3,5-di-tert-butyl-4-hydroxyphenyl)propionate] | Irganox 259 | 639 |

### <Phosphorus-Based Antioxidant (C2)>

In the examples of this specification, the following phosphorus-based antioxidants were used as the phosphorus-based antioxidant (C2).

Phosphorus-based antioxidant (c2-1): Irgafos 168 manufactured by BASF Japan

Chemical name: tris (2,4-di-tert-butylphenoxy) phosphine

CAS No.: 31570 Apr. 4

Phosphorus-based antioxidant (c2-2): ADK STAB HP-10 manufactured by ADEKA Corporation Chemical name: 2,4,8, 10-tetrakis (1,1-dimethylethyl)-6-[(2-ethylhexyl)oxy]-12H-dibenzo[d, g] [1,3,2] dioxaphosphocin

CAS No.: 126050-54-2

Phosphorus-based antioxidant (c2-3): ADK STAB PEP-36 manufactured by ADEKA Corporation Chemical name: 3,9-bis(2,6-di-tert-butyl-4-methylphenoxy)-2,4,8,10-tetraoxa-3,9-diphosphasp iro [5.5]undecane

CAS No.: 80693-00-1

Phosphorus-based antioxidant STAB PEP-8 manufactured by ADEKA Corporation Chemical name: 3,9-bis(octadecyloxy)-2,4,8, 10-tetraoxa-3,9-diphosphaspiro[5.5]undecane

### CAS No.: 3806-34-6

TABLE 5

| Table 5 | Chemical name | Trade Name | Molecular wt. |
|---|---|---|---|
| c2-1 | Tris(2,4-dibutylphenoxy-tert-)phosphinic | Irgafos 168 | 647 |
| c2-2 | 2,4,8,10-Tetrakis(1,1-dimethylethyl)-6-[(2-ethylhexyl)oxy]-12H-dibenzo[d,g][1,3,2]dioxaphosphocin | ADK STAB HP-10 | 583 |
| c2-3 | 3,9-Bis(2,6-di-tert-butyl-4-methylphenoxy)-2,4,8,10-tetraoxa-3,9-diphosphaspiro[5.5]undecane | ADK STAB PEP-36 | 633 |
| c2-4 | 3,9-Bis(octadecyloxy)-2,4,8,10-tetraoxa-3,9-diphosphaspiro[5.5]undecane | ADK STAB PEP-8 | 733 |

### <Ultraviolet Absorber (D)>

In the examples of this specification, the following ultraviolet absorbers were used as the ultraviolet absorber (D):

Ultraviolet absorber (d-1): JF-77 manufactured by Johoku Chemical Industry Co., Ltd.

Chemical name: 2-(2′-hydroxy-5′-methylphenyl)benzotriazole CAS No.: 2440-22-4
Ultraviolet absorber (d-2): ADK STAB LA-46 manufactured by ADEKA Corporation

Chemical name:

2-(4,6-diphenyl-1,3,5-triazin-2-yl)-5-[2-(2-ethylhexanoyloxy) ethoxy] phenol CAS No.: 371146 Apr. 2
Ultraviolet absorber (d-3): ADK STAB 1413 manufactured by ADEKA Corporation

Chemical name: 2-hydroxy-4-n-octyloxybenzophenone CAS No.: 1843 May 6
Ultraviolet absorber (d-4): HOSTAVIN B-CAP manufactured by Clariant Japan Co., Ltd.

Chemical name:

tetraethyl=2,2′-(1,4-phenylenedimethanediylidene) dimalonate CAS No.: 6337-43-5
Ultraviolet absorber (d-5): HOSTAVIN PR-25 manufactured by

### Clariant Japan Co., Ltd.

Chemical name: p-methoxybenzylidenemalonate dimethyl ester CAS No.: 7443-25-6
Ultraviolet absorber (d-6): HOSTAVIN VSU manufactured by

### Clariant Japan Co., Ltd.

Chemical name: N-(2-ethylphenyl)-N′-(2-ethoxyphenyl) oxalamide CAS No.: 23949-66-8

TABLE 6

| Table 6 | Chemical name | Trade Name | Molecular wt. |
|---|---|---|---|
| d-1 | 2-(2′-Hydroxy-5′-methylphenyl)benzotriazole | JF-77 | 225 |
| d-2 | 2-(4,6-Diphenyl-1,3,5-triazin-2-yl)-5-[2-(2-ethylhexanoyloxy)ethoxy]phenol | ADK STAB LA-46 | 512 |
| d-3 | 2-Hydroxy-4-n-octyloxybenzophenone | ADK STAB 1413 | 326 |
| d-4 | Tetraethyl 2,2′-(1,4-phenylenedimethane 2-ylidene) dimalonate | HOSTAVIN B-CAP | 418 |
| d-5 | p-Methoxybenzylidenemalonate dimethyl ester | HOSTAVIN PR-25 | 250 |
| d-6 | N-(2-ethylphenyl)-N′-(2-ethoxyphenyl)oxalic acid diamide | HOSTAVIN VSU | 312 |

### <Light Stabilizer (E)>

In the examples of this specification, the following light stabilizers were used as the light stabilizer (E).
Light stabilizer (e-1): JF-90G manufactured by Johoku Chemical Industry Co., Ltd.

Chemical name: bis(2,2,6,6-tetramethyl-4-piperidyl) sebacate CAS No.: 52829 Jul. 9
Light stabilizer (e-2): JF-95 manufactured by Johoku Chemical Industry Co., Ltd.

Chemical name: bis(1,2,2,6,6-pentamethyl-4-piperidyl) sebacate CAS No.: 41556-26-7

TABLE 7

| Table 7 | Chemical name | Trade Name |
|---|---|---|
| e-1 | Bis(2,2,6,6-tetramethyl-4-piperidyl)sebacate | JF-90G |
| e-2 | Bis(1,2,2,6,6-pentamethyl-4-piperidyl)sebacate | JF-95 |

### <Mold Release Agent (F)>

In the examples of this specification, the compounds summarized in Table 8 were used as the mold release agent (F).

TABLE 8

| Table 8 | Chemical name/trade name | Molecular wt. |
|---|---|---|
| f-1 | Stearic acid | 284 |
| f-2 | Glycerol monostearate | 359 |
| f-3 (wetted) | Ethylene bisstearate | 593 |

Among those listed in Table 8, stearic acid (f-1) and glycerol monostearate (f-2) were used as internal lubricants (F1), while ethylenebis (stearamide) (f-3) was used as external lubricant (F2).

### <Monovalent Alcohol (G) Having 6 or More Carbon Atoms>

In the examples of this specification, the following types of alcohol were used as the monovalent alcohol (G) having 6 or more carbon atoms.

As a monovalent alcohol (g-1), Kalcol 8980 (stearyl alcohol) manufactured by Kao Corporation was used.

As a monovalent alcohol (g-2), Fine Oxocol 180 manufactured by Chemical Corporation (compound name: Nissan 5,7,7-trimethyl-2-(1,3,3-trimethylbutyl)-1-octanol) was used.

As a monovalent alcohol (g-3), 2-ethylhexanol was used.

As a monovalent alcohol (g-4), Emulgen 109P manufactured by Kao Corporation (polyoxyethylene (9) lauryl ether mono alcohol) was used.

TABLE 9

| Table 9 | Chemical name/trade name |
|---|---|
| g-1 | Stearyl Alcohol/Calcohol 8980 |
| g-2 | 5,7,7-Trimethyl-2-(1,3,3-trimethylbutyl)-1-octanol/Fine |
| | Oxocole 180 |
| g-3 | 2-Ethylhexanol |
| g-4 | Polyoxyethylene lauryl ether/Emulsifier 109P |

### <Production Examples of Resin Containing Rubbery Polymer (H)>

-Preparation of Resin h-6-

A polymerization feed composition consisting of 65.5 parts by mass of styrene (containing 20 μg/g of t-butyl catechol as a polymerization inhibitor), 3.8 parts by mass of methyl methacrylate, 6.9 parts by mass of methacrylic acid (containing 50 μg/g of 4-methoxyphenol as a polymerization inhibitor), 2.4 parts by mass of polybutadiene rubber (Diene 55 manufactured by Asahi Kasei Chemicals Corporation), 18.9 parts by mass of ethylbenzene, 2.5 parts by mass of 2-ethyl-1-hexanol, and 0.027 parts by mass of 1,1-bis(t-butylperoxy) cyclohexane was continuously supplied at a rate of 0.8 liters/hour to a 3.6-liter complete mixing-type reactor. This mixture was then continuously fed to a devolatilizer, which was connected to a single-screw extruder designed to remove unreacted monomers and volatile components such as polymerization solvents. The polymerization temperature in the complete mixing-type reactor was set to 130° C. The temperature of the single-screw extruder was set to 210 to 230° C., and the pressure to 10 torr to devolatilize the unreacted monomers and polymerization solvents. The volatilized components were condensed using a condenser cooled to −5° C. and collected as unreacted liquid, while the styrene-based resin was recovered as resin pellets. The physical properties of the Resin h-6 obtained through the above-mentioned analysis methods are summarized in Table 1.

-Preparation of Resins h-7 to h-11-

Resins h-7 to h-11 were prepared in a similar manner to Resin h-6. In Resin h-11, styrene-butadiene rubber (Asaprene 625A manufactured by Asahi Kasei Chemicals Corporation) was used.

Preparation of Resins h-12 and h-13-

Resins h-12 and h-13 were prepared by emulsion polymerization so as to have the composition summarized in Table 10 below. See Table 10 below.

TABLE 10

| | | | Resin | Resin | Resin | Resin | Resin | Resin | Resin | Resin |
|---|---|---|---|---|---|---|---|---|---|---|
| Table 10 | | | (h-6) | (h-7) | (h-8) | (h-9) | (h-10) | (h-11) | (h-12) | (h-13) |
| Composition | Styrene monomer unit (St) | mass % | 82.5 | 83.9 | 84.2 | 84.6 | 83.9 | 54.8 | 22 | 22.5 |
| | Methacrylic acid monomer unit (MAA) | mass % | 10 | 10 | 10 | 10 | 11 | 0 | 0 | 0 |
| | Methyl methacrylate monomer unit (MMA) | mass % | 4 | 4 | 5 | 5 | 5 | 43 | 70 | 71 |
| | n-acrylic acid (n-butyl) monomer unit (n-BA) | mass % | 0 | 0 | 0 | 0 | 0 | 0.0 | 0 | 0 |
| | Acrylonitrile monomer unit (AN) | mass % | 0 | 0 | 0 | 0 | 0 | 0.0 | 4 | 5 |
| | Rubbery polymer (H) containing | mass % | 3.5 | 2.1 | 0.8 | 0.4 | 0.1 | 2.2 | 4 | 2.1 |
| | conjugated diene monomer unit | | | | | | | | | |
| Properties | Number average Molecular wt. Mn | ×10,000 | 6.5 | 6.5 | 6.5 | 7.5 | 7.5 | 6.0 | 4.0 | 4.0 |
| and physical | Weight average Molecular wt. Mw | ×10,000 | 15 | 15 | 16 | 16.5 | 16.5 | 14 | 8.0 | 8.0 |
| properties | Z average Molecular wt. Mz | ×10,000 | 26 | 26 | 28 | 29 | 29 | 25 | 14 | 14 |
| | Mw/Mn | | 2.3 | 2.3 | 2.5 | 2.2 | 2.2 | 2.3 | 2 | 2 |
| | Mz/Mw | | 1.7 | 1.7 | 1.8 | 1.8 | 1.8 | 1.8 | 1.8 | 1.8 |
| | Melt mass flow rate | g/10 min | 0.6 | 0.6 | 0.8 | 0.8 | 0.8 | 1.7 | 1.1 | 1.5 |
| | Vicat softening temperature | ° C. | 119 | 119 | 120 | 121 | 121 | 94 | 95 | 97 |

### <Production Example of Transparent Resin Composition>

The detailed production methods of the transparent thermoplastic resin compositions will be described below.

### Example 1

After blending 100 mass % of the resin ps1 listed in Table 1 as the styrene-unsaturated carboxylic acid-based resin (A1); 0.05 mass % of the phosphorus-based compound (b-1) listed in Table 2 as the phosphorus-based compound (B); 0.05 mass % of the phenolic antioxidant c1-1 listed in Table 4, that is, octadecyl 3-(3,5-di-tert-butyl-4-hydroxyphenyl) propionate as the phenolic antioxidant (C1); 0.1 mass % of the phosphorus-based antioxidant c2-1 listed in Table 5, that is, tris (2,4-di-tert-butylphenoxy) phosphine as the phosphorus-based antioxidant (C2); 0.02 mass % of the ultraviolet absorber d-1 listed in Table 4, that is, 2-(2-hydroxy-5-methylphenyl)benzotriazole as the ultraviolet absorber (D); and 0.2 mass % of stearyl alcohol (g-1) listed in Table 9 (product name: Kalcol 8980) as the monovalent alcohol (G) having 6 or more carbon atoms, the blend was kneaded and extruded using a single-screw extruder HS-30 manufactured by Ishinaka Iron Works, Co., Ltd., and pelletized. Then, 0.01 mass % of ethylenebis (stearamide) (f-3), which is the mold release agent (F), was dry blended as an external lubricant to the resin pellets, to obtain a transparent thermoplastic resin composition (1) in the form of resin pellets. The screw rotation speed was 150 rpm, the cylinder temperature was 180 to 220° C., and the feed rate was 10 kg/h. The resin temperature was 230 to 240° C. The evaluation results of the obtained transparent thermoplastic resin composition (1) and molded articles thereof are summarized in Table 11-1.

### Examples 2 to 59

Transparent thermoplastic resin compositions (2) to (59) and molded articles thereof were obtained in the same manner as Example 1 except for changing the formulation as listed in Tables 11 and 12 below. Evaluation results of each composition and molded article are summarized in Tables 11-1 to 11-2, Tables 12-1 to 12-2, and Tables 13-1 to 13-2.

### Comparative Examples 1 to 11

Resin compositions and molded articles thereof of Comparative Examples 1 to 11 were obtained in the same manner as in Example 1 except for changing the composition as listed in Table 14. The evaluation results of each composition and molded article are summarized in Table 14.

| Transparent thermoplastic resin composition | | | (1) | (2) | (3) | (4) | (5) | (6) | (7) | (8) | (9) | (10) |
|---|---|---|---|---|---|---|---|---|---|---|---|---|
| Type of | Styrene-unsaturated carboxylic | | ps1 | ps1 | ps1 | ps1 | ps1 | ps1 | ps1 | ps2 | ps3 | ps5 |
| each raw | acid-based resin (A1) | | | | | | | | | | | |
| material | Aromatic polycarbonate (A2) | | — | — | — | — | — | — | — | — | — | — |
| | (Meth)Acrylic Resin (A3) | | — | — | — | — | — | — | — | — | — | — |
| | Phosphorus-based compound (B) | | b-1 | b-1 | b-1 | b-1 | b-2 | b-3 | b-4 | b-1 | b-1 | b-1 |
| | Phenolic antioxidant (C1) | | c1-1 | c1-1 | c1-1 | c1-1 | c1-1 | c1-1 | c1-1 | c1-1 | c1-1 | c1-1 |
| | Phosphorus-based | | c2-1 | c2-1 | c2-1 | c2-1 | c2-1 | c2-1 | c2-1 | c2-1 | c2-1 | c2-1 |
| | antioxidant (C2) | | | | | | | | | | | |
| | UV absorber (D) | | d-1 | d-4 | d-4 | d-4 | d-4 | d-4 | d-4 | d-4 | d-4 | d-4 |
| | Light stabilizer (E) | | — | — | — | — | — | — | — | — | — | — |
| | Mold release agent (F) | | f-3 | f-3 | f-3 | f-3 | f-3 | f-3 | f-3 | f-3 | f-3 | f-3 |
| | Resin containing rubbery | | — | — | — | — | — | — | — | — | — | — |
| | polymer (H) | | | | | | | | | | | |
| Formulation | Styrene-unsaturated | mass % | 100 | 100 | 100 | 100 | 100 | 100 | 100 | 100 | 100 | 100 |
| | carboxylic acid-based | | | | | | | | | | | |
| | resin (A1) | | | | | | | | | | | |
| | Aromatic polycarbonate (A2) | mass % | — | — | — | — | — | — | — | — | — | — |
| | (Meth)Acrylic Resin (A3) | mass % | — | — | — | — | — | — | — | — | — | — |
| | Phosphorus-based | mass % | 0.05 | 0.05 | 0.12 | 0.03 | 0.05 | 0.05 | 0.05 | 0.05 | 0.05 | 0.05 |
| | compound (B) | | | | | | | | | | | |
| | Phenolic antioxidant (C1) | mass % | 0.05 | 0.05 | 0.05 | 0.05 | 0.05 | 0.05 | 0.05 | 0.05 | 0.05 | 0.05 |
| | Phosphorus-based | mass % | 0.1 | 0.1 | 0.1 | 0.1 | 0.1 | 0.1 | 0.1 | 0.1 | 0.1 | 0.1 |
| | antioxidant (C2) | | | | | | | | | | | |
| | UV absorber (D) | mass % | 0.02 | 0.02 | 0.02 | 0.02 | 0.02 | 0.02 | 0.02 | 0.02 | 0.02 | 0.02 |
| | Light stabilizer (E) | mass % | — | — | — | — | — | — | — | — | — | — |
| | Mold release agent (F) | mass % | 0.01 | 0.01 | 0.01 | 0.01 | 0.01 | 0.01 | 0.01 | 0.01 | 0.01 | 0.01 |
| | Resin containing rubbery | mass % | — | — | — | — | — | — | — | — | — | — |
| | polymer (H) | | | | | | | | | | | |
| | Rubbery polymer (H) | mass % | — | — | — | — | — | — | — | — | — | — |
| | Stearyl alcohol (g-1) | mass % | 0.2 | 0.2 | 0.2 | 0.2 | 0.2 | 0.2 | 0.2 | 0.2 | 0.2 | 0.2 |
| | Fine oxocholic 180 (g-2) | mass % | 0.15 | 0.15 | 0.15 | 0.15 | 0.15 | 0.15 | 0.15 | 0.15 | 0.15 | 0.15 |
| | 2-Ethylhexanol (g-3) | mass % | 0.01 | 0.01 | 0.01 | 0.01 | 0.01 | 0.01 | 0.01 | 0.01 | 0.01 | 0.01 |
| | Emulgen 109P (g-4) | mass % | 0 | 0 | 0 | 0 | 0 | 0 | 0 | 0 | 0 | 0 |
| Stabilizing | Stabilizing component in | mass % | 0.22 | 0.22 | 0.29 | 0.2 | 0.22 | 0.22 | 0.22 | 0.22 | 0.22 | 0.22 |
| component | composition | | | | | | | | | | | |
| | Proportion of phosphorus- | mass % | 22.7 | 22.7 | 41.4 | 15.0 | 22.7 | 22.7 | 22.7 | 22.7 | 22.7 | 22.7 |
| | based compound (B) in | | | | | | | | | | | |
| | stabilizing components | | | | | | | | | | | |
| | Proportion of phenol-based | mass % | 22.7 | 22.7 | 17.2 | 25.0 | 22.7 | 22.7 | 22.7 | 22.7 | 22.7 | 22.7 |
| | antioxidant (C1) in | | | | | | | | | | | |
| | stabilizing components | | | | | | | | | | | |
| | Proportion of phosphorus- | mass % | 45.5 | 45.5 | 34.5 | 50.0 | 45.5 | 45.5 | 45.5 | 45.5 | 45.5 | 45.5 |
| | based antioxidant (C2) in | | | | | | | | | | | |
| | stabilizing | | | | | | | | | | | |
| | Proportion of antioxidant | mass % | 68.2 | 68.2 | 51.7 | 75.0 | 68.2 | 68.2 | 68.2 | 68.2 | 68.2 | 68.2 |
| | (C) in stabilizing | | | | | | | | | | | |
| | components | | | | | | | | | | | |
| | Phenolic antioxidant | | 1.0 | 1.0 | 0.4 | 1.7 | 1.0 | 1.0 | 1.0 | 1.0 | 1.0 | 1.0 |
| | (C1)/Phosphorus-based | | | | | | | | | | | |
| | compound (B) | | | | | | | | | | | |
| | Phosphorus-based antioxidant | | 2.0 | 2.0 | 0.8 | 3.3 | 2.0 | 2.0 | 2.0 | 2.0 | 2.0 | 2.0 |
| | (C2)/Phosphorus-based | | | | | | | | | | | |
| | compound (B) | | | | | | | | | | | |
| Properties of | Vicat softening temperature | ° C. | 122 | 122 | 122 | 122 | 122 | 122 | 122 | 117 | 118 | 125 |
| composition | Deflection temperature | ° C. | 99 | 99 | 99 | 99 | 99 | 99 | 99 | 94 | 95 | 104 |
| | under load | | | | | | | | | | | |
| | Heat resistance | | A | A | A | A | A | A | A | B | B | A |
| | Density | g/cm³ | 1.08 | 1.08 | 1.08 | 1.08 | 1.08 | 1.08 | 1.08 | 1.07 | 1.07 | 1.09 |
| | Total light transmittance of | % | 91 | 91 | 90 | 91 | 91 | 90 | 91 | 91 | 91 | 91 |
| | 2 mm-thick plate | | | | | | | | | | | |
| | YI value at optical path | | 20 | 13 | 16 | 18 | 19 | 20 | 19 | 19 | 18 | 17 |
| | length of 300 mm | | | | | | | | | | | |
| | Lightness (L*) at optical path | | 91 | 92 | 88 | 92 | 90 | 89 | 90 | 90 | 90 | 91 |
| | length of 300 mm | | | | | | | | | | | |
| | ΔYI (light resistance) | | 11 | 11 | 11 | 11 | 11 | 12 | 12 | 15 | 14 | 11 |
| | ΔYI (long-term thermal | | 12 | 12 | 12 | 14 | 15 | 16 | 15 | 16 | 15 | 11 |
| | stability) | | | | | | | | | | | |
| | Moist heat resistance | | 0.5 | 0.5 | 0.6 | 0.5 | 0.6 | 0.7 | 0.5 | 0.4 | 0.5 | 0.6 |
| | (ΔHz) | | | | | | | | | | | |
| | Moist heat resistance | ° C. | 4 | 4 | 4 | 4 | 4 | 4 | 4 | 3 | 4 | 5 |
| | (ΔVicat) | | | | | | | | | | | |
| | Moldability (fluidity) | MPa | 35 | 35 | 35 | 35 | 35 | 35 | 35 | 30 | 35 | 40 |
| | Moldability (mold | | A | A | A | A | A | A | A | A | A | B |
| | releaseability) | | | | | | | | | | | |

TABLE 11-2

| | | | Example | Example | Example | Example | Example |
|---|---|---|---|---|---|---|---|
| Table 11-2 | | | 11 | 12 | 13 | 14 | 15 |
| Transparent thermoplastic resin composition | | | (11) | (12) | (13) | (14) | (15) |
| Type of | Styrene-unsaturated carboxylic | | ps6 | ps1 | ps1 | ps1 | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-1 | — | c1-1 | — | c1-3 |
| | Phosphorus-based antioxidant (C2) | | c2-1 | — | — | c2-1 | c2-1 |
| | UV absorber (D) | | d-4 | d-4 | d-4 | d-4 | d-4 |
| | Light stabilizer (E) | | — | — | — | — | — |
| | Mold release agent (F) | | f-3 | f-3 | f-3 | f-3 | f-3 |
| | Resin containing rubbery polymer (H) | | — | — | — | — | — |
| Formulation | Styrene-unsaturated carboxylic | mass % | 100 | 100 | 100 | 100 | 100 |
| | acid-based resin (A1) | | | | | | |
| | Aromatic polycarbonate (A2) | mass % | — | — | — | — | — |
| | (Meth)Acrylic Resin (A3) | mass % | — | — | — | — | — |
| | Phosphorus-based compound (B) | mass % | 0.05 | 0.05 | 0.05 | 0.05 | 0.05 |
| | Phenolic antioxidant (C1) | mass % | 0.05 | — | 0.05 | — | 0.05 |
| | Phosphorus-based antioxidant (C2) | mass % | 0.1 | — | — | 0.1 | 0.1 |
| | UV absorber (D) | mass % | 0.02 | 0.02 | 0.02 | 0.02 | 0.02 |
| | Light stabilizer (E) | mass % | — | — | — | — | — |
| | Mold release agent (F) | mass % | 0.01 | 0.01 | 0.01 | 0.01 | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0.2 | 0.2 | 0.2 | 0.2 |
| | Fine oxocholic 180 (g-2) | mass % | 0.15 | 0.15 | 0.15 | 0.15 | 0.15 |
| | 2-Ethylhexanol (g-3) | mass % | 0.01 | 0.01 | 0.01 | 0.01 | 0.01 |
| | Emulgen 109P (g-4) | mass % | 0 | 0 | 0 | 0 | 0 |
| Stabilizing | Stabilizing component in composition | mass % | 0.22 | 0.07 | 0.12 | 0.17 | 0.22 |
| component | Proportion of phosphorus-based compound | mass % | 22.7 | 71.4 | 41.7 | 29.4 | 22.7 |
| | (B) in stabilizing components | | | | | | |
| | Proportion of phenol-based antioxidant | mass % | 22.7 | — | 41.7 | — | 22.7 |
| | (C1) in stabilizing components | | | | | | |
| | Proportion of phosphorus-based antioxidant | mass % | 45.5 | — | — | 58.8 | 45.5 |
| | (C2) in stabilizing components | | | | | | |
| | Proportion of antioxidant | mass % | 68.2 | — | 41.7 | 58.8 | 68.2 |
| | (C) in stabilizing components | | | | | | |
| | Phenolic antioxidant | | 1.0 | — | 1.0 | — | 1.0 |
| | (C1)/Phosphorus-based compound (B) | | | | | | |
| | Phosphorus-based antioxidant | | 2.0 | — | — | 2.0 | 2.0 |
| | (C2)/Phosphorus-based compound (B) | | | | | | |
| Properties of | Vicat softening temperature | ° C. | 120 | 122 | 122 | 122 | 122 |
| composition | Deflection temperature under load | ° C. | 97 | 99 | 99 | 99 | 99 |
| | Heat resistance | | A | A | A | A | A |
| | Density | g/cm³ | 1.09 | 1.08 | 1.08 | 1.08 | 1.08 |
| | Total light transmittance of | % | 91 | 91 | 91 | 91 | 91 |
| | 2 mm-thick plate | | | | | | |
| | YI value at optical path | | 13 | 21 | 20 | 22 | 17 |
| | length of 300 mm | | | | | | |
| | Lightness (L*) at optical path | | 92 | 91 | 89 | 90 | 91 |
| | length of 300 mm | | | | | | |
| | ΔYI (light resistance) | | 10 | 14 | 13 | 15 | 12 |
| | ΔYI (long-term thermal stability) | | 10 | 23 | 19 | 23 | 14 |
| | Moist heat resistance (ΔHz) | | 0.4 | 0.5 | 0.5 | 0.5 | 0.5 |
| | Moist heat resistance (ΔVicat) | ° C. | 6 | 4 | 4 | 4 | 4 |
| | Moldability (fluidity) | MPa | 40 | 35 | 35 | 35 | 35 |
| | Moldability (mold releaseability) | | B | A | A | A | A |
| | | | Example | Example | Example | Example | Example |
| Table 11-2 | | | 16 | 17 | 18 | 19 | 20 |
| Transparent thermoplastic resin composition | | | (16) | (17) | (18) | (19) | (20) |
| Type of | Styrene-unsaturated carboxylic | | ps1 | ps1 | ps1 | ps1 | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-5 | c1-6 | c1-1 | c1-1 | c1-1 |
| | Phosphorus-based antioxidant (C2) | | c2-1 | c2-1 | c2-2 | c2-1 | c2-1 |
| | UV absorber (D) | | d-4 | d-4 | d-4 | d-3 | d-5 |
| | Light stabilizer (E) | | — | — | — | — | — |
| | Mold release agent (F) | | f-3 | f-3 | f-3 | f-3 | f-3 |
| | Resin containing rubbery polymer (H) | | — | — | — | — | — |
| Formulation | Styrene-unsaturated carboxylic | mass % | 100 | 100 | 100 | 100 | 100 |
| | acid-based resin (A1) | | | | | | |
| | Aromatic polycarbonate (A2) | mass % | — | — | — | — | — |
| | (Meth)Acrylic Resin (A3) | mass % | — | — | — | — | — |
| | Phosphorus-based compound (B) | mass % | 0.05 | 0.05 | 0.05 | 0.05 | 0.05 |
| | Phenolic antioxidant (C1) | mass % | 0.05 | 0.05 | 0.05 | 0.05 | 0.05 |
| | Phosphorus-based antioxidant (C2) | mass % | 0.1 | 0.1 | 0.1 | 0.1 | 0.1 |
| | UV absorber (D) | mass % | 0.02 | 0.02 | 0.02 | 0.02 | 0.02 |
| | Light stabilizer (E) | mass % | — | — | — | — | — |
| | Mold release agent (F) | mass % | 0.01 | 0.01 | 0.01 | 0.01 | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0.2 | 0.2 | 0.2 | 0.2 |
| | Fine oxocholic 180 (g-2) | mass % | 0.15 | 0.15 | 0.15 | 0.15 | 0.15 |
| | 2-Ethylhexanol (g-3) | mass % | 0.01 | 0.01 | 0.01 | 0.01 | 0.01 |
| | Emulgen 109P (g-4) | mass % | 0 | 0 | 0 | 0 | 0 |
| Stabilizing | Stabilizing component in composition | mass % | 0.22 | 0.22 | 0.22 | 0.22 | 0.22 |
| component | Proportion of phosphorus-based compound | mass % | 22.7 | 22.7 | 22.7 | 22.7 | 22.7 |
| | (B) in stabilizing components | | | | | | |
| | Proportion of phenol-based antioxidant | mass % | 22.7 | 22.7 | 22.7 | 22.7 | 22.7 |
| | (C1) in stabilizing components | | | | | | |
| | Proportion of phosphorus-based antioxidant | mass % | 45.5 | 45.5 | 45.5 | 45.5 | 45.5 |
| | (C2) in stabilizing components | | | | | | |
| | Proportion of antioxidant | mass % | 68.2 | 68.2 | 68.2 | 68.2 | 68.2 |
| | (C) in stabilizing components | | | | | | |
| | Phenolic antioxidant | | 1.0 | 1.0 | 1.0 | 1.0 | 1.0 |
| | (C1)/Phosphorus-based compound (B) | | | | | | |
| | Phosphorus-based antioxidant | | 2.0 | 2.0 | 2.0 | 2.0 | 2.0 |
| | (C2)/Phosphorus-based compound (B) | | | | | | |
| Properties of | Vicat softening temperature | ° C. | 122 | 122 | 122 | 122 | 122 |
| composition | Deflection temperature under load | ° C. | 99 | 99 | 99 | 99 | 99 |
| | Heat resistance | | A | A | A | A | A |
| | Density | g/cm³ | 1.08 | 1.08 | 1.08 | 1.08 | 1.08 |
| | Total light transmittance of | % | 91 | 91 | 91 | 90 | 91 |
| | 2 mm-thick plate | | | | | | |
| | YI value at optical path | | 18 | 18 | 19 | 18 | 15 |
| | length of 300 mm | | | | | | |
| | Lightness (L*) at optical path | | 91 | 91 | 90 | 89 | 91 |
| | length of 300 mm | | | | | | |
| | ΔYI (light resistance) | | 12 | 12 | 16 | 15 | 11 |
| | ΔYI (long-term thermal stability) | | 15 | 15 | 23 | 11 | 11 |
| | Moist heat resistance (ΔHz) | | 0.5 | 0.5 | 0.5 | 0.5 | 0.5 |
| | Moist heat resistance (ΔVicat) | ° C. | 4 | 4 | 4 | 4 | 4 |
| | Moldability (fluidity) | MPa | 35 | 35 | 35 | 35 | 35 |
| | Moldability (mold releaseability) | | A | A | A | A | A |

TABLE 12-1

| | | | Example | Example | Example | Example | Example |
|---|---|---|---|---|---|---|---|
| Table 12-1 | | | 21 | 22 | 23 | 24 | 25 |
| Transparent thermoplastic resin composition | | | (21) | (22) | (23) | (24) | (25) |
| Type of | Styrene-unsaturated carboxylic | | ps1 | ps1 | ps1 | ps1 | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-1 | c1-1 | c1-1 | c1-1 | c1-1 |
| | Phosphorus-based antioxidant (C2) | | c2-1 | c2-1 | c2-1 | c2-1 | c2-1 |
| | UV absorber (D) | | d-6 | — | d-4 | d-4 | d-4 |
| | Light stabilizer (E) | | — | — | e-1 | e-2 | — |
| | Mold release agent (F) | | f-3 | f-3 | f-3 | f-3 | — |
| | Resin containing rubbery polymer (H) | | — | — | — | — | — |
| Formulation | Styrene-unsaturated carboxylic | mass % | 100 | 100 | 100 | 100 | 100 |
| | acid-based resin (A1) | | | | | | |
| | Aromatic polycarbonate (A2) | mass % | — | — | — | — | — |
| | (Meth)Acrylic Resin (A3) | mass % | — | — | — | — | — |
| | Phosphorus-based compound (B) | mass % | 0.05 | 0.05 | 0.05 | 0.05 | 0.05 |
| | Phenolic antioxidant (C1) | mass % | 0.05 | 0.05 | 0.05 | 0.05 | 0.05 |
| | Phosphorus-based antioxidant (C2) | mass % | 0.1 | 0.1 | 0.1 | 0.1 | 0.1 |
| | UV absorber (D) | mass % | 0.02 | — | 0.02 | 0.02 | 0.02 |
| | Light stabilizer (E) | mass % | — | — | 0.05 | 0.05 | — |
| | Mold release agent (F) | mass % | 0.01 | 0.01 | 0.01 | 0.01 | — |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0.2 | 0.2 | 0.2 | 0.2 |
| | Fine oxocholic 180 (g-2) | mass % | 0.15 | 0.15 | 0.15 | 0.15 | 0.15 |
| | 2-Ethylhexanol (g-3) | mass % | 0.01 | 0.01 | 0.01 | 0.01 | 0.01 |
| | Emulgen 109P (g-4) | mass % | 0 | 0 | 0 | 0 | 0 |
| Stabilizing | Stabilizing component in composition | mass % | 0.22 | 0.20 | 0.27 | 0.27 | 0.22 |
| component | Proportion of phosphorus-based compound | mass % | 22.7 | 25.0 | 18.5 | 18.5 | 22.7 |
| | (B) in stabilizing components | | | | | | |
| | Proportion of phenol-based antioxidant | mass % | 22.7 | 25.0 | 18.5 | 18.5 | 22.7 |
| | (C1) in stabilizing components | | | | | | |
| | Proportion of phosphorus-based | mass % | 45.5 | 50.0 | 37.0 | 37.0 | 45.5 |
| | antioxidant (C2) in stabilizing components | | | | | | |
| | Proportion of antioxidant | mass % | 68.2 | 75.0 | 55.6 | 55.6 | 68.2 |
| | (C) in stabilizing components | | | | | | |
| | Phenolic antioxidant (C1)/Phosphorus-based | | 1.0 | 1.0 | 1.0 | 1.0 | 1.0 |
| | compound (B) | | | | | | |
| | Phosphorus-based antioxidant | | 2.0 | 2.0 | 2.0 | 2.0 | 2.0 |
| | (C2)/Phosphorus-based compound (B) | | | | | | |
| Properties of | Vicat softening temperature | ° C. | 122 | 122 | 122 | 122 | 122 |
| composition | Deflection temperature under load | ° C. | 99 | 99 | 99 | 99 | 99 |
| | Heat resistance | | A | A | A | A | A |
| | Density | g/cm³ | 1.08 | 1.08 | 1.08 | 1.08 | 1.08 |
| | Total light transmittance of | % | 91 | 91 | 91 | 90 | 91 |
| | 2 mm-thick plate | | | | | | |
| | YI value at optical path | | 18 | 13 | 20 | 24 | 14 |
| | length of 300 mm | | | | | | |
| | Lightness (L*) at optical path | | 90 | 92 | 90 | 89 | 92 |
| | length of 300 mm | | | | | | |
| | ΔYI (light resistance) | | 15 | 25 | 8 | 11 | 10 |
| | ΔYI (long-term thermal stability) | | 11 | 11 | 13 | 15 | 11 |
| | Moist heat resistance (ΔHz) | | 0.5 | 0.5 | 0.5 | 0.5 | 0.5 |
| | Moist heat resistance (ΔVicat) | ° C. | 4 | 4 | 4 | 4 | 4 |
| | Moldability (fluidity) | MPa | 35 | 35 | 35 | 35 | 35 |
| | Moldability (mold releaseability) | | A | A | A | A | A |
| | | | Example | Example | Example | Example | Example |
| Table 12-1 | | | 26 | 27 | 28 | 29 | 30 |
| Transparent thermoplastic resin composition | | | (26) | (27) | (28) | (29) | (30) |
| Type of | Styrene-unsaturated carboxylic | | ps1 | ps1 | ps1 | ps1 | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-1 | c1-1 | c1-1 | c1-1 | c1-1 |
| | Phosphorus-based antioxidant (C2) | | c2-1 | c2-1 | c2-1 | c2-1 | c2-1 |
| | UV absorber (D) | | d-4 | d-4 | d-4 | d-4 | d-4 |
| | Light stabilizer (E) | | — | — | — | — | — |
| | Mold release agent (F) | | f-2 | — | f-3 | f-3 | f-3 |
| | Resin containing rubbery polymer (H) | | — | — | — | — | — |
| Formulation | Styrene-unsaturated carboxylic | mass % | 100 | 100 | 100 | 100 | 100 |
| | acid-based resin (A1) | | | | | | |
| | Aromatic polycarbonate (A2) | mass % | — | — | — | — | — |
| | (Meth)Acrylic Resin (A3) | mass % | — | — | — | — | — |
| | Phosphorus-based compound (B) | mass % | 0.05 | 0.05 | 0.05 | 0.05 | 0.05 |
| | Phenolic antioxidant (C1) | mass % | 0.05 | 0.05 | 0.05 | 0.05 | 0.05 |
| | Phosphorus-based antioxidant (C2) | mass % | 0.1 | 0.1 | 0.1 | 0.1 | 0.1 |
| | UV absorber (D) | mass % | 0.02 | 0.02 | 0.02 | 0.02 | 0.02 |
| | Light stabilizer (E) | mass % | — | — | — | — | — |
| | Mold release agent (F) | mass % | 0.2 | — | 0.01 | 0.01 | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0 | 0.2 | 0 | 0.5 |
| | Fine oxocholic 180 (g-2) | mass % | 0.15 | 0 | 0 | 0 | 0.15 |
| | 2-Ethylhexanol (g-3) | mass % | 0.01 | 0 | 0 | 0 | 0.01 |
| | Emulgen 109P (g-4) | mass % | 0 | 0 | 0 | 0.2 | 0 |
| Stabilizing | Stabilizing component in composition | mass % | 0.22 | 0.22 | 0.22 | 0.22 | 0.22 |
| component | Proportion of phosphorus-based compound | mass % | 22.7 | 22.7 | 22.7 | 22.7 | 22.7 |
| | (B) in stabilizing components | | | | | | |
| | Proportion of phenol-based antioxidant | mass % | 22.7 | 22.7 | 22.7 | 22.7 | 22.7 |
| | (C1) in stabilizing components | | | | | | |
| | Proportion of phosphorus-based | mass % | 45.5 | 45.5 | 45.5 | 45.5 | 45.5 |
| | antioxidant (C2) in stabilizing components | | | | | | |
| | Proportion of antioxidant | mass % | 68.2 | 68.2 | 68.2 | 68.2 | 68.2 |
| | (C) in stabilizing components | | | | | | |
| | Phenolic antioxidant (C1)/Phosphorus-based | | 1.0 | 1.0 | 1.0 | 1.0 | 1.0 |
| | compound (B) | | | | | | |
| | Phosphorus-based antioxidant | | 2.0 | 2.0 | 2.0 | 2.0 | 2.0 |
| | (C2)/Phosphorus-based compound (B) | | | | | | |
| Properties of | Vicat softening temperature | ° C. | 122 | 123 | 122 | 122 | 120 |
| composition | Deflection temperature under load | ° C. | 99 | 99 | 99 | 99 | 98 |
| | Heat resistance | | A | A | A | A | A |
| | Density | g/cm³ | 1.08 | 1.08 | 1.08 | 1.08 | 1.08 |
| | Total light transmittance of | % | 91 | 91 | 91 | 90 | 91 |
| | 2 mm-thick plate | | | | | | |
| | YI value at optical path | | 13 | 15 | 14 | 17 | 13 |
| | length of 300 mm | | | | | | |
| | Lightness (L*) at optical path | | 92 | 92 | 92 | 88 | 92 |
| | length of 300 mm | | | | | | |
| | ΔYI (light resistance) | | 10 | 10 | 10 | 10 | 10 |
| | ΔYI (long-term thermal stability) | | 11 | 11 | 11 | 11 | 11 |
| | Moist heat resistance (ΔHz) | | 0.5 | 0.5 | 0.5 | 0.5 | 0.5 |
| | Moist heat resistance (ΔVicat) | ° C. | 4 | 3 | 4 | 6 | 4 |
| | Moldability (fluidity) | MPa | 35 | 40 | 35 | 35 | 35 |
| | Moldability (mold releaseability) | | A | C | B | B | A |

TABLE 12-2

| | | | Example | Example | Example | Example | Example |
|---|---|---|---|---|---|---|---|
| Table 12-2 | | | 31 | 32 | 33 | 34 | 35 |
| Transparent thermoplastic resin composition | | | (31) | (32) | (33) | (34) | (35) |
| Type of | Styrene-unsaturated carboxylic | | ps1 | — | — | — | — |
| each raw | acid-based resin (A1) | | | | | | |
| material | Aromatic polycarbonate (A2) | | — | — | — | — | pc-1 |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-1 | c1-1 | c1-1 | c1-1 | — |
| | Phosphorus-based antioxidant (C2) | | c2-1 | c2-1 | c2-1 | c2-1 | — |
| | UV absorber (D) | | d-4 | d-4 | d-4 | d-4 | — |
| | Light stabilizer (E) | | — | — | — | — | — |
| | Mold release agent (F) | | — | f-3 | f-3 | f-3 | — |
| | Resin containing rubbery polymer (H) | | — | h-8 | h-9 | h-10 | — |
| Formulation | Styrene-unsaturated carboxylic | mass % | 100 | — | — | — | — |
| | acid-based resin (A1) | | | | | | |
| | Aromatic polycarbonate (A2) | mass % | — | — | — | — | 100 |
| | (Meth)Acrylic Resin (A3) | mass % | — | — | — | — | — |
| | Phosphorus-based compound (B) | mass % | 0.05 | 0.05 | 0.05 | 0.05 | 0.05 |
| | Phenolic antioxidant (C1) | mass % | 0.05 | 0.05 | 0.05 | 0.05 | — |
| | Phosphorus-based antioxidant (C2) | mass % | 0.1 | 0.1 | 0.1 | 0.1 | — |
| | UV absorber (D) | mass % | 0.02 | 0.02 | 0.02 | 0.02 | — |
| | Light stabilizer (E) | mass % | — | — | — | — | — |
| | Mold release agent (F) | mass % | — | 0.01 | 0.01 | 0.01 | — |
| | Resin containing rubbery polymer (H) | mass % | — | 100 | 100 | 100 | — |
| | Rubbery polymer (H) | mass % | — | 0.8 | 0.4 | 0.1 | — |
| | Stearyl alcohol (g-1) | mass % | 0.09 | 0.2 | 0.2 | 0.2 | 0 |
| | Fine oxocholic 180 (g-2) | mass % | 0 | 0.15 | 0.15 | 0.15 | 0 |
| | 2-Ethylhexanol (g-3) | mass % | 0 | 0.01 | 0.01 | 0.01 | 0 |
| | Emulgen 109P (g-4) | mass % | 0 | 0 | 0 | 0 | 0 |
| Stabilizing | Stabilizing component in composition | mass % | 0.22 | 0.22 | 0.22 | 0.22 | 0.05 |
| component | Proportion of phosphorus-based compound | mass % | 22.7 | 22.7 | 22.7 | 22.7 | 100 |
| | (B) in stabilizing components | | | | | | |
| | Proportion of phenol-based antioxidant | mass % | 22.7 | 22.7 | 22.7 | 22.7 | — |
| | (C1) in stabilizing components | | | | | | |
| | Proportion of phosphorus-based | mass % | 45.5 | 45.5 | 45.5 | 45.5 | — |
| | antioxidant (C2) in stabilizing components | | | | | | |
| | Proportion of antioxidant | mass % | 68.2 | 68.2 | 68.2 | 68.2 | — |
| | (C) in stabilizing components | | | | | | |
| | Phenolic antioxidant (C1)/Phosphorus-based | | 1.0 | 1.0 | 1.0 | 1.0 | — |
| | compound (B) | | | | | | |
| | Phosphorus-based antioxidant | | 2.0 | 2.0 | 2.0 | 2.0 | — |
| | (C2)/Phosphorus-based compound (B) | | | | | | |
| Properties of | Vicat softening temperature | ° C. | 120 | 120 | 121 | 121 | 143 |
| composition | Deflection temperature under load | ° C. | 98 | 97 | 98 | 98 | 122 |
| | Heat resistance | | A | A | A | A | A |
| | Density | g/cm³ | 1.08 | 1.08 | 1.08 | 1.08 | 1.20 |
| | Total light transmittance | % | 91 | 86 | 87 | 89 | 91 |
| | of 2 mm-thick plate | | | | | | |
| | YI value at optical | | 15 | 29 | 25 | 22 | 15 |
| | path length of 300 mm | | | | | | |
| | Lightness (L*) at optical | | 92 | 63 | 66 | 74 | 91 |
| | path length of 300 mm | | | | | | |
| | ΔYI (light resistance) | | 10 | 26 | 23 | 20 | 24 |
| | ΔYI (long-term thermal stability) | | 11 | 32 | 29 | 26 | 13 |
| | Moist heat resistance (ΔHz) | | 0.5 | 0.9 | 0.8 | 0.7 | 15 |
| | Moist heat resistance (ΔVicat) | ° C. | 3 | 4 | 4 | 4 | 23 |
| | Moldability (fluidity) | MPa | 40 | 35 | 35 | 35 | 70 |
| | Moldability (mold releaseability) | | C | A | A | A | B |
| | | | Example | Example | Example | Example | Example |
| Table 12-2 | | | 36 | 37 | 38 | 39 | 40 |
| Transparent thermoplastic resin composition | | | (36) | (37) | (38) | (39) | (40) |
| Type of | Styrene-unsaturated carboxylic | | — | — | — | — | — |
| each raw | acid-based resin (A1) | | | | | | |
| material | Aromatic polycarbonate (A2) | | pc-3 | pc-2 | pc-1 | pc-1 | — |
| | (Meth)Acrylic Resin (A3) | | — | — | — | — | pm-1 |
| | Phosphorus-based compound (B) | | b-1 | b-1 | b-1 | b-1 | b-1 |
| | Phenolic antioxidant (C1) | | — | — | c1-1 | c1-1 | — |
| | Phosphorus-based antioxidant (C2) | | — | — | c2-1 | c2-1 | — |
| | UV absorber (D) | | — | — | — | d-4 | — |
| | Light stabilizer (E) | | — | — | — | — | — |
| | Mold release agent (F) | | — | — | — | — | f-3 |
| | Resin containing rubbery polymer (H) | | — | — | — | — | — |
| Formulation | Styrene-unsaturated carboxylic | mass % | — | — | — | — | — |
| | acid-based resin (A1) | | | | | | |
| | Aromatic polycarbonate (A2) | mass % | 100 | 100 | 100 | 100 | — |
| | (Meth)Acrylic Resin (A3) | mass % | — | — | — | — | 100 |
| | Phosphorus-based compound (B) | mass % | 0.05 | 0.05 | 0.05 | 0.05 | 0.05 |
| | Phenolic antioxidant (C1) | mass % | — | — | 0.05 | 0.05 | — |
| | Phosphorus-based antioxidant (C2) | mass % | — | — | 0.1 | 0.1 | — |
| | UV absorber (D) | mass % | — | — | — | 0.02 | — |
| | Light stabilizer (E) | mass % | — | — | — | — | — |
| | Mold release agent (F) | mass % | — | — | — | — | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0 | 0 | 0 | 0 | 0.2 |
| | Fine oxocholic 180 (g-2) | mass % | 0 | 0 | 0 | 0 | 0 |
| | 2-Ethylhexanol (g-3) | mass % | 0 | 0 | 0 | 0 | 0 |
| | Emulgen 109P (g-4) | mass % | 0 | 0 | 0 | 0 | 0 |
| Stabilizing | Stabilizing component in composition | mass % | 0.05 | 0.05 | 0.2 | 0.22 | 0.05 |
| component | Proportion of phosphorus-based compound | mass % | 100 | 100 | 25.0 | 22.7 | 100 |
| | (B) in stabilizing components | | | | | | |
| | Proportion of phenol-based antioxidant | mass % | — | — | 25.0 | 22.7 | — |
| | (C1) in stabilizing components | | | | | | |
| | Proportion of phosphorus-based | mass % | — | — | 50.0 | 45.5 | — |
| | antioxidant (C2) in stabilizing components | | | | | | |
| | Proportion of antioxidant | mass % | — | — | 75.0 | 68.2 | — |
| | (C) in stabilizing components | | | | | | |
| | Phenolic antioxidant (C1)/Phosphorus-based | | — | — | 1.0 | 1.0 | — |
| | compound (B) | | | | | | |
| | Phosphorus-based antioxidant | | — | — | 2.0 | 2.0 | — |
| | (C2)/Phosphorus-based compound (B) | | | | | | |
| Properties of | Vicat softening temperature | ° C. | 144 | 144 | 143 | 143 | 106 |
| composition | Deflection temperature under load | ° C. | 123 | 123 | 123 | 123 | 85 |
| | Heat resistance | | A | A | A | A | C |
| | Density | g/cm³ | 1.20 | 1.20 | 1.2 | 1.2 | 1.19 |
| | Total light transmittance | % | 91 | 90 | 91 | 91 | 92 |
| | of 2 mm-thick plate | | | | | | |
| | YI value at optical | | 17 | 24 | 15 | 15 | 7 |
| | path length of 300 mm | | | | | | |
| | Lightness (L*) at optical | | 92 | 89 | 91 | 91 | 93 |
| | path length of 300 mm | | | | | | |
| | ΔYI (light resistance) | | 25 | 28 | 22 | 13 | 5 |
| | ΔYI (long-term thermal stability) | | 14 | 19 | 12 | 12 | 3 |
| | Moist heat resistance (ΔHz) | | 18 | 24 | 15 | 15 | 0.3 |
| | Moist heat resistance (ΔVicat) | ° C. | 24 | 28 | 23 | 23 | 11 |
| | Moldability (fluidity) | MPa | 80 | 85 | 65 | 65 | 55 |
| | Moldability (mold releaseability) | | B | B | B | B | B |

TABLE 13-1

| | | | Example | Example | Example | Example | Example |
|---|---|---|---|---|---|---|---|
| Table 13-1 | | | 41 | 42 | 43 | 44 | 45 |
| Transparent thermoplastic resin composition | | | (41) | (42) | (43) | (44) | (45) |
| Type of | Styrene-unsaturated carboxylic | | — | — | — | — | ps1 |
| each raw | acid-based resin (A1) | | | | | | |
| material | Aromatic polycarbonate (A2) | | — | — | — | — | — |
| | (Meth)Acrylic Resin (A3) | | pm-2 | pm-3 | pm-1 | pm-1 | — |
| | Phosphorus-based compound (B) | | b-1 | b-1 | b-1 | b-1 | b-1 |
| | Phenolic antioxidant (C1) | | — | — | — | c1-1 | c1-1 |
| | Phosphorus-based antioxidant (C2) | | — | — | — | c2-1 | c2-1 |
| | UV absorber (D) | | — | — | — | d-4 | d-4 |
| | Light stabilizer (E) | | — | — | — | — | — |
| | Mold release agent (F) | | f-3 | f-3 | — | f-3 | f-3 |
| | Resin containing rubbery polymer (H) | | — | — | — | — | — |
| Formulation | Styrene-unsaturated carboxylic | mass % | — | — | — | — | 100 |
| | acid-based resin (A1) | | | | | | |
| | Aromatic polycarbonate (A2) | mass % | — | — | — | — | — |
| | (Meth)Acrylic Resin (A3) | mass % | 100 | 100 | 100 | 100 | — |
| | Phosphorus-based compound (B) | mass % | 0.05 | 0.05 | 0.05 | 0.05 | 0.05 |
| | Phenolic antioxidant (C1) | mass % | — | — | — | 0.05 | 0.15 |
| | Phosphorus-based antioxidant (C2) | mass % | — | — | — | 0.1 | 0.3 |
| | UV absorber (D) | mass % | — | — | — | 0.02 | 0.02 |
| | Light stabilizer (E) | mass % | — | — | — | — | — |
| | Mold release agent (F) | mass % | 0.01 | 0.01 | — | 0.01 | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0 | 0 | 0.2 | 0.2 |
| | Fine oxocholic 180 (g-2) | mass % | 0 | 0 | 0 | 0 | 0.15 |
| | 2-Ethylhexanol (g-3) | mass % | 0 | 0 | 0 | 0 | 0.01 |
| | Emulgen 109P (g-4) | mass % | 0 | 0 | 0 | 0 | 0 |
| Stabilizing | Stabilizing component in composition | mass % | 0.05 | 0.05 | 0.05 | 0.22 | 0.52 |
| component | Proportion of phosphorus-based | mass % | 100 | 100 | 100 | 22.7 | 9.6 |
| | compound (B) in stabilizing components | | | | | | |
| | Proportion of phenol-based antioxidant | mass % | — | — | — | 22.7 | 28.8 |
| | (C1) in stabilizing components | | | | | | |
| | Proportion of phosphorus-based | mass % | — | — | — | 45.5 | 57.7 |
| | antioxidant (C2) in stabilizing | | | | | | |
| | Proportion of antioxidant | mass % | — | — | — | 68.2 | 86.5 |
| | (C) in stabilizing components | | | | | | |
| | Phenolic antioxidant (C1)/Phosphorus-based | | — | — | — | 1.0 | 3.0 |
| | compound (B) | | | | | | |
| | Phosphorus-based antioxidant | | — | — | — | 2.0 | 6.0 |
| | (C2)/Phosphorus-based compound (B) | | | | | | |
| Properties of | Vicat softening temperature | ° C. | 105 | 114 | 105 | 106 | 121 |
| composition | Deflection temperature under load | ° C. | 84 | 91 | 85 | 85 | 99 |
| | Heat resistance | | C | C | C | C | A |
| | Density | g/cm³ | 1.19 | 1.19 | 1.19 | 1.19 | 1.08 |
| | Total light transmittance of | % | 92 | 91 | 92 | 92 | 91 |
| | 2 mm-thick plate | | | | | | |
| | YI value at optical | | 7 | 17 | 7 | 7 | 15 |
| | path length of 300 mm | | | | | | |
| | Lightness (L*) at optical | | 93 | 90 | 93 | 93 | 92 |
| | path length of 300 mm | | | | | | |
| | ΔYI (light resistance) | | 5 | 7 | 5 | 5 | 15 |
| | ΔYI (long-term thermal stability) | | 3 | 6 | 3 | 3 | 16 |
| | Moist heat resistance (ΔHz) | | 0.2 | 0.3 | 0.3 | 0.3 | 0.8 |
| | Moist heat resistance (ΔVicat) | ° C. | 10 | 15 | 10 | 11 | 4 |
| | Moldability (fluidity) | MPa | 65 | 65 | 60 | 55 | 35 |
| | Moldability (mold releaseability) | | B | C | C | B | A |
| | | | Example | Example | Example | Example | Example |
| Table 13-1 | | | 46 | 47 | 48 | 49 | 50 |
| Transparent thermoplastic resin composition | | | (46) | (47) | (48) | (49) | (50) |
| Type of | Styrene-unsaturated carboxylic | | ps1 | ps1 | ps1 | ps1 | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-1 | c1-1 | c1-1 | c1-1 | c1-1 |
| | Phosphorus-based antioxidant (C2) | | c2-1 | c2-1 | c2-1 | c2-1 | c2-1 |
| | UV absorber (D) | | d-4 | d-4 | d-4 | d-4 | d-4 |
| | Light stabilizer (E) | | — | — | — | — | — |
| | Mold release agent (F) | | f-3 | f-3 | f-3 | f-3 | f-3 |
| | Resin containing rubbery polymer (H) | | — | — | — | — | — |
| Formulation | Styrene-unsaturated carboxylic | mass % | 100 | 100 | 100 | 100 | 100 |
| | acid-based resin (A1) | | | | | | |
| | Aromatic polycarbonate (A2) | mass % | — | — | — | — | — |
| | (Meth)Acrylic Resin (A3) | mass % | — | — | — | — | — |
| | Phosphorus-based compound (B) | mass % | 0.02 | 0.05 | 0.08 | 0.2 | 0.05 |
| | Phenolic antioxidant (C1) | mass % | 0.15 | 0.15 | 0.05 | 0.05 | 0.30 |
| | Phosphorus-based antioxidant (C2) | mass % | 0.25 | 0.15 | 0.05 | 0.05 | 0.15 |
| | UV absorber (D) | mass % | 0.02 | 0.02 | 0.02 | 0.02 | 0.02 |
| | Light stabilizer (E) | mass % | — | — | — | — | — |
| | Mold release agent (F) | mass % | 0.01 | 0.01 | 0.01 | 0.01 | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0.2 | 0.2 | 0.2 | 0.2 |
| | Fine oxocholic 180 (g-2) | mass % | 0.15 | 0.15 | 0.15 | 0.15 | 0.15 |
| | 2-Ethylhexanol (g-3) | mass % | 0.01 | 0.01 | 0.01 | 0.01 | 0.01 |
| | Emulgen 109P (g-4) | mass % | 0 | 0 | 0 | 0 | 0 |
| Stabilizing | Stabilizing component in composition | mass % | 0.44 | 0.37 | 0.2 | 0.32 | 0.52 |
| component | Proportion of phosphorus-based | mass % | 4.5 | 13.5 | 40.0 | 62.5 | 9.6 |
| | compound (B) in stabilizing components | | | | | | |
| | Proportion of phenol-based antioxidant | mass % | 34.1 | 40.5 | 25.0 | 15.6 | 57.7 |
| | (C1) in stabilizing components | | | | | | |
| | Proportion of phosphorus-based | mass % | 56.8 | 40.5 | 25.0 | 15.6 | 28.8 |
| | antioxidant (C2) in stabilizing | | | | | | |
| | Proportion of antioxidant | mass % | 90.9 | 81.1 | 50.0 | 31.3 | 86.5 |
| | (C) in stabilizing components | | | | | | |
| | Phenolic antioxidant (C1)/Phosphorus-based | | 7.5 | 3.0 | 0.6 | 0.3 | 6.0 |
| | compound (B) | | | | | | |
| | Phosphorus-based antioxidant | | 12.5 | 3.0 | 0.6 | 0.3 | 3.0 |
| | (C2)/Phosphorus-based compound (B) | | | | | | |
| Properties of | Vicat softening temperature | ° C. | 122 | 122 | 122 | 122 | 121 |
| composition | Deflection temperature under load | ° C. | 99 | 99 | 99 | 99 | 98 |
| | Heat resistance | | A | A | A | A | A |
| | Density | g/cm³ | 1.08 | 1.08 | 1.08 | 1.08 | 1.08 |
| | Total light transmittance of | % | 90 | 91 | 91 | 90 | 90 |
| | 2 mm-thick plate | | | | | | |
| | YI value at optical | | 22 | 17 | 21 | 19 | 24 |
| | path length of 300 mm | | | | | | |
| | Lightness (L*) at optical | | 89 | 91 | 91 | 88 | 89 |
| | path length of 300 mm | | | | | | |
| | ΔYI (light resistance) | | 17 | 15 | 14 | 14 | 18 |
| | ΔYI (long-term thermal stability) | | 20 | 16 | 22 | 15 | 25 |
| | Moist heat resistance (ΔHz) | | 0.5 | 0.5 | 0.5 | 0.6 | 0.5 |
| | Moist heat resistance (ΔVicat) | ° C. | 4 | 4 | 4 | 4 | 4 |
| | Moldability (fluidity) | MPa | 35 | 35 | 35 | 35 | 35 |
| | Moldability (mold releaseability) | | A | A | A | A | A |

TABLE 13-2

| | | | Example | Example | Example | Example | Example |
|---|---|---|---|---|---|---|---|
| Table 13-2 | | | 51 | 52 | 53 | 54 | 55 |
| Transparent thermoplastic resin composition | | | (51) | (52) | (53) | (54) | (55) |
| Type of | Styrene-unsaturated carboxylic | | ps1 | ps1 | ps1 | ps1 | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphorus-based compound (B) | | b-1 | b-1 | b-1 | b-1 | b-1 |
| | Phenolic antioxidant (C1) | | c1-1 | c1-1 | c1-7 | c1-8 | c1-9 |
| | Phosphorus-based antioxidant (C2) | | c2-1 | c2-1 | c2-1 | c2-1 | c2-1 |
| | UV absorber (D) | | d-4 | d-4 | d-4 | d-4 | d-4 |
| | Light stabilizer (E) | | — | — | — | — | — |
| | Mold release agent (F) | | f-3 | f-3 | f-3 | f-3 | f-3 |
| | Resin containing rubbery polymer (H) | | — | — | — | — | — |
| Formulation | Styrene-unsaturated carboxylic | mass % | 100 | 100 | 100 | 100 | 100 |
| | acid-based resin (A1) | | | | | | |
| | Aromatic polycarbonate (A2) | mass % | — | — | — | — | — |
| | (Meth)Acrylic Resin (A3) | mass % | — | — | — | — | — |
| | Phosphorus-based compound (B) | mass % | 0.05 | 0.08 | 0.05 | 0.05 | 0.05 |
| | Phenolic antioxidant (C1) | mass % | 0.015 | 0.05 | 0.05 | 0.05 | 0.05 |
| | Phosphorus-based antioxidant (C2) | mass % | 0.15 | 0.45 | 0.1 | 0.1 | 0.1 |
| | UV absorber (D) | mass % | 0.02 | 0.02 | 0.02 | 0.02 | 0.02 |
| | Light stabilizer (E) | mass % | — | — | — | — | — |
| | Mold release agent (F) | mass % | 0.01 | 0.01 | 0.01 | 0.01 | 0.01 |
| | Resin containing rubbery polymer (H) | mass % | — | — | — | — | — |
| | Rubbery polymer (H) | mass % | — | — | — | — | — |
| | Stearyl alcohol (g-1) | mass % | 0.2 | 0.2 | 0.2 | 0.2 | 0.2 |
| | Fine oxocholic 180 (g-2) | mass % | 0.15 | 0.15 | 0.15 | 0.15 | 0.15 |
| | 2-Ethylhexanol (g-3) | mass % | 0.01 | 0.01 | 0.01 | 0.01 | 0.01 |
| | Emulgen 109P (g-4) | mass % | 0 | 0 | 0 | 0 | 0 |
| Stabilizing | Stabilizing component in composition | mass % | 0.235 | 0.6 | 0.22 | 0.22 | 0.22 |
| component | Proportion of phosphorus-based compound | mass % | 21.3 | 13.3 | 22.7 | 22.7 | 22.7 |
| | (B) in stabilizing components | | | | | | |
| | Proportion of phenol-based antioxidant | mass % | 6.4 | 8.3 | 22.7 | 22.7 | 22.7 |
| | (C1) in stabilizing components | | | | | | |
| | Proportion of phosphorus-based | mass % | 63.8 | 75.0 | 45.5 | 45.5 | 45.5 |
| | antioxidant (C2) in stabilizing components | | | | | | |
| | Proportion of antioxidant | mass % | 70.2 | 83.3 | 68.2 | 68.2 | 68.2 |
| | (C) in stabilizing components | | | | | | |
| | Phenolic antioxidant (C1)/Phosphorus-based | | 0.3 | 0.6 | 1.0 | 1.0 | 1.0 |
| | compound (B) | | | | | | |
| | Phosphorus-based antioxidant | | 3.0 | 5.6 | 2.0 | 2.0 | 2.0 |
| | (C2)/Phosphorus-based compound (B) | | | | | | |
| Properties of | Vicat softening temperature | ° C. | 122 | 122 | 122 | 122 | 122 |
| composition | Deflection temperature under load | ° C. | 99 | 99 | 99 | 99 | 99 |
| | Heat resistance | | A | A | A | A | A |
| | Density | g/cm³ | 1.08 | 1.08 | 1.08 | 1.08 | 1.08 |
| | Total light transmittance of 2 mm-thick plate | % | 91 | 91 | 91 | 91 | 91 |
| | YI value at optical path length of 300 mm | | 19 | 15 | 13 | 13 | 13 |
| | Lightness (L*) at optical path length of 300 mm | | 90 | 91 | 92 | 92 | 92 |
| | ΔYI (light resistance) | | 19 | 19 | 12 | 12 | 13 |
| | ΔYI (long-term thermal stability) | | 23 | 24 | 13 | 14 | 13 |
| | Moist heat resistance (ΔHz) | | 0.5 | 0.5 | 0.6 | 0.6 | 0.6 |
| | Moist heat resistance (ΔVicat) | ° C. | 4 | 4 | 4 | 4 | 4 |
| | Moldability (fluidity) | MPa | 35 | 35 | 35 | 35 | 35 |
| | Moldability (mold releaseability) | | A | A | A | A | A |

| | | | Example | Example | Example | Example |
|---|---|---|---|---|---|---|
| Table 13-2 | | | 56 | 57 | 58 | 59 |
| Transparent thermoplastic resin composition | | | (56) | (57) | (58) | (59) |
| Type of | Styrene-unsaturated carboxylic | | ps1 | ps1 | ps1 | ps1 |
| each raw | acid-based resin (A1) | | | | | |
| material | Aromatic polycarbonate (A2) | | — | — | — | — |
| | (Meth)Acrylic Resin (A3) | | — | — | — | — |
| | Phosphorus-based compound (B) | | b-1 | b-1 | b-1 | b-1 |
| | Phenolic antioxidant (C1) | | — | — | c1-1 | c1-1 |
| | Phosphorus-based antioxidant (C2) | | — | — | c2-1 | c2-1 |
| | UV absorber (D) | | — | — | d-4 | d-4 |
| | Light stabilizer (E) | | — | — | — | — |
| | Mold release agent (F) | | f-3 | f-3 | f-3 | f-3 |
| | Resin containing rubbery polymer (H) | | — | — | — | — |
| Formulation | Styrene-unsaturated carboxylic | mass % | 100 | 100 | 100 | 100 |
| | acid-based resin (A1) | | | | | |
| | Aromatic polycarbonate (A2) | mass % | — | — | — | — |
| | (Meth)Acrylic Resin (A3) | mass % | — | — | — | — |
| | Phosphorus-based compound (B) | mass % | 0.05 | 0.10 | 0.1 | 0.08 |
| | Phenolic antioxidant (C1) | mass % | — | — | 0.05 | 0.05 |
| | Phosphorus-based antioxidant (C2) | mass % | — | — | 0.1 | 0.1 |
| | UV absorber (D) | mass % | — | — | 0.02 | 0.02 |
| | Light stabilizer (E) | mass % | — | — | — | — |
| | Mold release agent (F) | mass % | 0.01 | 0.01 | 0.01 | 0.01 |
| | Resin containing rubbery polymer (H) | mass % | — | — | — | — |
| | Rubbery polymer (H) | mass % | — | — | — | — |
| | Stearyl alcohol (g-1) | mass % | 0.2 | 0.2 | 0.2 | 0.2 |
| | Fine oxocholic 180 (g-2) | mass % | 0.15 | 0.15 | 0.15 | 0.15 |
| | 2-Ethylhexanol (g-3) | mass % | 0.01 | 0.01 | 0.01 | 0.01 |
| | Emulgen 109P (g-4) | mass % | 0 | 0 | 0 | 0 |
| Stabilizing | Stabilizing component in composition | mass % | — | — | 0.27 | 0.25 |
| component | Proportion of phosphorus-based compound | mass % | — | — | 37.0 | 32.0 |
| | (B) in stabilizing components | | | | | |
| | Proportion of phenol-based antioxidant | mass % | — | — | 18.5 | 20.0 |
| | (C1) in stabilizing components | | | | | |
| | Proportion of phosphorus-based | mass % | — | — | 37.0 | 40.0 |
| | antioxidant (C2) in stabilizing components | | | | | |
| | Proportion of antioxidant | mass % | — | — | 55.6 | 60.0 |
| | (C) in stabilizing components | | | | | |
| | Phenolic antioxidant (C1)/Phosphorus-based | | — | — | 0.5 | 0.6 |
| | compound (B) | | | | | |
| | Phosphorus-based antioxidant | | — | — | 1.0 | 1.3 |
| | (C2)/Phosphorus-based compound (B) | | | | | |
| Properties of | Vicat softening temperature | ° C. | 123 | 123 | 122 | 122 |
| composition | Deflection temperature under load | ° C. | 100 | 100 | 99 | 99 |
| | Heat resistance | | A | A | A | A |
| | Density | g/cm³ | 1.08 | 1.08 | 1.08 | 1.08 |
| | Total light transmittance of 2 mm-thick plate | % | 91 | 90 | 90 | 90 |
| | YI value at optical path length of 300 mm | | 20 | 24 | 18 | 16 |
| | Lightness (L*) at optical path length of 300 mm | | 91 | 89 | 89 | 90 |
| | ΔYI (light resistance) | | 25 | 25 | 15 | 14 |
| | ΔYI (long-term thermal stability) | | 24 | 23 | 16 | 15 |
| | Moist heat resistance (ΔHz) | | 0.5 | 0.5 | 0.5 | 0.5 |
| | Moist heat resistance (ΔVicat) | ° C. | 4 | 4 | 4 | 4 |
| | Moldability (fluidity) | MPa | 35 | 35 | 35 | 35 |
| | Moldability (mold releaseability) | | A | A | A | A |

TABLE 14

| | | | Comp. | Comp. | Comp. | Comp. | Comp. | Comp. |
|---|---|---|---|---|---|---|---|---|
| Table 14 | | | Ex. 1 | Ex. 2 | Ex. 3 | Ex. 4 | Ex. 5 | Ex. 6 |
| Transparent thermoplastic resin composition | | | (60) | (61) | (62) | (63) | (64) | (65) |
| Type of | Styrene-unsaturated carboxylic | | ps4 | — | ps1 | ps1 | — | — |
| each raw | acid-based resin (A1) | | | | | | | |
| material | Aromatic polycarbonate (A2) | | — | — | — | — | — | — |
| | (Meth)Acrylic Resin (A3) | | — | pm5 | — | — | pm4 | — |
| | Phosphinic ester (B) | | b-1 | b-1 | b-1 | — | — | b-1 |
| | Phenolic antioxidant (C1) | | c1-1 | c1-1 | c1-1 | c1-1 | — | c1-1 |
| | Phosphorus-based antioxidant (C2) | | c2-1 | c2-1 | c2-1 | c2-1 | — | c2-1 |
| | UV absorber (D) | | d-4 | d-4 | d-4 | d-4 | — | d-4 |
| | Light stabilizer (E) | | — | — | — | — | — | — |
| | Mold release agent (F) | | f-3 | f-3 | f-3 | f-3 | f-3 | f-3 |
| | Resin containing rubbery polymer (H) | | — | — | — | — | — | h-6 |
| Each | Styrene-unsaturated carboxylic | mass % | 100 | 100 | 100 | 100 | — | — |
| blending | acid-based resin (A1) | | | | | | | |
| composition | Aromatic polycarbonate (A2) | mass % | — | — | — | — | — | — |
| | (Meth)Acrylic Resin (A3) | mass % | — | — | — | — | 100 | — |
| | Phosphinic ester (B) | mass % | 0.05 | 0.05 | 0.4 | — | — | 0.05 |
| | Phenolic antioxidant (C1) | mass % | 0.05 | 0.05 | 0.05 | 0.05 | — | 0.05 |
| | Phosphorus-based antioxidant (C2) | mass % | 0.1 | 0.1 | 0.1 | 0.1 | — | 0.1 |
| | UV absorber (D) | mass % | 0.02 | 0.02 | 0.02 | 0.02 | — | 0.02 |
| | Light stabilizer (E) | mass % | — | — | — | — | — | — |
| | Mold release agent (F) | mass % | 0.01 | 0.01 | 0.01 | 0.01 | 0.01 | 0.01 |
| | Resin containing rubbery polymer (H) | mass % | — | — | — | — | — | 100 |
| | Rubbery polymer (H) | mass % | — | — | — | — | — | 3.5 |
| | Stearyl alcohol (g-1) | mass % | 0.2 | 0.2 | 0.2 | 0.2 | 0.2 | 0.2 |
| | Fine oxocholic 180 (g-2) | mass % | 0.15 | 0.15 | 0.15 | 0.15 | 0 | 0.15 |
| | 2-Ethylhexanol (g-3) | mass % | 0.01 | 0.01 | 0.01 | 0.01 | 0 | 0.01 |
| | Emulgen 109P (g-4) | mass % | 0 | 0 | 0 | 0 | 0 | 0 |
| Stabilizing | Stabilizing component in composition | mass % | 0.22 | 0.22 | 0.57 | 0.17 | — | 0.22 |
| component | Proportion of phosphorus-based compound | mass % | 22.7 | 22.7 | 70.2 | — | — | 22.7 |
| | (B) in stabilizing components | | | | | | | |
| | Proportion of phenol-based | mass % | 22.7 | 22.7 | 8.8 | 29.4 | — | 22.7 |
| | antioxidant (C1) in stabilizing components | | | | | | | |
| | Proportion of phosphorus-based | mass % | 45.5 | 45.5 | 17.5 | 58.8 | — | 45.5 |
| | antioxidant (C2) in stabilizing components | | | | | | | |
| | Proportion of antioxidant | mass % | 68.2 | 68.2 | 26.3 | 88.2 | — | 68.2 |
| | (C) in stabilizing components | | | | | | | |
| | Phenolic antioxidant (C1)/Phosphorus-based | | 1.0 | 1.0 | 0.1 | — | — | 1.0 |
| | compound (B) | | | | | | | |
| | Phosphorus-based antioxidant | | 2.0 | 2.0 | 0.3 | — | — | 2.0 |
| | (C2)/Phosphorus-based compound (B) | | | | | | | |
| Properties of | Vicat softening temperature | ° C. | 101 | 100 | 121 | 122 | 119 | 119 |
| composition | Deflection temperature under load | ° C. | 80 | 80 | 98 | 99 | 95 | 97 |
| | Heat resistance | | D | D | A | A | B | A |
| | Density | g/cm³ | 1.05 | 1.10 | 1.08 | 1.08 | 1.19 | 1.08 |
| | 2 mm thickness-plate transmission | % | 90 | 91 | 89 | 90 | 90 | 52 |
| | YI value at optical path | | 25 | 15 | 22 | 32 | 40 | 48 |
| | length of 300 mm | | | | | | | |
| | Lightness (L*) at optical | | 88 | 92 | 79 | 88 | 85 | 29 |
| | path length of 300 mm | | | | | | | |
| | ΔYI (light resistance) | | 25 | 12 | 20 | 15 | 6 | 34 |
| | ΔYI (long-term thermal stability) | | 20 | 13 | 16 | 27 | 5 | 38 |
| | Moist heat resistance (ΔHz) | | 2 | 0.2 | 0.7 | 0.5 | 0.5 | 1.5 |
| | Moist heat resistance (ΔVicat) | ° C. | 3 | 5 | 4 | 4 | 15 | 4 |
| | Moldability (fluidity) | MPa | 25 | 35 | 35 | 35 | 65 | 35 |
| | Moldability (mold releaseability) | | B | B | A | A | B | A |

| | | | Comp. | Comp. | Comp. | Comp. | Comp. |
|---|---|---|---|---|---|---|---|
| Table 14 | | | Ex. 7 | Ex. 8 | Ex. 9 | Ex. 10 | Ex. 11 |
| Transparent thermoplastic resin composition | | | (66) | (67) | (68) | (69) | (70) |
| Type of | Styrene-unsaturated carboxylic | | — | — | — | — | ps1 |
| each raw | acid-based resin (A1) | | | | | | |
| material | Aromatic polycarbonate (A2) | | — | — | — | — | — |
| | (Meth)Acrylic Resin (A3) | | — | — | — | — | — |
| | Phosphinic ester (B) | | b-1 | b-1 | b-1 | b-1 | — |
| | Phenolic antioxidant (C1) | | c1-1 | c1-1 | c1-1 | c1-1 | — |
| | Phosphorus-based antioxidant (C2) | | c2-1 | c2-1 | c2-1 | c2-1 | — |
| | UV absorber (D) | | d-4 | d-4 | d-4 | d-4 | d-4 |
| | Light stabilizer (E) | | — | — | — | — | e-1 |
| | Mold release agent (F) | | f-3 | f-3 | f-3 | f-3 | f-3 |
| | Resin containing rubbery polymer (H) | | h-7 | h-11 | h-12 | h-13 | — |
| Each | Styrene-unsaturated carboxylic | mass % | — | — | — | — | 100 |
| blending | acid-based resin (A1) | | | | | | |
| composition | Aromatic polycarbonate (A2) | mass % | — | — | — | — | — |
| | (Meth)Acrylic Resin (A3) | mass % | — | — | — | — | — |
| | Phosphinic ester (B) | mass % | 0.05 | 0.05 | 0.05 | 0.05 | — |
| | Phenolic antioxidant (C1) | mass % | 0.05 | 0.05 | 0.05 | 0.05 | — |
| | Phosphorus-based antioxidant (C2) | mass % | 0.1 | 0.1 | 0.1 | 0.1 | — |
| | UV absorber (D) | mass % | 0.02 | 0.02 | 0.02 | 0.02 | 0.02 |
| | Light stabilizer (E) | mass % | — | — | — | — | 0.1 |
| | Mold release agent (F) | mass % | 0.01 | 0.01 | 0.01 | 0.01 | 0.01 |
| | Resin containing rubbery polymer (H) | mass % | 100 | 100 | 100 | 100 | — |
| | Rubbery polymer (H) | mass % | 2.1 | 2.2 | 4.0 | 2.1 | — |
| | Stearyl alcohol (g-1) | mass % | 0.2 | 0.2 | 0.2 | 0.2 | 0.2 |
| | Fine oxocholic 180 (g-2) | mass % | 0.15 | 0.15 | 0.15 | 0.15 | 0.15 |
| | 2-Ethylhexanol (g-3) | mass % | 0.01 | 0.01 | 0.01 | 0.01 | 0.01 |
| | Emulgen 109P (g-4) | mass % | 0 | 0 | 0 | 0 | 0 |
| Stabilizing | Stabilizing component in composition | mass % | 0.22 | 0.22 | 0.22 | 0.22 | — |
| component | Proportion of phosphorus-based compound | mass % | 22.7 | 22.7 | 22.7 | 22.7 | — |
| | (B) in stabilizing components | | | | | | |
| | Proportion of phenol-based | mass % | 22.7 | 22.7 | 22.7 | 22.7 | — |
| | antioxidant (C1) in stabilizing components | | | | | | |
| | Proportion of phosphorus-based | mass % | 45.5 | 45.5 | 45.5 | 45.5 | — |
| | antioxidant (C2) in stabilizing components | | | | | | |
| | Proportion of antioxidant | mass % | 68.2 | 68.2 | 68.2 | 68.2 | — |
| | (C) in stabilizing components | | | | | | |
| | Phenolic antioxidant (C1)/Phosphorus-based | | 1.0 | 1.0 | 1.0 | 1.0 | — |
| | compound (B) | | | | | | |
| | Phosphorus-based antioxidant | | 2.0 | 2.0 | 2.0 | 2.0 | — |
| | (C2)/Phosphorus-based compound (B) | | | | | | |
| Properties of | Vicat softening temperature | ° C. | 119 | 92 | 94 | 96 | 122 |
| composition | Deflection temperature under load | ° C. | 97 | 72 | 74 | 75 | 99 |
| | Heat resistance | | A | D | D | D | A |
| | Density | g/cm³ | 1.08 | 1.06 | 1.06 | 1.06 | 1.08 |
| | 2 mm thickness-plate transmission | % | 60 | 88 | 87 | 88 | 90 |
| | YI value at optical path | | 40 | 34 | 39 | 33 | 30 |
| | length of 300 mm | | | | | | |
| | Lightness (L*) at optical | | 37 | 69 | 55 | 66 | 88 |
| | path length of 300 mm | | | | | | |
| | ΔYI (light resistance) | | 26 | 29 | 32 | 27 | 12 |
| | ΔYI (long-term thermal stability) | | 32 | 30 | 33 | 30 | 31 |
| | Moist heat resistance (ΔHz) | | 1.3 | 0.8 | 0.8 | 0.8 | 0.5 |
| | Moist heat resistance (ΔVicat) | ° C. | 4 | 5 | 5 | 5 | 4 |
| | Moldability (fluidity) | MPa | 35 | 25 | 25 | 25 | 35 |
| | Moldability (mold releaseability) | | A | A | A | A | A |

### INDUSTRIAL APPLICABILITY

The transparent thermoplastic resin composition of the present disclosure is used in molded articles that have low yellowness and are and excellent in transparency, heat resistance, long-term thermal stability, light resistance, and moldability. The molded article of the present disclosure can be widely applied to vehicle lamp materials, packaging materials for food containers, housing insulation materials, lighting device materials, monitor or display materials, optical components (such as lighting covers, optical lenses, in-vehicle injection molded articles, light guide members (e.g., light guides for vehicles), light guide bodies (light guide rods), or light diffusers), or the like.

1. A transparent thermoplastic resin composition comprising:
95 to 99.999 mass % of a transparent thermoplastic resin (A); and
0.001 to 0.3 mass % of a phosphorus-based compound (B) represented by the following general formula (1): 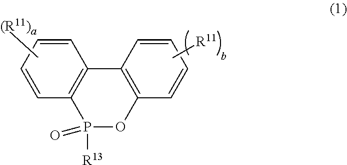
in the above general formula (1), R¹¹ and R¹² each independently are the same or different and represent halogen atoms or lower alkyl groups, and R¹³ represents a hydrogen atom, a halogen atom, a hydroxyl group, an alkyl group having 1 to 10 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; and a and b each independently represent an integer from 0 to 4, and
having a Vicat softening temperature of 105° C. or higher.

2. The transparent thermoplastic resin composition according to claim 1, comprising 95 to 99.999 mass % of the thermoplastic resin (A), 0.001 to 0.3 mass % of the phosphorus-based compound (B) represented by the general formula (1), 0 to 1.0 mass % of an antioxidant (C), 0 to 1.0 mass % of an ultraviolet absorber (D), 0 to 1.0 mass % of a hindered amine-based light stabilizer (E), 0 to 2.5 mass % of a mold release agent (F), 0 to 2.5 mass % of a monovalent alcohol (G) having 6 or more carbon atoms, and 0 to 3 mass % of a rubbery polymer (H) having a conjugated diene-based monomer unit (h),
wherein a total content of the thermoplastic resin (A), the phosphorus-based compound (B) represented by the general formula (1), the antioxidant (C), the ultraviolet absorber (D), the hindered amine-based light stabilizer (E), the mold release agent (F), the monovalent alcohol (G) having 6 or more carbon atoms, and the rubbery polymer (H) having a conjugated diene-based monomer unit (h) is 100 mass % or less.

3. The transparent thermoplastic resin composition according to claim 1, further comprising a rubbery polymer (H) having a conjugated diene-based monomer unit (h), wherein a content of the rubbery polymer (H) is 3.0 mass % or less relative to an entire transparent thermoplastic resin composition.

4. The transparent thermoplastic resin composition according to claim 1, wherein the transparent thermoplastic resin (A) is one or two or more selected from the group consisting of a styrene-unsaturated carboxylic acid-based resin (A1) having a styrene-based monomer unit (a1-1) and an unsaturated carboxylic acid monomer unit (a1-2), an aromatic polycarbonate resin (A2), and a (meth)acrylic resin (A3).

5. The transparent thermoplastic resin composition according to claim 1, wherein the styrene-unsaturated carboxylic acid-based resin (A1) is a styrene-based copolymer resin including a styrene-based monomer unit (a1-1), an unsaturated carboxylic acid monomer unit (a1-2), and an unsaturated carboxylic acid monomer unit ester (a1-3).

6. The transparent thermoplastic resin composition according to claim 1, wherein the transparent thermoplastic resin (A) is a styrene-unsaturated carboxylic acid-based resin (A1) having a styrene-based monomer unit (a1-1) and an unsaturated carboxylic acid monomer unit (a1-2), a content of the styrene-based monomer unit is 60 mass % or more and 97 mass % or less relative to an entire transparent thermoplastic resin (A), and a methyl ethyl ketone insoluble component content is 3 mass % or less.

7. The transparent thermoplastic resin composition according to claim 1, wherein the phosphorus-based compound (B) is 9,10-dihydro-9-oxa-10-phosphaphenanthrene-10-oxide.

8. The transparent thermoplastic resin composition according to claim 1, further comprising one or two or more antioxidants (C) selected from the group consisting of a phenolic antioxidant (C1) and a phosphorus-based antioxidant (C2), and contents of the phenolic antioxidant (C1) and the phosphorus-based antioxidant (C2) are each 0.001 to 0.5 mass % relative to the entire transparent thermoplastic resin composition.

9. The transparent thermoplastic resin composition according to claim 1, further comprising one or two or more antioxidants (C) selected from the group consisting of a phenolic antioxidant (C1) and a phosphorus-based antioxidant (C2),
wherein a content ratio (mass ratio) of the phenolic antioxidant (C1) to the phosphorus-based compound (B) (phenolic antioxidant (C1)/phosphorus-based compound (B)) is 0.1 to 10.

10. The transparent thermoplastic resin composition according to claim 1, further comprising a phosphorus-based antioxidant (C2), wherein a content ratio of the phosphorus-based antioxidant (C2) to the phosphorus-based compound (B) (phosphorus-based antioxidant (C2)/phosphorus-based compound (B)) is 0.1 to 15.

11. The transparent thermoplastic resin composition according to claim 1, further comprising 0.001 to 1 mass % of an ultraviolet absorber (D) represented by the general formula (d) and the general formula (d′) relative to the entire transparent thermoplastic resin composition: 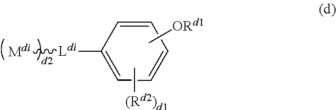
in the above general formula (d), M^{di} each independently represents a monovalent or higher aromatic group, R^{d1} represents a hydrogen atom or an alkyl group having 1 to 10 carbon atoms, L^{di} each independently represents a divalent to pentavalent group, R^{d2} represents an alkyl group having 1 to 15 carbon atoms or an aralkyl group having 7 to 25 carbon atoms, wherein —CH₂—in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring; d1 represents an integer of 0 or more and 4 or less; and d2 represents an integer of 0 or more and 4 or less; a wavy line connecting M^{di} and L^{di} in the above general formula (d) indicates the presence of one or more chemical bonds that are greater than or equal to a single bond, and 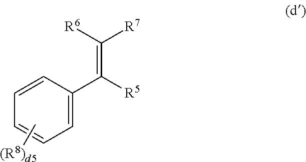
in the above general formula (d′), R⁵ to R⁷ each independently represent a hydrogen atom, a halogen atom, a hydroxyl group, a cyano group, a phenyl group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring, R⁸ each independently represents a halogen atom, a hydroxyl group, a cyano group, an alkyl group having 1 to 15 carbon atoms, or an aralkyl group having 7 to 25 carbon atoms, wherein —CH₂— in the alkyl group or the aralkyl group may be substituted with —O— or —C(═O)—, or —CH₂—CH₂— in the alkyl group or the aralkyl group may be substituted with —CH═CH—, —C(═O)—O—, —O—C(═O)—, —CH₂O—, or —OCH₂—, and one or more hydrogen atoms on the benzene ring in the aralkyl group may be substituted with a phenolic hydroxyl group, an alkyl group having 1 to 15 carbon atoms, or a monovalent aromatic ring, and
d5 represents an integer of 0 or more and 4 or less, and when d5 is 2 or more, R⁸ may be the same or different from each other.

12. The transparent thermoplastic resin composition according to claim 2, wherein the hindered amine-based light stabilizer (E) is contained in an amount of 0.001 to 1 mass % relative to the entire transparent thermoplastic resin composition.

13. The transparent thermoplastic resin composition according to claim 2, wherein a proportion of the phosphor-based compound (B) in stabilizing components composed of the phosphorus-based compound (B), the antioxidant (C), the ultraviolet absorber (D), and the hindered amine-based light stabilizer (E) is 5 to 50 mass % when a total amount of the stabilizing components is 100 mass %.

14. The transparent thermoplastic resin composition according to claim 2, wherein the mold release agent (F) is contained in an amount of 0.001 to 2.5 mass % relative to the entire transparent thermoplastic resin composition.

15. The transparent thermoplastic resin composition according to claim 2, wherein the monovalent alcohol (G) having 6 or more carbon atoms is contained in an amount of 0.001 to 2.5 mass % relative to the entire transparent thermoplastic resin composition.

16. The transparent thermoplastic resin composition according to claim 1, wherein a long optical path test piece having a light path length of 300 mm obtained by injection molding the transparent thermoplastic resin composition under the following molding conditions (S1) to (S3) has a YI value of 25 or less and an L* value of 80 or more:
<Molding conditions>
a molding condition (S1) of the transparent thermoplastic resin composition when the transparent thermoplastic resin (A) in the transparent thermoplastic resin composition is mainly composed of the styrene-unsaturated carboxylic acid-based resin (A1): a cylinder temperature of 220° C., a mold temperature of 70° C., and a cycle time of 35 seconds;
a molding condition (S2) of the transparent thermoplastic resin composition when the transparent thermoplastic resin (A) in the transparent thermoplastic resin composition is mainly composed of the aromatic polycarbonate resin (A2): a cylinder temperature of 260° C., a mold temperature of 80° C., and a cycle time of 35 seconds; or
a molding condition (S3) of the transparent thermoplastic resin composition when the transparent thermoplastic resin (A) in the transparent thermoplastic resin composition is mainly composed of the (meth)acrylic resin (A3): a cylinder temperature of 240° C., a mold temperature of 70° C., and a cycle time of 35 seconds.

17. The transparent thermoplastic resin composition according to claim 16, wherein ΔYI, which is determined by subtracting an initial YI value before heating from the YI value after heating the long optical path test piece at 110° C. for 1000 hours, is 25 or less.

18. An injection molded article produced by injection molding the transparent thermoplastic resin composition according to claim 1.

19. A light guide member comprising the transparent resin composition according to claim 1.

20. The light guide member according to claim 19, which is a member used in a vehicle lamp and having a bent portion.

21. A daytime running light for vehicles comprising the transparent thermoplastic resin composition according to claim 1.

22. An elongated light guide member comprising the transparent thermoplastic resin composition according to claim 1 and having a bent portion.

23. An aspherical lens comprising the transparent resin composition according to claim 1.
